(19) United States
(12) Patent Application Publication
(10) Pub. No.: US 2026/0099861 A1
(43) Pub. Date: Apr. 9, 2026

(54) Devices, Systems, And Their Methods Of Use For Generating A Communication And Recommendation Therefore

(71) Applicant: SOCI, Inc., San Diego, CA (US)

(72) Inventors: Afif KHOURY, San Diego, CA (US); Alo SARV, San Diego, CA (US)

(21) Appl. No.: 19/337,810

(22) Filed: Sep. 23, 2025

Related U.S. Application Data
(60) Provisional application No. 63/698,038, filed on Sep. 23, 2024.
(60) Provisional application No. 63/807,829, filed on May 18, 2025.

(51) Int. Cl. G06Q 30/0242

(52) U.S. Cl. CPC G06Q 30/0244

(57) ABSTRACT

Presented herein are devices, systems, and their methods of use for generating a communication to be recommended for publication at an online communication platform. In one aspect, a communication system is provided that is configured as a business listing recommendation platform that may be used for generating a business listing for publication at a search engine website. The communication recommendation and generation system may be adapted for recommending content to be included in a social media post or other online communication. The communication may be a business listing to be published, which listing may be evaluated and modified so as to include one or more high impact, relevant keywords, where the keywords have been evaluated and recommended for use within the communication based on one or more system generated insights.

### CROSS-REFERENCE TO RELATED APPLICATIONS

The current application claims priority under 35 U.S.C. § 119(e) to provisional application Ser. No. 63/807,829 filed May 18, 2025 and to provisional application Ser. No. 63/698,038 filed Sep. 23, 2024, the disclosures of which are incorporated herein by reference in their entirety.

### BACKGROUND

This document presents devices, systems, and their methods of use for generating a communication and a recommendation therefore. In various instances, the communication may be any form of messaging to be generated and/or recommended for use in internal or external communications, such as within an organization. For instance, in a particular instance, the organization may be a business, such as an E-commerce business, and the communication may be an advertisement, a response to a review, a request for a review, a survey, or the like. In one specific instance, the communication may be a business listing that is designed to be returned as a search result when a consumer enters a search at a search engine interface.

Such business listings, therefore, are very important with regard to enabling a search engine to identify and present that business as matching one or more criteria of the search being performed by a consumer. Further, the degree to which the consumer's search criteria match the description of the business listing, the higher up in the returned results the business listing will appear. Specifically, when a search is entered into a search engine platform, such as GOOGLE®, BING®, APPLE®, FACEBOOK®, YELP®, and other such search engine platforms, a complex set of algorithms are employed by which to compare the words of the search query to the words of the business listing and thereby determine which, of all potential business listings, best match that which is being searched for. The result of this determination is a prioritized list of results of business listings that have been determined to best meet the search criteria, which listings are listed in rank order, whereby the search algorithm places what it deems to be the best matching results towards the top of the search results list, and those not matching as closely are placed further down the list. This is of vital importance to the business because the higher up in the search results their business listing appears, the greater the chances are that the business listing will be seen and engaged with, which could lead to a drastic uptick in reach and sales for that business.

For example, E-commerce sales for 2023 were estimated to be above 5 trillion dollars worldwide, of which, above 1.8 trillion dollars of that 5 trillion in sales were transacted in the United States, alone. That may sound like a big number; however, the number is considerably smaller when divided by the 14 million number of U.S. e-commerce sites. That number is even smaller when the top earning online retailers, such as AMAZON® (about 135 B), WALMART® (about 65B), APPLE® (about 26B), HOME DEPOT® (about 20B), TARGET® (about 20B), as well as about another 60B in net sales being generated by a mere handful of other companies, is subtracted from that 1.8 trillion in total US sales. Further, the top online retailers, such as NIKE® (about 5B), ZARA® (about 54 B), MACYS® (about 500M), H&M® (about 5.5B), GAP® (about 4B), ABERCROMBIE & FITCH® (about 750M), and OTTERBOX® (about 1B) account for about another 71B in online retail sales. This leaves about 1.4 trillion to be divided by 13,990,000 online US businesses, which amounts to about an average of $100,000 in retail sales that is split amongst the rest of the online ecommerce businesses in the United States. This makes the competition for available online dollars very difficult.

Obviously, some online businesses make money, and some do not. For instance, some ecommerce businesses simply offer a superior product than others. However, the vast majority of online businesses offer fairly ubiquitous products that are not highly differentiated from the products of their competitors. This begs the questions as to why some ecommerce companies, offering the same products and services as their competitors make it big, while others do not make it at all. The answer to this question is simple: Advertising. In fact, 515B was spent on US e-commerce advertising in 2023.

E-commerce advertising is part of a larger rubric of online marketing, which entails the promoting of products and services, such as by enhancing brand visibility, optimizing user experience, and building consumer trust. In order to achieve these goals, e-commerce companies spend thousands to millions to even billions of dollars each year on paid online advertisements, to strategically place advertisements across a wide number of diverse platforms to generate traffic to their sale's pages and thereby increase their net-sales. However, unlike traditional paid advertising, online sellers are wary to pay for advertisement placement, because it is very difficult to determine if an advertisement placed on a webpage is actually seen or not.

Traditionally, for instance, companies pay for advertisement placement, where the price to be paid for the advertisement is based on the likelihood of being seen. Specifically, the more likely an advertisement is to be seen, the more the ad placement will cost. This is why an advertisement during a Superbowl game costs upwards of about 5 million for a 30 second ad, whereas an advertisement placed on a billboard might cost hundreds to thousands, and an advertisement placed in a local paper may only cost mere dollars. These differences in costs are primarily determined based on circulation, such as for the newspaper, which at one extreme, could be in the tens to hundreds of dollars for a local newspaper, and on the other extreme, viewership, which could be in excess of 30 million dollars for a television ad placed during a halftime show. In the middle is a variable range of costs, such as for billboard ads, the price of which will depend on the number of the cars passing by the billboard, e.g., the traffic. The higher the traffic passing by the billboard, the higher the cost for placing an advertisement thereon.

Likewise, when it comes to online advertising, the higher the traffic a website garners to itself, e.g., the number of potential consumers that visit the website on a daily basis, the greater the website owner can charge for ad placements on the webpages thereof. However, unlike traditional advertising, where it is very difficult to determine if an advertisement is actually viewed and/or if a consumer makes a purchase based on having seen the advertisement, it is comparatively easier to determine if an online consumer has seen an online advertisement and what affect the advertisement has had on that consumer because their actions can be more easily tracked. Particularly, where an online consumer opens a given webpage having advertisements thereon, such as on a boarder thereof, the very fact that the advertisement was placed on the screen, e.g., next to content being consumed by the consumer, in a place to be seen by that consumer, is termed an impression.

Having potentially seen, e.g., been impressed by, the advertisement, the consumer can either continue with their intended online activity, or they can be lured away from their intended activity by clicking on a presented ad, which in ecommerce terminology is called a conversion. All of impressions, conversions, and sales in ecommerce fall under the classification of engagements, and the price paid for an online advertisement is dependent on the extent of the engagement. Specifically, an advertiser can pay a first, lower, price for the presentation of an advertisement, e.g., an impression, and may sometimes pay a second, higher, price for a consumer actually clicking on the advertisement, e.g., a conversion, and may also pay an even higher price when an actual sale is made. Unlike in traditional advertising where the level at which the consumer responds to an advertisement they have read in a publication or seen on a billboard cannot be directly measured, such activity can be tracked online, and thus, incremental online activity, such as from impressions to conversions to ultimate sales, can all be measured and, therefore, monetized. This concept in ecommerce is termed lift, specifically, incremental lift.

Generally, incrementality is a measurement for the amount of change that is caused by a small increment of input, such as where the input is an advertisement or other promotion under evaluation. Particularly, with respect to online advertising, incrementality can be determined, at least in part, based on one or more forms of the above referenced impressions and/or conversions. For example, one of the most pertinent questions to be resolved for an organization and/or advertiser engaging in online advertising is determining the success of the online advertising campaigns they run. Typically, this success is measured by conversion rates, which conversion rates may be determined by a number of different defined characteristics, such as by a number of impressions, clicking on a banner ad (clicks), visits at an advertisement page (site visits), length of stay on the advertisement page (duration), bounce rate, number of pages visited per session, actual purchases made, etc. This data is commonly referred to as “metrics.” However, a question remains as to which, if any, of these instances is caused, or in some manner positively influenced by the nature of one or more advertisements in an advertisement campaign being run. Incrementality attempts to measure the effectiveness of such advertisements and advertising campaigns.

Accordingly, in view of the above, given the relatively infinite number of online retailers, and the limited amount of consumer dollars capable of being captured, there has arisen fierce competition amongst online businesses to distinguish themselves from their competition, which in many cases offer the same general product offerings of the same universal quality. Success or failure of an online business, therefore, largely depends on their ability to be “seen” online, which is due, more specifically, to their ability to engage in advertising campaigns that increase impressions and conversions that directly lead to incremental lift. Consequently, to win this battle, a successful company must not merely participate in online advertising, they must engage in advertising that appeals to every individual consumer on their terms, in a manner that is relevant to them, and presents them with an offer that meets their needs and is communicated in a manner that provokes their decision to actually engage with the advertisement and ultimately make a purchase.

To do this, high performing advertising must include content that is not only relevant to the consumer, it must also meet their immediate needs. Unfortunately, the vast majority of online advertising does not meet these criteria as the advertisements are either not seen and/or do not lead to conversions, sales, and/or engagements. This leads to the greatest problem in online advertising in that limited advertising dollars are spent on advertisements that have no effect on the consumer to which they are being presented, and thus, those dollars are being wasted.

Particularly, there are typically three channels for digital online advertising. First, there is proprietary reach-based marketing, including direct to consumer digital marketing, such as using mailing lists and emails. In this channel online businesses reach out to consumers who have made purchases from them before or have joined their mailing lists. Second, there is social media network marketing, which has emerged as a critical marketing channel for successful online retail growth. However, social network advertising, which in the past has been highly beneficial, is currently suffering from intense competition, which has led to a rapid decline in “click through rates” that indicates a reduction in user interaction with ads on these networks, and thus a decrease in profitable campaign performance. Finally, there is organic search-based advertising associated with the various big search engine platforms, such as GOOGLE®, BING®, APPLE®, FACEBOOK®, YELP®, and the like.

However, as indicated above with regard to search-based advertising, the challenge for business is in determining how best to craft their business listings so as to maximize their potentiality for being ranked highly in returned search results so as to maximize the potential for being seen and engaged with. This problem is made even more challenging when you have nationwide companies having a large number of localized franchises that have to both live up to their national brand promises, but must also maintain and/or increase relevance to their local consumers who are often performing searches not in a nationwide context, but a local one. Hence, to be competitive in the search result rankings, local businesses, whether they be mom and pop shops or franchises of a multinational brand, need location level intelligence on consumers and how they are behaving on the local level. Marketing that is tailored to localized consumers may be referenced as Hyperlocal Marketing.

Particularly, it would be useful for a local business when generating a business listing to have both location level intelligence on the individual consumer and how they are acting, e.g., what kinds of searching they are performing, within their local environment, as well as to have overall global intelligence pertaining to nationwide trends that are currently affecting search engine rankings. Such intelligence would be extremely important for implementing search engine optimization (SEO) best practice insights that can be employed for the purpose of generating and/or recommending high performing content that has been evaluated with regard to boosting business listing reach and rankings. It would also be useful to identify and maintain brand voice in generating and recommending communication content, especially in situations where that content is employed in the autonomous generation of communications that are directed to local consumers of a nationwide or global brand. The devices, systems, and their methods of use, as described herein and throughout this description, are directed at meeting these and other such needs.

### SUMMARY OF DISCLOSURE

Accordingly, in view of the above, provided herein are devices, systems, and their methods of use for generating a communication to be recommended for publication, or other form of distribution, at an online communication platform. In various embodiments, the system may be configured for autonomously generating a communication for publication without a need for prior approval. For instance, in one aspect, an autonomous communication system may be provided, whereby the communication system may be configured as a business listing and/or review response recommendation platform for generating a business listing or review response, such as for publication at one or more search engine websites.

However, in other embodiments, the communication system may be configured as an online content recommendation platform that is adapted for recommending content to be included in a social media post, a review, a review response, or other online communication. In any of these instances, the communication, e.g., business listing, review response, or other online message, to be published or otherwise posted, may be evaluated and modified so as to include one or more high impact and/or relevant keywords, such as where those keywords have been recommended for use within the communication based on one or more insights having been generated by the system and/or accepted for use by a system user, e.g., the communicator.

In performing the referenced evaluation, the system may employ a number of data that may be collected and employed by an analytics platform of the system so as to determine if a number of potential keywords that can be used, will be recommended for use, such as in the generation and/or distribution of the communication. For such purposes, the system may include a content identification, contextual appreciation, and collection module that may be implemented by one or more processing engines that are configured for identifying and/or collecting a wide variety of communication data, such as communication content, communication use data, including data pertaining to how consumers and/or businesses are engaging with various communication content, e.g., keywords, communication content evaluation data, including metric and/or factor data pertaining to how communication content is performing, and business listing data, e.g., of a business, pertaining to one or more descriptors describing what the business does and/or how the business functions, e.g., its business purpose.

In these regards, the referenced communication content may be any form of content used in an online communication, which may include one or more keyword and/or keyword metric data. Particularly, in various embodiments, the keyword may be any word that the system and/or one or more of its associated components evaluates and determines to potentially be a high performing, high impact, or any other word, or phrase, that is trending or could be relevant to advancing the business purposes of a business or person. In such instances, such keywords may be evaluated in relation to one or more metrics, such as collected metric data, which may include keyword search traffic data as well as keyword volume data.

These keywords may also be evaluated by a number of other communication content evaluation data, such as factor data, which may include one or more of impression, conversion, sales, and/or other engagement data that may be relevant to performing an assessment of a keyword. Such evaluative data may also be used to analyze the referenced business listing and/or review response data, which data may include a number of business, competitor, or consumer descriptors, such as describing what the business does, describing, one or more goods and/or services being proffered by the business, and/or descriptors that in some way characterize the business, its competitors, and/or its consumers. Once analyzed, the evaluated keyword and/or business descriptors and evaluated data may be stored in one or more content collection repositories, such as for storing the communication content, the communication use data, the communication content evaluation data, as well as the business listing data, and any pertinent data that was collected and/or used to perform the evaluations set forth herein.

Further, for the performance of the referenced analyses, in another aspect, provided herein is one or more communication generation and recommendation servers that are in communication with the one or more content collection repositories, such as via a communication network. In various iterations, the communication server may include a plurality of processing modules, such as where each of the processing modules has one or more sets of processing engines that are configured for executing discrete functional operations. For instance, the various different processing modules may include one or more analytics modules, such as for performing evaluations, a content impact and/or relevancy determination module, a content recommendation module, a content generation module, and/or other such processing modules configured for evaluating communication related content.

For example, in one configuration, the communication generation and/or recommendation server may include a first analytics processing module that is adapted for evaluating various collected words, e.g., keywords, such as to determine their meaning, context, as well as their potential use in generating communications. For these purposes, the keyword analytics module may include a number of sets of processing engines, for instance, for implementing operations or processes for accessing one or more of the content collection repositories and for identifying and analyzing one or more of the identified keywords. Particularly, the one or more sets of keyword processing engines may be configured for applying the keyword metric and/or other associated keyword data to the keywords so as to determine one or more high performing keywords and/or for determining which words in a communication, such as a review, should be responded to. In particular instances, other keyword associated data, such as keyword and/or keyword communication data may be accessed and applied in the evaluation process. Once the various potential keywords have been evaluated and/or one or more high performing keywords have been identified they may be stored in a repository of the system, such as for future use and/or further analyses. In such instances, the repository may be a database having a plurality of memories, such as where one or more of the memories may have a structured architecture that allows for words having similar meanings to be grouped, e.g., clustered together. In some instances, the memory may be implemented as an artificial neural network.

Likewise, the communication generation and/or recommendation server may include a further analytics processing module that is adapted for evaluating the keywords, and other collected content and data, such as for evaluating one or more of the identified high performing keywords, so as to determine their contextual, e.g., semantic, meaning. For these purposes, the keyword semantic analytics module may include a number of sets of processing engines, for instance, for implementing operations for accessing one or more of the system repositories, e.g., memories, and for determining the semantic meaning for one or more of the keywords, such as for determining the contextual meaning for the determined high performing keywords. Once the semantic meaning for the high performing keywords have been determined, they may be stored in a repository of the system, such as a semantic meaning, e.g., vector, database for future use and/or further analysis by the system.

Furthermore, the communication generation and/or recommendation server may include an additional analytics processing module that is adapted for evaluating one or more of the words of a business description, words of a review or other consumer engagement, and/or words of other online commentary, e.g., one or more descriptors. These descriptors may be the same or analogous to one or more of the identified keywords, or may be entirely different words therefrom, but which are to be evaluated, such as in comparison to one or more of the identified, e.g., high performing, keywords, so as to determine their potential performance value, impact, reach, and/or overall ability to provoke engagement and/or increase impressions, conversions, and/or sales, e.g., lift. Specifically, in specific iterations, the descriptor analytics processing module may be configured for analyzing one or more of the identified descriptors, e.g., business descriptors, so as to determine their contextual, e.g., semantic, meaning, such as their business or review meaning. For these purposes, the descriptor semantic analytics module may include a number of sets of processing engines, for instance, for implementing operations for accessing one or more of the descriptors within the system repositories, and for determining the semantic meaning for one or more of the identified descriptors, such as for determining the contextual meaning for a selected business listing.

More particularly, with respect to evaluating various business listings and/or business reviews for semantic meaning, one or more sets of the processing engines of the descriptor semantic analytics module may be configured for analyzing the descriptors used by the communicator, e.g., business communicator, to determine what the business does and what are the goods and services being proffered by the business. Once such contextual business and/or consumer data has been determined it may be used, by one or more processing modules of the system, so as to determine one or more semantic business and/or consumer contexts for the business and/or consumer, overall, as well as one or more semantic meanings for the descriptors themselves. Further, once the semantic meaning for various of the business listing, reviews, and/or one or more of the descriptors have been determined, they and the semantically defined business listing and/or review may be stored in a semantic, e.g., vector, database or repository of the system, such as for future use and/or further analyses.

Further still, the communication generation and/or recommendation server may include another analytics processing module, e.g., a content relevancy determination module, that is adapted for analyzing one or more of the identified keywords, e.g., high performing and/or impactful keywords, in relation to one or more of the descriptors. In this regard, the content relevancy determination module may be configured for determining whether one or more of the identified keywords would be relevant to the business listing or review, and/or would be useful and/or impactful for use in a response thereto, such as for achieving a business purpose or objective of the contextualized business, consumer, competitor, or the like. Such objectives may include the increasing of impressions, conversions, engagements, reach, sales, and the like, for example, through its advertising and/or other communications.

For these purposes, the content relevancy determination module may include a plurality of sets of processing engines for implementing operations for accessing the keyword, business or consumer, other related information, and/or their associated collected and analytic data, stored within one or more of the repositories of the system, and for comparing the keyword semantic meaning, e.g., for at least one of the high performing and/or impactful keywords, to the one or more determined semantic contexts so as to identify a number of high performing keywords that are relevant to the contexts, e.g., business contexts of the business. Once the high performing relevant keywords have been identified and evaluated, they may be stored within a repository of the system, such as in a structured, e.g., clustered, manner for future analysis and/or use, such as for use within a business listing, review response, or other communication.

Accordingly, in these regards, the communication generation and/or recommendation server may also include a content evaluation and recommendation module that is configured for reviewing and analyzing a number of the semantically defined high performing, impactful, and/or relevant keywords in relation to a selected contextually determined communication, such as a business listing or review. The contextual meaning of these words may be accessed and reviewed so as to evaluate the business listing, review, or other communication with respect to the descriptors, e.g., keywords, employed therein. The purpose for such semantic evaluation is manifold, such as to determine if one or more of the words, e.g., descriptors, within the communication can or should be replaced by one or more of the high, impactful keywords, which is useful where the communication is a business listing.

Alternatively, where the communication is a review, semantic meaning can be determined so as to determine the context and meaning of the review, which can the results of which can then be used to generate, e.g., autonomously, a response to the review. In such instances, one or more of such the descriptors can be determined to be relevant to a further communication to be generated, such as for use in business listing or in response to a review. For these purposes, the communication generation and/or recommendation server may include a plurality processing engines for implementing operations for evaluating a number of descriptors, keywords, and/or high performing relevant keywords, and for selecting one or more of the evaluated high performing relevant keywords for inclusion within a business listing, such as to be published at a search engine website.

For example, in various embodiments, the system may be configured for being accessed, such as via the referenced communications network connection, by a client computing device, e.g., a desktop, laptop, handheld computing device, such as through a suitably configured client application running on a mobile computing device. Specifically, in various embodiments, the server may be a cloud based server having a network and/or wireless internet connection so as to communicate with one or more recipient computing devices, which computing device may be a client computer, a recipient computer, a desktop computer, laptop computer, a tablet computing device, or other mobile computing device such as a cellular phone having online or other computing functionalities. Accordingly, the disclosed computer systems, such as the servers and desktop computers described herein, may include one or more data processors, such as forming one or more of the disclosed processing engines, which processors may be coupled with one or more databases and memories.

Such memories may temporarily or permanently store instructions, operational parameters, and/or models, such as a large language model, LLM, or a retrieval augmented generation, RAG, model, which operational elements cause at least one processor to perform one or more of the operations described herein. As described herein, the various recited methods can be implemented by one or more of the disclosed processing elements, which may reside either within a single computing system or may be distributed among two or more computing systems. As indicated, these computing systems can be connected and can exchange data and/or commands or other operational instructions, prompts, and the like via one or more connections, including but not limited to a connection over a network (e.g., the Internet, a wireless wide area network, a local area network, a wide area network, a wired network, or the like), via a direct or indirect connection between one or more of the multiple computing systems, etc.

Consequently, in these regards, a user, e.g., a communicator, of the system may engage the system, over a network connected, desktop or handheld computing device, such as through an application running on the computing device, and may elicit the system's help in generating a communication, such as engaging with the system through a graphical user interface generated by the application running on the computing device. In this regard, the user may interact with an input of the computing device, and thereby request the system to evaluate one or more communications, e.g., business listings. Pursuant to receipt of this request the system may then implement the aforementioned processes so as to evaluate one or more words, e.g., descriptors, of the business listing so as to determine whether one or more of the business descriptors should be replaced by one or more evaluated high performing relevant keywords, such as for inclusion within the business listing, prior to it being published at a search engine website.

As indicated, pursuant to a request for content recommendation, the business listing or review or other recommendation system may employ one or more of the aforementioned analytics processing modules to evaluate one or more of the collected words or phrases, e.g., keywords, in reference to one or more descriptors, for the purpose of determining the potential that one of those keywords might be impactful for the messaging in relation to a respective business, if those evaluated keywords were to be substituted for one or more other words previously used in the communications of the business, such as in their business listings and/or review responses. In this regard, as indicated, in a first step, the evaluation and/or recommendation process, implemented by the computing system(s) of the disclosure, may include initially receiving, or otherwise collecting, such as from a search engine platform, a number of keywords, keyword use, and/or keyword evaluation data. Additionally, the system may collect, or otherwise receive, a number of business, consumer, and/or competitor related data, such as business listing, review, or other engagement related data. These data may be analyzed separately and individually, or may be analyzed collectively together, such as by the keyword analytics module.

Particularly, in a second step, once the aforementioned data has been collected and/or stored within a repository or database of the system, the keyword analytics module may perform a first evaluative process on the collected words and associated data. For instance, the collected content may include communication content, communication use data, along with communication content evaluation data, which may all be used to evaluate a list of descriptors and keywords that a given search engine platform has predetermined to be high performing and/or impactful generally. Specifically, one or more search engine platforms may push a list or compilation of keywords into the system, along with a variety of evaluative and/or metric data, which metric data may be used to evaluate one or more keywords in the pushed, or otherwise collected, compilation of keywords.

In particular instances, the keyword metric data may include the search traffic data relevant to each of the keywords listed as well as their respective volume data. These traffic and volume data may be applied to the keywords to determine what their relative strength and/or impact may be, e.g., generally, as may be determined by the search engine platform. However, in various embodiments, to better determine impactfulness on a more particularized basis, the system can collect and employ a number of other data such as communication evaluation and/or factor data. In certain instances, the keyword factor data may include one or more marketing analytics, such as impression, conversion, sales, reach, and/or engagement data, which may be relevant to determining the ability of any given keyword to provoke engagement by one or more consumers.

For these purposes the keyword analytics module may include a first set of keyword sub-processing engines that are configured for analyzing one or more of the keywords, respective keyword search traffic, respective keyword volume data, and/or other metric and/or factor data to extract a number of keyword insights therefrom, and may further include a second set of keyword sub-processing engines that configured for employing the keyword insights so as to generate or otherwise access a high performing keyword impact model. Consequently, the keyword analytics module may include a further, e.g., third or fourth, etc., set of keyword sub-processing engines that are configured for applying the generated high performing keyword model to the one or more of the keywords so as to produce a number of high impact keywords. In certain iterations, the keyword analytics module may be configured as, or may otherwise access, an artificial intelligence module, and the referenced high performing keyword impact model may be implemented by Large Language Model (LLM) by which the keyword insights may be generated and/or employed in determining the impact of one or more of the list of keywords, such as in the process of determining which keywords are going to be high performing and/or impactful.

In various embodiments, the keyword sub-processing engines of the keyword analytics module may further be configured for employing the collected content, such as communication use data, e.g., data pertaining to how the collected content is currently being used and/or engaged with by online consumers, when extracting the referenced keyword insights. In particular embodiments, the communication use data may include data pertaining to how consumers engage with or how businesses employ one or more of the high performing keywords. Such data can include consumer evaluative data such as with regard to how consumers evaluate or use those keywords to evaluate goods and services they search for online, such as using those words in reviews, recommendations, up or down votes, thumbs up or down, +1 or −1, forwards, and the like. In particular iterations, the determined high performing and/or impactful keywords may further be evaluated, e.g., comparatively, so as to be scored, e.g., relative to each other and/or with respect to the predicted impact they may have on a consumer. For example, the score may be computed in a manner to evidence the relative impact that such use of any of the keywords within a general business listing is predicted to have on increasing a ranking of that general business listing reciting one or more of those high impact keywords.

Additionally, with regard to the referenced keyword semantic analytics module, the various processing elements thereof may be configured as one or more sets of keyword semantic meaning sub-processing engines that are adapted for employing one or more of the previously identified keywords, e.g., the system determined high impact keywords, and their respective communication use data, e.g., how those words are currently being used by consumers, so as to extract a number of keyword semantic meaning insights therefrom. In order to perform these operations, one or more sets of the keyword semantic meaning sub-processing engines may further be adapted for employing the generated keyword semantic meaning insights to generate a keyword semantic meaning model. This model may be applied to a selection of the identified keywords, e.g., the determined high impact keywords, for determining the semantic, e.g., contextual, meaning of the selected keywords.

In particular embodiments, the keyword semantic analytics module may be configured as, or may otherwise be associated with, an artificial intelligence module that is adapted for implementing the keyword semantic meaning model. In certain iterations, the model may be a natural language processing (NLP) classification model that is configured for employing various of the collected data, e.g., the communication use data, to infer one or more categories, e.g., keyword meaning categories, which may be applied to the evaluated keywords, such as based on previously categories learned by the model, so as to determine the semantic meaning for each of the selected keywords, e.g., determined high performing, impactful keywords. In particular implementations, the classification model may employ one or more of a one-shot learning and a zero-shot learning protocol.

Once the selected keywords have been contextually, e.g., semantically, defined, they may then be converted into a symbol, such as a numerical sequence, whereby the numerical sequence may be adapted to represent the semantic meaning of the keyword. In this manner, keywords can be stored within a database of the system sequentially, such as in a manner whereby words that have similar contextual meaning may be grouped together, e.g., categorically, but without the need for the actual words to be labeled. Storing such words both numerically and/or semantically, e.g., without labels, is useful because it allows the system to rapidly identify stored keywords, evaluate them in relation to a determined context, e.g., a business context, and then to select whichever keyword, of a collection of keywords, that the system evaluates best fits the determined business context.

Accordingly, the keyword semantic analytics module may include a number of sets of symbol and/or numerical representation sub-processing engines that are configured for converting each of the selection of high performing keywords into a symbolic, e.g., numerical, representation, which representation may be based on its respective determined semantic meaning. Once the selected high performing and/or impactful keywords have been symbolically represented, a further set of sub-processing engines, e.g., a set of vectorization sub-processing engines, may be employed for converting each of the symbolically, e.g., numerically, represented high performing keywords into a vector representation, such as where the vector representation is based on its respective determined semantic meaning. Likewise, a further set of sub-processing engines, e.g., a set of cluster generation sub-processing engines, may be instantiated and employed for clustering the high performing keyword vectors, such as based on their determined semantic meaning. In such instances, a degree of correspondence between the semantic meanings of the underlying words may be determined, or otherwise be represented, by a degree of an acute angle formed between any two intersecting vectors. Hence, once the keywords have been identified, determined to be high performing and/or impactful, they can then be semantically defined, symbolized, and then can be vectorized, as described herein, and once vectorized the semantically defined vectors may be stored, such as within a repository, e.g., a vector database, of the system, such as in a clustered manner.

In addition to the above-described keyword analytics modules, the system may further include a number of equivalent communication, e.g., business listing, analytic modules, such as a business listing contextualization module, a business listing semantic vectorization module, and/or a business listing vector clustering module. For example, the communication generation and/or recommendation server, or set of servers, may include one or more business listing contextualization modules that may include a set of business listing sub-processing engines that are configured for accessing and analyzing one or more of the descriptors of the business listing so as to extract a number of business listing insights therefrom. Specifically, in various implementations, the business listing may include one or more descriptors that describe what the business does, and may further include a set of descriptors describing one or more of the goods and services being proffered by the business. Hence, the business listing may be evaluated, such as with regard to what the business does and/or what it sells, along with other collected business contextual data, so as to extract a number of business listing insights therefrom.

Particularly, once the business listing and contextual data has been analyzed, and one or more business listing insights have been extracted therefrom, a further set of business listing sub-processing engines may be instantiated and employed for evaluating the extracted business listing insights so as to generate a business listing contextual meaning model. Once generated, or otherwise accessed, a further set of business listing sub-processing engines may be employed for applying the generated business listing contextual meaning model to one or more business listings so as to determine one or more contexts for those business listings. These contextual meanings for the business listing may then be stored within one or more of the content collection repositories of the system.

In this regard, in various embodiments, the business listing contextualization module may be instantiated as, or may otherwise access, an artificial intelligence module, such as where the artificial intelligence module is configured for generating and/or otherwise implementing the business listing and/or review contextual meaning models. In particular implementations, the business listing and/or review contextual, e.g., semantic, model may be a natural language processing (NLP) classification model that is configured for analyzing the business listing and/or review data so as to infer one or more categories, e.g., business listing or review based categories, e.g., from the business listing or review, as well as relevant collected data that pertains therefrom. In specific instances, the business listing and/or review semantic determination model may be pretrained, such as on previously learned business listing and/or review contextual categories, such that when presented a business listing or review, the model may substantially instantaneously determine one or more contextual, e.g., semantic, meanings for the business listing and/or review, which as set forth above, can also be performed with respect to one or more of the identified keywords. Thus, the business listing and review semantic determination module may be configured for determining one or more contexts for the business or the review particulars, e.g., via the application of the classification model, so as to contextually define one or more of the business descriptors of a business listing and/or contextual review descriptors.

Like with respect to the descriptors and/or keywords above, once various of the business or review descriptors have been semantically determined, the determined descriptors may then be symbolized, vectorized, clustered, and stored, such as within a structured, e.g., vector, database of the system. For these purposes, the one or more communication generation and/or recommendation servers may further include one or more business listing or review symbolization and/or vectorization modules, whereby an accessible business or review symbolization module instantiates, or otherwise accesses, a set of business listing or review response symbol and/or numerical representation sub-processing engines that are configured for converting each of the one or more contextual meanings for the business listing and/or review into a symbolic, e.g., numerical, representation based on their respective determined semantic meaning. Likewise, a business listing vectorization module may be included such as including a set of vectorization sub-processing engines that are configured for converting each of the symbolically/numerically represented contextual meanings for the business listing and/or review into a number of vector representations. In these instances, the vector representations may be based on their respective determined semantic meaning.

Once the selected business or review listing descriptors have been contextually, e.g., semantically, defined, they may then be converted into a symbol, such as a numerical sequence, whereby the numerical sequence may be adapted to represent the semantic meaning of the descriptors. In this manner, business listing or review descriptors can be stored within a database of the system sequentially, such as in a manner whereby descriptors that have similar contextual meaning may be grouped together, e.g., categorically, but without the need for the actual descriptors, e.g., words thereof, being labeled. Storing such descriptors both numerically and/or semantically, e.g., without labels, is useful because it allows the system to rapidly identify stored descriptors, evaluate them in relation to a determined context, e.g., a business, consumer, or competitor context, and then to select whichever keyword, of a collection of keywords, that the system evaluates best fits the determined context, such as in a manner that is predicted to increase impact of the messaging.

Accordingly, the business listing and/or review semantic analytics module may include a number of sets of symbol and/or numerical representation sub-processing engines that are configured for converting each of a selection of business listing or review descriptors, which may include key words, into a symbolic, e.g., numerical, representation, which representation may be based on its respective determined semantic meaning. Once the selected descriptors have been symbolically represented, a further set of sub-processing engines, e.g., a set of vectorization sub-processing engines, may be employed for converting each of the symbolically, e.g., numerically, represented descriptors into a vector representation, such as where the vector representation is based on its respective determined semantic meaning. Likewise, a further set of sub-processing engines, e.g., a set of cluster generation sub-processing engines, may be instantiated and employed for clustering the business listing or review vectors, such as based on their determined semantic meaning. In such instances, a degree of correspondence between the semantic meanings of the underlying descriptors and/or words thereof may be determined, or otherwise be represented, by a degree of an acute angle formed between any two intersecting vectors. In this manner, the degree to which the meaning of any two words represented as vectors correspond to one another determines how easily one word can be replaced by another without changing the meaning of the listing or review response, the more acute the angle, the more closely aligned the two words will be with regard to an overlap of their semantic meaning.

Further, once the descriptors have been defined, they may be evaluated so as to determine which descriptors may be high performing or impactful and which descriptors may be suitable for being replaced. Particularly, the descriptors may be semantically defined, symbolized, and then be vectorized, as described above with respect to evaluating keywords, and once vectorized the semantically defined vectors may be stored, such as within a repository, e.g., a vector database, of the system. In like manner, a business listing cluster generation module may be included such as where the module includes one or more sets of cluster generation sub-processing engines that are configured for clustering the business listing contextual vectors based on their determined semantic meaning. In such an instance, a degree of an acute angle formed between two intersecting business descriptor vectors may be determinable of a degree of correspondence between the semantic meanings of respective underlying descriptors. Once the descriptor vectors have been generated, a further set of cluster generation sub-processing engines may then store the business listing semantic vectors within the vectors database of the system.

Additionally, the business listing and/or review response recommendation system may further include a content relevancy determination module. The content relevancy module may be configured for determining the relevancy of one or more words, or the meanings thereof, in relation to one or more other words, e.g., high impactful keywords. For these purposes, the module may include one or more sets of content relevancy determination sub-processing engines that are configured for accessing and analyzing one or more of the keyword semantic meaning insights, the keyword semantic meanings, the business listing and/or review insights, and the business listing and/or review contextual meaning to extract a number of business and/or consumer or competitor relevant keyword insights therefrom.

A second set of business listing or review response sub-processing engines may also be included and may be adapted for employing the business or review relevant keyword insights to generate a business and/or review relevant keyword determining model. Likewise, a third set of business listing and/or review sub-processing engines may further be included, and may be configured for applying the generated business or review relevant keyword determining model to the selection of one or more high impact keywords for determining high impact keywords that are relevant to the business listing and/or review being evaluated. A fourth set of business listing or review sub-processing engines may also be included and may be configured for storing the determined high impact business or review relevant keywords within a first and/or second content collection repositories.

In particular embodiments, the content relevancy determination module may include, or may otherwise access, an artificial intelligence module that is configured for implementing the business or review relevant keyword determining model. In such instances, the relevancy determining model may be instantiated by another Large Language Model (LLM) by which one or more of the keyword semantic meaning insights, the keyword semantic meanings, the business listing and/or review relevant insights, and the business listing and/or review contextual meaning may be employed to determine the business or review relevant keyword insights, which business or review relevant keyword insights may then be utilized by the LLM in determining the high impact business relevant keywords.

Further still, the business listing and/or recommendation system may also include a content evaluation and recommendation module that contains a number of sets of content evaluation and recommendation sub-processing engines. These processing engines may be configured for accessing the high impact business or consumer relevant keyword vectors as well as the business listing or review semantic vectors so as to compare the high impact relevant keyword vectors with the business and review listing semantic vectors, and based on the comparison, one or more high impact business and/or review relevant keywords may be selected for recommended use in a business listing or review response. In this regard, the selecting of the one or more high impact business relevant keywords for recommended use in the business listing or review may be based on a comparison of acute angles formed by respective intersections of the high impact business or review relevant keyword vectors with the business listing and/or review semantic vectors. Additionally, the system may include a business listing and/or review response generation module that is composed of a set of business listing and/or review response generation sub-processing engines, which are configured for accessing the one or more selected high impact business or consumer, e.g., review, relevant keywords, and employing the selected high impact business or review relevant keywords in the generation of a business listing or review response for approval and/or publication at a search engine or review focused website.

Accordingly, with reference to the above, for the purpose of implementing the aforementioned processes, the system may include one or more servers, such as a set of remote or decentralized servers, for instance, where the one or more servers are capable of being coupled to one or more central or decentralized repositories or databases, such as via a network interface. For example, a first set of servers may include a plurality of decentralized servers positioned remotely from one another, such as where one server embodies one of the referenced processing modules for performing one set of operations, while another server embodies a second of the processing modules for performing another set of operations. In these regards, the various remote servers may be communicationally networked together, such as via a wired or wireless communication network, and may be used collectively for performing the various tasks recited herein seamlessly together.

Therefore, in various embodiments, a system of servers may be provided and be configured for working seamlessly together to generate one or more content evaluations and/or for the purpose of generating one or more content and/or communication recommendations. In such instances, each server of the set of servers may include one or more, e.g., a plurality, of sets of processors that are configured for functioning together, such as in a pipelined fashion, so as to form a set of processing engines, where each processing engine may include instructions, or may otherwise be configured to run operations, that when executed by a set of processing engines of the one or more servers implements the various functional components of the disclosure. For these purposes, the server system may include a plurality of communications modules for receiving a large number of data packets, e.g., from one or more associated other servers and/or one or more client computing devices, which data packets, once received, may be reviewed, parsed, aggregated, evaluated, and/or analyzed, as described herein.

In various implementations, the content collection, evaluation, and recommendation system may further include a client computing device and associated display that may be coupled to the one or more servers, e.g., via an associated network connection, such as to send directives, such as from a user of the system, with respect to initiating an evaluation and/or recommendation protocol, which recommendation, once generated by one or more servers of the system, may be sent from the server back to the client computing device, whereby it may be viewed by the user, such as via an associated display of the client computing device. Upon receipt, the user may then review the recommendation and approve or disapprove its posting. In this regard, the system may include one or more databases, servers, and/or client computing devices, which may be distributed away from one another and/or be decentralized but may all be connected via a high-speed communication architecture that allows the various components of the system to work collectively as a group in an efficient manner.

The details of one or more embodiments are set forth in the accompanying figures and the description below. Other features and advantages will be apparent from the description and drawings, and from the claims.

### DESCRIPTION OF FIGURES

FIG. 1 presents a diagram of a representative embodiment of a process for generating a communication recommendation in accordance with the teachings of the disclosure.

FIG. 2 presents a diagram of an exemplary flow of information throughout the disclosed communication recommendation system as implementable in accordance with the process of FIG. 1.

FIG. 3A presents a diagram of another embodiment of a representative process for generating a communication recommendation in accordance with the teachings of the disclosure.

FIG. 3B presents a further exemplary embodiment of a process flow of information throughout an analytics platform of the system in accordance with the disclosure.

FIG. 3C presents a representation of an exemplary embodiment of an analytics system of the disclosure.

FIG. 4 presents a diagram of another representative embodiment of a process for generating a communication recommendation in accordance with the teachings of the disclosure.

FIG. 5A presents a diagram of a representation of various signals and sources from which insights that are useful for generating bespoke communications may be derived.

FIG. 5B presents a diagram of a representation of communication generation process whereby the communication content may be derived from a variety of consumer signals.

FIG. 5C presents a diagram of a representation of a set of communication generation modules that may be configured to act synergistically together in the building of an autonomous communication.

FIG. 5D presents a diagram of an analytics module of the system that may be employed to perform a knowledge extraction process in accordance with the methods set forth in the disclosure.

FIG. 6A presents a diagram of a representative review response generation process in accordance with the methods set forth in the disclosure.

FIG. 6B presents a diagram of a representative online listening and monitoring process whereby various determined signals can be employed as drivers of communication generation.

FIG. 6C presents a diagram of a representative search query being analyzed to derive one or more keywords and/or keyword categories therefrom.

FIG. 6D presents a diagram of a representative prompt generation process set forth in the disclosure.

FIG. 7A presents a diagram of representative content and engagement modules of the system.

FIG. 7B presents a diagram of a representative key offering extraction process in accordance with the teachings of the disclosure.

FIG. 7C presents a diagram of a representative content generation process in accordance with the teachings of the disclosure.

FIG. 7D presents a diagram of a representative keyword cleaning process in accordance with the teachings of the disclosure.

FIG. 8A presents a diagram of a representative communication generation process in accordance with the teachings of the disclosure.

FIG. 8B presents a diagram of another representative knowledge extraction process so as to generate semantic meaning in accordance with the teachings of the disclosure.

FIG. 8C presents a diagram of a categorization determination process in accordance with the teachings of the disclosure.

FIG. 9A presents a diagram of a representative subject extraction process in accordance with the teachings of the disclosure.

FIG. 9B presents a diagram of a representative category extraction process in accordance with the teachings of the disclosure.

FIG. 9C presents a diagram of an exemplary embodiments of the constituents of a communication generated in accordance with the teachings of the disclosure.

FIG. 10A presents a diagram of an exemplary calendar of scheduled communications to be distributed in accordance with the teachings of the disclosure.

FIG. 10B presents a diagram of an exemplary communication generation process in accordance with the teachings of the disclosure.

FIG. 10C presents a diagram of an exemplary content generation process in accordance with the teachings of the disclosure.

FIG. 11A presents a diagram of another exemplary embodiment of a communication generation process where the communication is generated in response to a question being posted online.

### DETAILED DESCRIPTION

In view of the above, presented herein are devices, systems, and their methods of use for generating a communication, such as a business listing or review response, to be recommended for publication, or other form of distribution, at an online communication platform. In one aspect, provided herein is a communication system that is configured as a business listing recommendation platform, which platform may be used for generating a business listing for publication at a search engine website. In particular embodiments, the communication recommendation and generation system may be further adapted for recommending content to be included in a business listing, review, social media post, or other online communication. In either of these instances, the communication, e.g., a business listing or other online message, to be published or otherwise posted, may be evaluated and modified so as to include one or more high impact and/or relevant keywords, such as where the keywords have been evaluated and recommended for use within the communication based on one or more insights having been generated by the system and/or accepted for use by a system communicator, e.g., user of the system.

In its simplest iteration, the listing platform is configured for allowing business owners, be they large multinational corporations, small mom and pop shops, or even a single person, such as a social media influencer, to access a plurality of listing and/or social media platforms, as well as all the various communication channels that make up those platforms. Once accessed, such as via a suitably configured client computing device, a user of the system can, from a single access point, transmit communications nationwide, where the communications may be the same or different depending on its intended audience either on the global and local levels. For instance, in one implementation, business owners can use the communication platform to set up, upload, and manage all of their business listings and/or review responses, across all the various different listings, reviews, and other social media platforms, both globally and locally.

This is useful because in many instances the various associated listings, reviews, and/or social media websites are constantly changing their formatting, updating their terms, services, and user information requirements, and thus the system may be configured for receiving data, e.g., pushed data, and/or collecting such data from these websites, and then implementing any requirements therein so as to ensure any published communication data, e.g., listings or review responses, meet the website requirements and is always kept up to date, e.g., real time, and accurate with respect thereto. Hence, in various embodiments, the communication recommendation and generation system may be configured for the autonomous updating of listings, as well as autonomously responding to reviews and other engagements, across a number of business listing, review centered, and/or other social media platforms, for a multiplicity of brand locations. In various instances, the business or brand owner may be a multi-location brand, servicing from 2 to 10 to 100 to 1,000s locations, or more, or the business owner may run a small, community focused business. In any of these instances, it is often difficult, if not impossible, to manage consistent, comprehensive listings, review responses, and communications throughout the entirety of the business and/or multi-location organization and across all communication platforms.

Accordingly, to solve this problem, provided herein, is a communication, e.g., listing and/or engagement response, management system that provides system users, e.g., communicators, a suite of modules by which using a single user interface, e.g., such as via an application running on a client device, all communications throughout the organization can be viewed, generated, approved, transmitted, and otherwise managed, such as using a desktop or handheld mobile computing device. In this regard, be it a business listing, engagement response, such as a review response, or a social media post, this system is useful for ensuring that a business owner can take personal control of their relevant business listing and social media channels, such as by creating listings, review responses, and/or postings thereon, as well as for using those channels as vehicles by which to distribute communications. Further, the communications management system is useful for guaranteeing all communications within and distributed outside of an organization are consistent, relevant to the business and/or its target consumers, and that the communications are accurate.

The system presented herein, therefore, is especially useful where the communication is configured as a business listing that is meant to be posted at a business listing platform and meant to be found in response to a consumer enquiry being entered at a search query interface provided by a website hosted by the business listing platform, such as at GOOGLE®, FACEBOOK®, BING®, LINKEDIN®, YELP®, and the like. In this regard, any number, 10, 20, 50, 60, 80, even 100 or more business listing and/or review websites can be managed via a single graphical user interface (GUI) of the system.

Managing all communications across all listing platforms is very problematic because each search engine implements a search function by use of an algorithm whereby words entered at the search engine interface, such as by a consumer performing a search for goods and/or services to purchase, are evaluated and compared to a number of business listings stored within a database associated with the listing platform, so as to identify, retrieve, and present to the user a number of business listings that best match the requirements of the search query. Consequently, upon a search query being entered at the business listing platform, a number of business listings are evaluated and scored, such as for relevancy, and then a select number of listings are returned and presented to the consumer in a list whereby the business listings that best match the search criteria are listed in descending order of relevancy. Hence, the business listings will be evaluated and ranked by the search engine algorithm in accordance with their determined relevancy. This search engine algorithm, however, changes constantly throughout the month, in an unpredictable manner, and so it is virtually impossible to determine what factors it will weigh and to what degree when determining relevancy.

Ostensibly, the purpose for these changes is to level the playing field so as to allow each business to have an equal opportunity for success, which success should be directly related to the natural, homegrown popularity that business has garnered by their ability to reach and meet the needs of their customers. So being, the more an online business meets the needs of online consumers, and gives them a good customer experience, the more these consumers will review and recommend the products and services of that business, and the more the reputation of the company will trend naturally and thus be ranked higher in the ranked list of businesses returned by the search return algorithm. This being the case, the more people are using the internet to talk about a business, and the more those consumers engage with and discuss, e.g., review, the business and its products and services, the higher up in the search ranking it will move, and, thus, the higher up in the search results it will be placed.

In certain instances, however, these natural characteristics that cause a company to trend online can be gamed, thereby allowing a company to appear higher up in the search results, and thus, giving them a competitive advantage in the marketplace that could be worth thousands to millions of dollars or more. The constant changing of the search return algorithms, therefore, is an attempt to prevent such gaming from occurring so that the rank order of the search results are naturally derived. Nevertheless, understanding how such search algorithms function, can help online businesses take better advantage of their natural social growth as well as to better increase that growth. Understanding the black box of these algorithms and how they function, and learning to identify and promote factors that increase a company's ability to rise in the search results rankings is of paramount importance to ensuring the success of an online business.

Accordingly, an aspect of the technologies disclosed herein is that they are configured for not only determining the factors that are likely to be highly weighted by a multiplicity of models being implemented by various search engine algorithms, but they are also configured to determine what activities a business should engage in that will best fit those models so as to promote natural social growth. The result of a business advertising the performance of such activities will naturally be a higher ranking in retrieved search results. The processes set forth and described herein, therefore, are designed to manage a company's social listings, social media communications, reviews, and other engagements, on a global basis, and in a manner that not only is consistent throughout, but is also locally relevant, and accurate in addition to including factors that promote a high ranking amongst search engine models.

The enactment of such processes will not only result in a higher ranking amongst returned search results, but higher visibility, thereby making it easier for current customers to find what they are looking for in a brand they already trust, but to also more easily appeal to new customers by making them aware of the popularity of their goods, services, and other offerings. Along these lines, the greater the consumer experience with goods and services of a business, the more likely they will be to speak positively about the business, e.g., by posting positive reviews. Ultimately, in response to future search queries, the expected result will be higher consumer engagement, especially with regard to generating more meaningful impressions and an increase in conversions and sales.

Specifically, the devices and systems described throughout this disclosure, as well as their methods of use are configured to enhance the ability of a company's communications to include touch points that will more closely align their communications with the factors being valued by search engine models to thereby achieve higher search result rankings. This is useful because the greater the number of search results a given company's offerings are included within, and the higher up on the ranking of those search results a business gets listed, the greater the chances are that the company's offerings will naturally be viewed by the consumer. This is important because, as set forth above, it leads to a greater probability of generating a sale, at a lower cost than having to incur the high pricing of paying for click-through advertising, absorbent fees of paid promotions via social media influencers, and uncertain return on such investments.

Another benefit of the presented communications recommendation and generation platform, as indicated, is that it overcomes the challenges of generating and managing both global and localized business communications at scale, and in an automated fashion. Particularly, the communications platform may be used to manage and automate a large variety of communications, such as with respect to business listings and engagement responses, such as with regard to review replies, which can all be tailored to have both a global, brand look, while maintaining a local, personalized feel. This is useful because it allows the communications system to autonomously generate and control communications in a manner whereby all the good will inured to the global brand, e.g., the brand promise, can be leveraged by all the associated, local businesses, but each communication can be crafted in such a manner that the content employed in the massaging reflects the tenor and tone of each local community that each respective localized business serves.

As described herein, at the core of the communication platform is an analytics system that includes a workflow manger, e.g., agent, that is configured for monitoring communications and postings that pertain to business communicators, e.g., which are published online, and then determining the contexts and meaning of those communications so as to determine the appropriate response, such as to achieve a business objective. In various instances, the communications platform may be automated whereby various operations may be performed by a specially trained AI module. In such an instance, the workflow manager may be termed an AI agent, which agent may be one or a plurality of agents that have been specifically trained to perform specialized tasks and operations of the communication platform.

As will be described herein below, in order to perform these specific tasks, these workflow managers, e.g., agents, may be specially trained on both unique localized as well as global datasets, so that each agent becomes hyper localized, but globally reaching so as to drive business objective outcomes, such as at local and global scale. In particular instances, these specialized, autonomous agents may be configured to act either in a supervised or unsupervised manner. In these regards, in producing a specially trained AI agent, for performing a specialized task, each agent may be trained on a number of different data, or on data that is specific to the particular task to be performed, and at a particularized organizational level, such as a global and/or local level. In this context, the workflow managers set forth herein may be made into specialized AI agents by being trained on one or more of localized data specific to a given business, e.g., brand, within a determined local, e.g., franchise, served community and market, and may also or alternatively be trained on global data specific to the overall industry with a more far reaching, e.g., national, market. Such specificity may further be implemented with agents being trained on consumer information and data, competitor information and data, as well as a combination of the same.

In certain instances, a single agent may be trained on all of this content, information, and data, or a plurality of agents may be trained exclusively on data from each separate category, but where the AI agents are configured to act synergistically together so as to produce a more comprehensive result, dependent on the tasks to be performed. In this manner, a communication being crafted, such as in response to an online engagement, can be tailored in such a manner to account for national industry trends, while maintaining a unique brand voice that highlights the look and appeal of the overall corporate promise, but further implements insights derived from the local communities being serviced by each local, community based business representative of the national brand. The results of crafting communications in these manners is that, on one hand, the messaging may be unique in its content so as to appeal to community based consumers, hence, the messaging will have a local feel as to its tone, tenor, the idioms and expression used, but also has a national brand look that taps into the global brand goodwill and reputation, all the while using key terms and language that boosts the communications higher up in the rankings in response to various search queries being entered at various search engine websites. Hence, from the consumer side, the online customer has a much better bespoke experience, while the brand cache and reputation increase by a process of increased and consistent responsiveness to consumer engagements and review responsiveness.

Currently, online retailers, especially those with many local, regional locations do not recognize the problem of global messaging may be out-of-sync with local, community-based contexts, and the global voice may, at times, be antithetical to, or otherwise not helpful for, the local voice. Hence, in their communication strategies they opt for “one-size-fits-all” approach to managing their locations'online presence, they employ the same categories and same descriptions across all their locations, without even attempting to cater their listings and communication to the local environments within which many of their business units reside. Thus, in many instances, their business listings and other communications are not helpful at best.

The present communication platform herein disclosed overcomes this problem by allowing for the generation and/or recommendation of communication content that is attuned to and effectively reaches local audiences in different localities with localized messaging and voice. The present devices and systems as well as their methods of use provide for a localized approach that current solutions in the market fail to provide, leaving it on the local store managers to do, which they typically do not. The communication platform herein is a new technical system that allows optimizing local business listings for each of their local audiences, e.g., within a set range, such as about 1 to about 50, such as about 2 or 10 to about 30 or 40, including about 15 to 20 or 25, mile radius, etc., which is based on the unique customer behavioral patterns, foot traffic, search queries, demographics, weather, etc., specific to that locality.

Another problem, in addition to the ever-changing search engine algorithms, is the fact that the manner by which consumers perform searches using the various search engine portals is also constantly evolving. For instance, consumers are becoming much more discriminating in the products and services they purchase, and the manner by which they perform searches have, therefore, become more sophisticated. Particularly, instead of searching for a “coffee shop” near a given zip-code, and just selecting the closest shop, consumers are now searching for a “coffee shop” within a given zip-code range, but are also including in their search query a number of different various coffee producers, coffee types, as well as proffered shop amenities, such as couches, live music, food and pastry selections, and the like. All of these elements form a string of keywords that may be used as touch points by the search engine algorithms in evaluating whether a given business meets the criteria of a search query.

Such multiple keyword searching really narrows down the number of shops that will fit the required categories, which is good for the consumer so that they find exactly that for which they are looking, but it is not so good for potential businesses, e.g., coffee shop owners, that don't have the amenities that fit the required search strategy. Consequently, search strategies and the methodologies they employ are becoming more complex, and as a result of this, business owners need to be more sensitive to the needs of their consumers and more aware of what the current search trends are, so that they can be sure to cast the widest possible net when marketing their business, e.g., posting business profiles and/or listings. More particularly, businesses need to know more fully what the consumers want, and be proactive in making sure they not only offer the products and services being sought by the consumer, but that they market those products, services, amenities, and accouterments in a manner such that the various different search engines tag these offerings in the greatest number of possible hits, thus, making their business more visible to consumers, e.g., raising their order in the rankings.

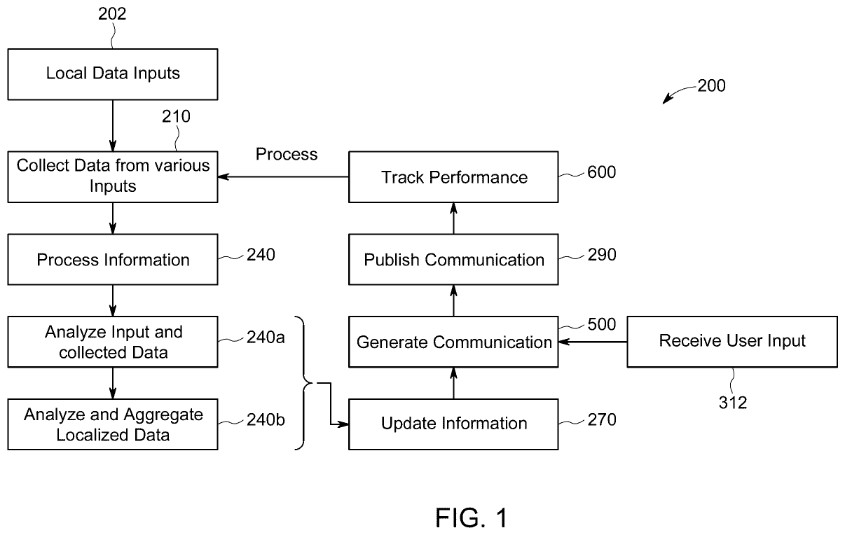

In view of the foregoing, the present devices, systems, and their methodologies of use presented herein are adapted for solving these and other such problems. Specifically, as set forth herein with respect to FIG. 1, the systems and devices herein described provide for processes and methods for collecting data 210, processing the collected data 240, and analyzing the results thereof 240a, 240b so as to identify products, services, and the messaging surrounding them that are determined to be capable of provoking particular responses from online consumers with respect to making a business decision. These analyses are important for identifying and determining high performing, impactful content that is both relevant to a given business, but which can be incorporated in their business communications so as to increase engagement, and thereby increase sales, e.g., lift. More specifically, the system 1 is configured for initiating the searching and/or collecting 210 of content, such as high impact, e.g., trending, communication, e.g., listing or messaging, content 211, marketing and/or consumer behavior 212 content, market evaluation content 213, and business content 214, that can all be analyzed, evaluated 240, and used to generate 300 new business listings and/or social media communications.

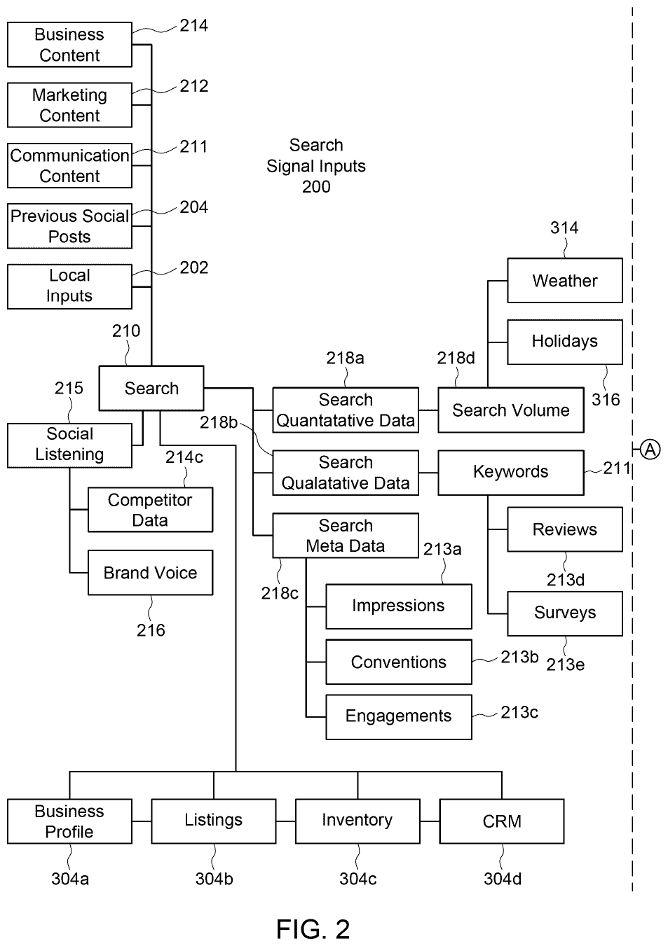

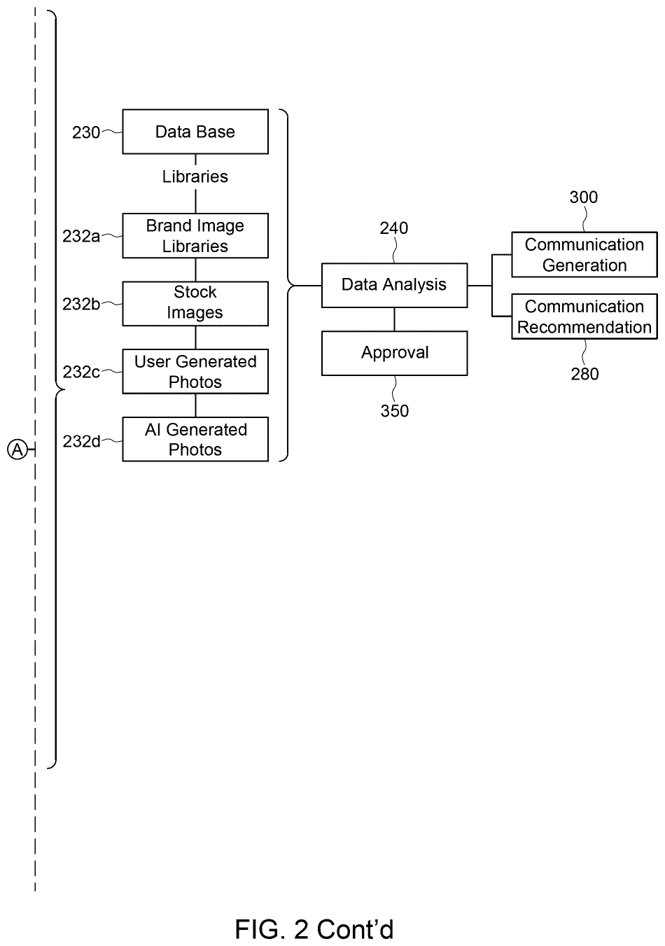

For instance, as can be seen with respect to FIG. 2, the content to be collected can be of a number of different types. Particularly, on one hand, a first type of content to be collected may be communication content 211 that can be used to generate or update a business listing, which may be published on one or more listings websites, such as Google®, BING®, YELP®, FACEBOOK®, and the like, or to generate one or more communications that may be posted, or otherwise transmitted, on a social media platform. The communication content 211 to be collected is not just any content, but rather, content that is suspected of being high performing and/or expected to be impactful in that the content is predicted to provoke one or more actions by the potential consumers who view the content.

In various embodiments, such communication content 211 may include one or more keywords 211a and/or keyword data 211b. So being, on the other hand, the second type of content to be collected may be consumer characterization or behavior data 212, marketing content and/or valuation data 213, which marketing data 213, may be used to evaluate the communication content 211 with respect to its ability to have the desired impact, and business characterization and/or listing data 214 can also be collected. Accordingly, in particular instances, in order to more accurately evaluate the communication content 211 consumer behavior content 212 and/or business behavior content 214, may also be collected by the system 1. Such consumer behavior content 212 may include data pertaining to how the consumer behaves with respect to online publications, such as in regard to business listings and/or social media postings, and how the consumer interacts with them, and based on these interactions, the system can collect, or otherwise generate, market evaluation data 213.

For instance, typically a consumer can interact with published online content in three general ways. First, they can “see” the business content, termed an impression 213a, and this is inferred when the content is posted to a webpage, such as on the boarder thereof, which the consumer is viewing. Essentially, when a business listing or advertisement is posted to a website being viewed by the consumer it is inferred that an impression 213a has occurred and that the consumer has “seen” the advertisement. Once seen, the consumer then has a decision to make; they can either ignore the listing or advertisement, or they can engage with it, e.g., they can click on it, which is termed a “conversion” 213b.

Additionally, once a consumer has clicked on the listing or advertisement they can further engage with it by purchasing the advertised product or service, placing it in a corresponding shopping cart, perform a further search on the proffered product or service, reviewing it, or otherwise further engaging with it, which is termed an engagement 213c. Leaving a review is an important factor because it shows the consumer was passionate about the product, and thus, review data 213d can also be collected and evaluated by the system 1. In various instances, one or more surveys 213e can also be generated by the system 1, or otherwise be collected, so as to determine how consumers engage with and/or like the proffered products or services of a business, which is useful for safeguarding the reputation of a brand. The communications platforms and process of utilizing the same are useful for optimizing consumer communications that provoke consumer engagement in a series of communications that increase consumer knowledge, generating growth, while maintaining consumer interest and avoiding communication burnout. These objectives may be achieved by scheduling the communication generation and subject matter content thereof so as to ensure the consumer never receives the same type and content in a communication back-to-back.

Analytic data, such as keyword metric data 211b, including keyword search traffic data 211c and keyword volume data 211d, can also be collected in addition to the keyword and associated data 211a, whereby the keyword metric data 211b may be used to evaluate the collected keywords 211a. Various factor data, which can include market content evaluation data 213 may also be collected and used to evaluate the level of impact any given keyword 211a is having within the market. In this regard, the market factor data may include data relevant to determining the number of impressions 213a, conversions, 213b, and/or engagements 213c any given keyword 211 is generating in the market, such as by eliciting increased consumer behavior 212. Quantitative 218a and qualitative 218b keyword 211 data may also be collected, such as including the number of times the keyword was used and how it was used, the number of different consumers using the word, the number of search engine platforms using the keyword, and how high up in the rankings the keyword appears, are all data that can be collected and used by the system to evaluate the keyword. Associated keyword and/or webpage metadata may also be collected and likewise employed.

Additionally, the system 1 may further collect business listing data 214 for a business, which may include descriptions of what the business does 214a as well as what the business offers for sale 214b. Additional business characterization information 214c and/or business competitor 214d may also be collected. This information can be evaluated by the system to determine the meaning of the business listing 214 as well as to evaluate the nature of its offerings. In this regard, the system may include a social listing module 215 having one or more sets of processing engines that are configured for identifying and collecting keyword 211, consumer 212, evaluation 213, and business 214 relevant data that can then be used by the system to evaluated the collected data, e.g., the collected keyword 211 and/or business listing data 214. Such listening can be closely attuned or otherwise associated with the various searches 210 being performed across any number of search engine platforms. In particular embodiments, the system may collect a number of different business profiles 304a and/or their associated business listings 304b, such as for business proffering the same or similar goods and services for sale, so as to analyze such data and provide business insights with respect thereto. Further, the system 1 can be coupled with the inventory 304c and/or customer service resource management tools 304d of a business to better track and manage communications of the business and ensure their communications are consistent with CRM and/or inventory statuses. In certain iterations, the system 1 can also access weather 314 and holiday 316 data so as to account for such data when generating recommendations.

The system 1, therefore, may be configured for both collecting and processing communication content 211 and/or listing 214 data, as well as for evaluating such communication content 211, e.g., keywords 211a, and listing data 214, such as with regard to the ability of those keywords 211 to provoke the consumer to better engage with the goods and services being offered for sale with respect to that particular business listing 214. In essence, the system 1 can measure the impact of the messaging on the consumer, as well as measure the ability of the system to target the online consumer with goods and services that can meet their wants, needs, and desires. Further, the system 1 can collect impact data, e.g., data pertaining to the effect the targeted messaging of a business is having on consumers, en masse, can derive insights thereof, and can then employ those insights in updating 270 business listings and social media communications as well as in generating 300 and/or recommending communications that can then be published 290. The system 1 can also then track performance of its recommendations to determine the incremental lift in the marketplace that occurs when those recommendations have been implemented. For these purposes, the system 1 is configured for receiving user inputs 312 as well as to respond to the directives thereof.

Hence, the system 1 is configured for evaluating and analyzing 240 online communications, e.g., listing and/or advertising communications, with respect to their ability to match goods or services with consumers who are in need of and searching for those goods and services in a manner that evokes a response, e.g., engagement 213c, with them, and thereby increases the probability that the targeted consumer will favorably engage with the communication content. In this regard, the communications platforms set forth herein have been configured to employ intelligent workflow managers, e.g., AI agents, that are trained to optimize communication, e.g., listing and/or review response accuracy, while also increasing visibility of and engagement with the underlying content.

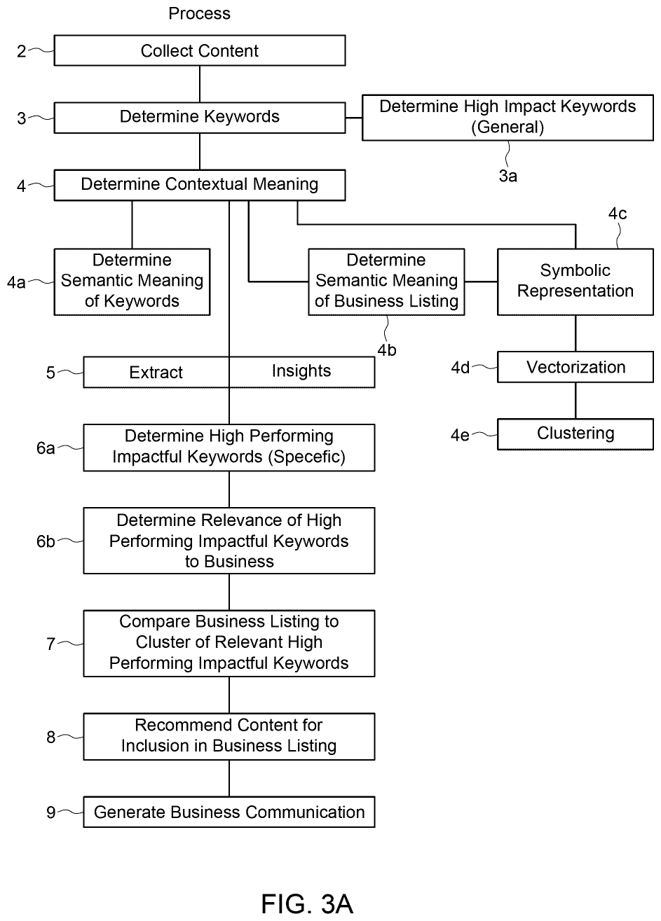

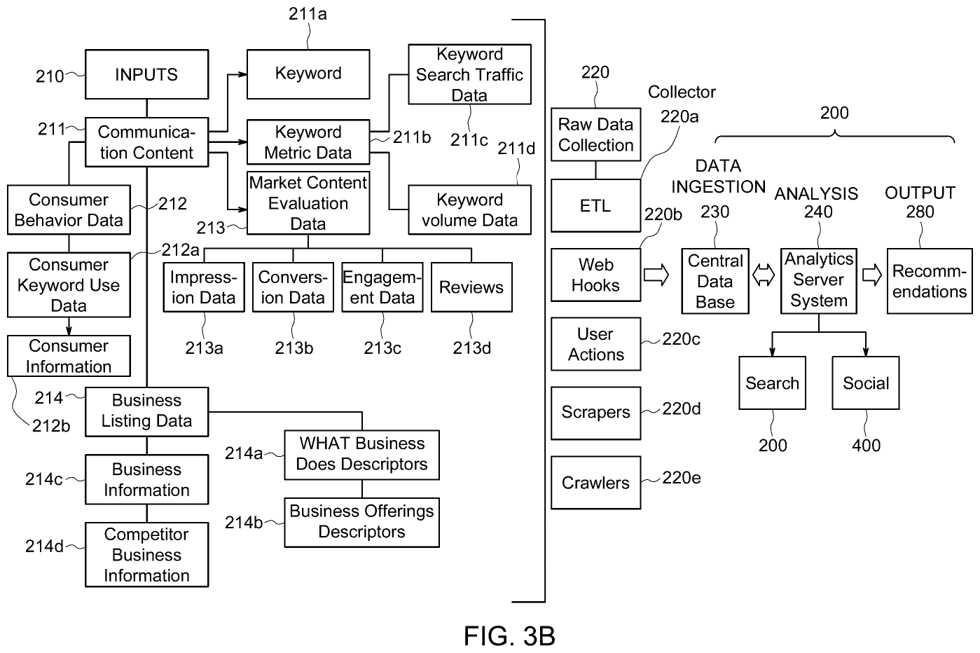

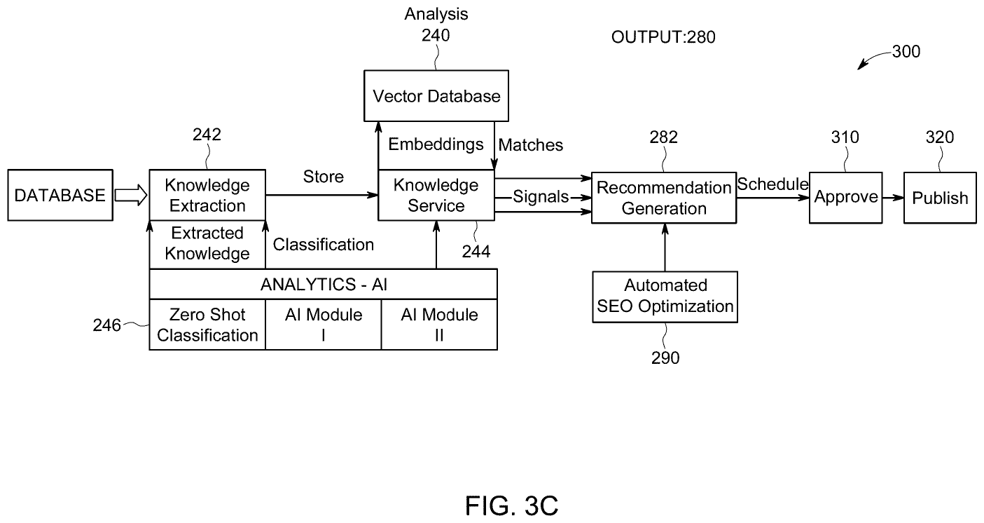

Accordingly, a benefit of the system with respect to using a search engine to perform a search, as explained in greater detail with respect to FIGS. 3A, 3B and 3C set forth herein below, is that the system 1 can perform an analysis of present business listings 304b, search results 210, and/or other social media postings 204, so as to provide insights whereby subsequent communications, whether they be a listing, a search result, or a social media posting, can be formulated in such a manner that subsequent use of the communication by a business owner, service provider, or other communicator, will increase the likelihood that any future analogous searches will result in the business listing and/or posting returned in response to a search will be advanced in the rank order of returned search results, so as to improve the probability of the communications being seen by the potential customers of the communicator.

For example, there are a number of ways by which proposed communications to be published can be evaluated with respect to improving their impact. One such manner that thus can be accomplished is by identifying and using high impact keywords in one's messaging. Specifically, this can be performed by determining key words, e.g., branded or non-branded keywords, that are trending or for whatever reason seem to be prevalent in top ranking search results. Therefore, as can be seen with reference to FIG. 3A, in various instances, the system 1 may analyze top performing search results for a given topic in a specific field of business, and identify prime or non-prime keywords, such as words that are not typically well known to be associated with top hits, and then may evaluate, weight, and/or use those words in generating communication content for a business in the field. Identification of these non-prime keywords are important because they represent a unique opportunity for exploitation that the use of prime words does not represent because everyone already knows about, and therefore, they have already been exploited.

As indicated above, another example of a way the system 1 can provide communication insights 250 is to analyze a multiplicity of behaviors from a number of different business 214 and/or consumers 212, such as within the same classification, and determine commonalities within these behaviors that can be identified and used to craft effective, high-ranking communications and content that can be recommended 280 for use in communication generation 300. In part, this process is useful because it allows the system to determine what is currently trending and affecting rankings at the present moment, such as with regard to what consumers are searching for, and how, e.g., what language they are using to perform their searching now. In such instances, the system can not only identify keywords, phrases, and language that consumers are employing to perform searches, so that the system can determine high ranking material that is presently trending, but in view of this determination, the system can also then review and analyze the business listings and communications of an organization, in view of the referenced search analysis, and may then make one or more recommendations as to how the language currently being employed by that organization can be changed so as to more effectively model the high ranking language that appear to be positively impacting search results. Specifically, in one implementation, the system may make recommendations of what language or concepts should be changed or substituted for which language or concepts that should be used or otherwise employed, e.g., what descriptions should be used in a business listing, what categories should be referenced, and/or what products or services should be proffered in view of what is currently trending.

A further advantage of the present system is its scalability. Scalability is important here because many businesses have branches or franchises in a multiplicity of locations, and therefore, the system is configured for providing insights both on a global, but also on a location specific level, and also highlighting when those insights vary and/or may be in conflict with one another. This is especially important where different locations of a brand may have different product or service offerings. Hence, the system is adaptable for generating business insights on a multiplicity of horizontal as well as vertical levels.

Consequently, from the user, e.g., business side, at the core of the content evaluation and communication generation architecture is the account, such as the corporate account, which may form a central hub, from which all other, e.g., local accounts, radiate. All communication and/or other designated data, whether it be pushed or collected, may be stored in a centralized repository, such as of one or more servers, whereby the stored data may be aggregated, analyzed, and used in the performance of the methods disclosed herein, such as for communication generation and transmission. From this centralized repository, data can be pushed down to the servers and/or other computing systems of the local sub-systems, and likewise, these subsystems can push data upwards to the central repository.

In this manner, as described in FIGS. 2 and 3B a multiplicity of data from all over the organizational and system architecture can be aggregated, analyzed, and integrated system wide, both on a central and distributed, local level, such as their business profile 304a and listings 304b data describing what the business is, what it does, what goods it proffers, and/or what services it provides. Although a number of data being collected by the system may primarily be directed toward communications and their content, any number of other data may be collected, aggregated, integrated, e.g., into the central or distributed repository, and used in advancing the purposes described herein, such as inventory 304c including Customer Resource Management (CRM) data 304d. Such data can be collected from any associated location across any communication platform be it a listing platform or a social media platform, and different data and/or data elements can be extracted therefrom, whereby one or more insights can be derived therefrom all at real time.

In this manner, the system is designed to create a comprehensive list of Best Practices for Search Engine Optimization, which best practices can then be used in the recommendation of new, relevant, high performing communication content, as well as its use in the communications generated. Likewise, using these identified Best Practices principles, the system can also analyze the present communication content of a business and generate a detailed list of what content they should change, for which specific communications, and why. In particular iterations, the system can further determine a predicted rise in search rankings as well as a potential increase in incremental lift that could be achieved by implementing the new communication content.

In these regards, the system 1 is configured for collecting a plurality of data, e.g., communication content 211 and/or metrics 211b and factors 213 related thereto, from a variety of different channels, analyzing the communication content 211 in relation to the determined metrics 211b and factors 213, and then both of these data can be evaluated with regard to a business objectives of a business, and then using the analytic results of the analyses, the system 1 can identify high performing, impactful keyword content that has been determined to be relevant to the business, such as for the crafting of messaging content and/or recommending 280 its use in generating communications 300. In a manner such as this communication content 211 can be evaluated so as to determine its suitability as content that can be employed in the generation of advertisement messaging 280 that can be listed on one or more listing channels and/or employed as messaging that can be transmitted across one or more social media platforms.

Specifically, the collected communication content 211 can be evaluated in relation to one or more metrics 211b and factors 213 so as to generate one or more insights, e.g., signals, therefrom, which signals can then be used to determine which content is suitable for use in a communication and in what context, such as by being evaluated against one or more metrics, factors, and/or other parameters related thereto. In this manner, potentially high performing content for any given listing and/or search engine platform may readily be identified, evaluated, and determined. In various embodiments, the collected factor data 213 may include behavior data 212, 214, such as behavior data related to the potential communication content, which can then be used to evaluate the content and its suitability for use within a communication.

In particular instances the behavior data may be related to consumer 212 and/or business 214 behaviors, such as with respect to the kind of products and services a given business proffers 214b, and/or in relation to how one or more consumers 212 relates to those products and/or services, such as with regard to the online comments they make about those products and services, e.g., comments, views, up or down votes, likes, dislikes, and the like. These evaluation data may be used to identify high performing content that may be evaluated and predicted to increase the potentiality for provoking impactful engagement and/or to increase incremental lift. In certain embodiments, the identified and/or collected messaging content can be evaluated with respect to its ability to increase the potentiality of the communication within which the evaluated content is employed to be ranked higher by one or more search engine platforms. In such instances, the communication content can be evaluated against past ranking behavior of a search engine ranking algorithm, and the communication can be modified to include content that is predicted to raise the ranking of the business employing that content in its messaging to promote its products and services.

For example, search engine evaluation and ranking behavior may be used as metric data 211b by which messaging content can be evaluated. Additionally, use of impactful prime and non-prime keywords may be evaluated with respect to their effect on the rankings if employed in any given communication. For these purposes the system may evaluate potentially impactful words, phrases, products, and/or services to determine which are trending, such as which are currently being used in search queries, and the like, and can then recommend their use in the communications being employed by a business or other person using the system to generate messaging in hopes of creating engagement that is of a type to increase bottom line sales. A number of other engagement parameters can also be considered, such as with regard to what online content current consumers are engaging with, e.g., liking or disliking, upvoting or downvoting, +1 or −1ing, hearting, thumb up or thumb downing, sharing, forwarding, tweeting, re-tweeting, commenting on, reviewing, and the like.

This data may then be employed in determining metrics 211b and/or factors 213 by which the system 1 may determine what terminology is currently trending. In such instances, evaluative comments, such as made in reviews and other social media postings and online content, can be parsed, collected evaluated, and used as signals, which signals can be used to generate, or modify, communication content that can then be recommended to business owners for use in their business listings and other communications. Accordingly, in various embodiments, a communication generation platform of the system may be specially configured and trained to identify, textually and contextually understand, and autonomously respond to the posting of reviews. As indicated, all of these processes can be managed, monitored, and controlled via a single dashboard interface of client computer device, so as to continue ensuring that the reputation of the business is maintained at a high-quality standard. Where a change to the communication generation process, or a change to the content of communications is found to be useful, such as for increasing engagement, the analytics module of the system can recommend such changes to the user, such as via the dashboard interface. Other recommendations that may be derived by the analysis of content herein is with regard to what classification, types, and manner of products or services that are currently being promoted and are trending online, whereby the system can recommend that business owners stock up on, offer for sale, discount, advertise about, and the like.

In this regard, other signals that can be identified, analyzed, and the results thereof provided to business owners as insights may include forward looking data, which may be predicted to be of importance to various business owners. For example, weather data 314 may be analyzed to determine upcoming climatic events that may affect communities and the businesses that service those communities, so as to recommend the stocking up of products that may be relevant to preparing for the upcoming weather, such as stocking up on rain coats and/or umbrellas, during times of rain and/or snow, or sunscreen, such as during sunny days, and the like. Additionally, calendar data 316 can also be accessed and analyzed so as to inform the type and timing of recommendations, as well as to assure opening and closing data of listings to account for holidays. In various instances, the results of the analysis, e.g., resultant analytic data, may be used to recommend a response, however, in other instances, the system can automatically implement the recommendations.

For instance, the system may regularly perform communication analyses to determine accuracy, and where an inaccuracy is determined may autonomously correct the inaccuracy. This is useful, such as with regard to business operation hours, such as during holidays, whereby various businesses may have different operational hours. In such instances, the system may autonomously determine there is an inaccuracy in published communication content, such as by listening to customer or business owner published content regarding the same, which contradicts the published data, and in light of this contradiction may recommend the language be changed, and in some instances, may autonomously implement the needed change, such as to ensure accuracy. A multiplicity of signals can be generated and evaluated collectively when making recommendations, such as where the system 1 determines there is inclement weather coming, and in response thereto, recommends a store closing early, so its employees can make it home safely, or stay open longer, to better provide for its customers.

And when the recommendation is accepted, or otherwise implemented, the system may then autonomously change the posted business hours, or any other data that has been changed, in view of the acceptance (or rejection) of the recommendation. Further, as indicated, although these changes are adopted 350 at one local, location, such changes need not be implemented globally, such as where the weather is not affecting stores in different regions, or may be implemented globally, where the changes affect every location, such as when changing store hours to accommodate the extended hours of holiday shopping, and the like. Hence, both real-time and future predicted data may be analyzed and used by the system for a variety of purposes, such as for making and/or implementing recommendations 280 in business practices and/or communications related thereto.

Further, it is not just about identifying metrics 211b and factors 213 that can then be used to generate the signals used to evaluated and recommend communication content 211, but the system 1 can also identify other data associated with metrics, 211b, factors 213, and signals, such as volume, number, breadth, and other such data can also be collected by the system and used in the evaluation processes herein disclosed, such as to determine keyword 211 impact. The impact of metrics 211b and factors 213 is important when evaluating signals, because if the metrics, such as volume, are low, and/or the factors, e.g., engagements, are small, then the impact will correspondingly be low. Consequently, the system is not only configured for identifying key signals, but also determining associated metrics and factors by which to determine the relative impact of any given signals, such as its impact for increasing its ranking in the return of search results, and based on that impact, determining if a recommendation of a proposed change to communication should be made, and if so in what regard, and also further determining what the predicted results will be, e.g., with regard to an increase in ranking lift, other metric, and the like.

The system, therefore, may be configured for capturing, e.g., identifying and collecting, impactful content, which content can be evaluated, such as with respect to a predicted level of impact that content may have on one or more targeted consumers, such as with regard to the listing and/or communications being posted or otherwise published. The system, then, may use or recommend the use of identified high impactful content in the generation of communications that can be posted online, such as in the description of a listing, or otherwise conveyed to consumers, such as via direct messaging or via a social media platform. The system, therefore, may identify high quality subject matter, and use that subject matter to build, e.g., autonomously generate, a communication that can either be transmitted, e.g., broadcast, directly to consumers, or the communication can be configured for being approved, such as by a system administrator, e.g., an advertisement marketeer, prior to being posted and/or transmitted.

In such instances, a useful feature in generating and/or broadcasting communications, e.g., approved communications, is maintaining the voice of the communicator, whether that voice be of a national corporation, or one of its local franchisees. For instance, the tone, wording, phraseology, formatting, use of emoji's, gifs, jpegs, giffy's, and the like, are all elements that can be analyzed by the system and be employed thereby to generate communication and communication content that maintains the look and feel of the particular user, e.g., communicator, of the system. There are many ways in which the voice of a communicator, e.g., brand voice, can be determined, but in various embodiments, voice can be determined not by what is actually being said by the words used in a communication, but by the manner by which it is said. In particular, voice can be determined by first determining what is being said, e.g., the meaning of words or phrases being used to convey one or more thoughts, e.g., messages.

Next, the context within which those words are used to convey the message may then be determined. Then using the defined meaning of the words within their determined context, not only can the meaning of the messaging be determined, e.g., autonomously by the system, but the tone of the messaging may be determined. Further, that referenced tone can be determined over a number of different messages being reviewed, and from this analysis, the voice of the author or brand can be determined by the system. Once brand voice has been determined, at least provisionally, it may be tested by the system, whereby current messaging being generated, recommended, and/or published by the system can be compared to previous messaging by the same author, and may further be evaluated against other messaging from other authors, such as based on the way and manner by which other users of the system, e.g., consumers, are engaging with that messaging.

As can be seen with respect to FIG. 3B, such evaluations may be performed in the manners set forth herein, such as where keyword content 211a may be evaluated against the various factors 213, metrics 211b, and signal associated data, all of which may be collected by the system 1, such as by web crawlers, APIs, RSS feeds, and any other such integrations, which can then be fed into the analytics system and used to determine both high ranking subject matter and material as well as the voice in which it is to be conveyed. In this regard, the collected keywords 211 are the words that have been entered into the search engine, from past searches. They are aggregated and are pushed from the search engine platform into the content collection module 220 of the system.

Specifically, the system 1 receives, or otherwise retrieves, a list of words, e.g., keywords and or hit data, concerning what keywords are being utilized in which number of searches being performed. The data collection mechanisms 220a of the system may include: web hooks 220b, scrapers 220d, crawlers 220e, and the like. Additionally, various users of the system can push or otherwise transmit data 220c into the system as well. As indicated, various crawlers 220e and scrapers 220e retrieve one or more lists of keyword and associated data 211a from a number of search engine platforms. These lists of keywords are provided within a rough hierarchy, which may be arranged in descending order, such as based on volume of traffic. It is predicted, therefore, that these words may be impactful because, globally, they are represented in a greater number of searches being performed, but they may or may not be relevant to the products or services being proffered by a given business entity.

Keywords are important, therefore, because they are the drivers of traffic, whereby the greater the volume of their use, the more likely the greater the measure of impact will be. In certain instances, keyword data may not only be collected from search results, but the keywords in question may even appear in a given company's proffering and/or listings, but perhaps not in the manner, e.g., the definition, by which it is trending. Hence, along with the keywords, a number of other metric data, such as traffic data, e.g., data that can be used by the system to evaluate the impact of keywords, may also be pushed into or be collected by the system, so as to determine, generally, which of the list of keywords will be impactful and/or may be relevant to any particular business. Accordingly, the system may be configured for filtering down any, e.g., a large number of keywords to those that are both impactful and relevant.

Specifically, the system may be configured for filtering the list of keywords, such as based on their impact, e.g., their ability to trend, and/or their relevance. For instance, in determining impact and relevance, first, the system may evaluate the ability of the keyword to trend, e.g., to be high performing, and further determine its ability to increase impact, e.g., increase engagement, and once impact is determined to be above a set threshold, the system may perform a relevancy analysis so as to determine whether the high performing keyword is relevant to a given business seeking to include high performing keywords in its business listings. Hence, the system may evaluate the trending and impact of keywords so as to further determine whether or not they apply to the context of a business entity as well as the products and/or services they offer with regard to their specific business listings. In particular embodiments, this determination may be performed globally, for all or a selection of business locations, or it may be performed individually, such as based within a geographic region, e.g., locally. Such analysis may be performed collectively or sequentially.

Further, once a keyword has been determined to be high performing and relevant to a business, then the system may also determine the specific impact that specific keyword may have with regard to a specific business and its communications. The nature and the extent of these impacts may also be determined. Therefore, if the keyword under consideration is impactful, then the system may further evaluate the keyword to determine just how impactful it is, for this business entity, and what kind of impact would inclusion of this given keyword have, if included in the business listing for this entity, and to what extent.

In various embodiments, in performing the referenced filtering operations, the system may employ an analytics module, such as an artificial intelligence module, so as to determine from the list of keywords, which keywords are of a class to potentially be high performing, impactful, and/or relevant to an identified business entity employing the system so as to generate a communication, such as for a business listing and/or a social media post. In particular instances, the system may employ, or otherwise access, an AI module implementing a Large Language Module. Specifically, a LLM may be employed to determine the context of one or more keywords as well as the context of a business, from which contexts the system may then determine whether any given keyword is high performing and/or impactful and whether it is relevant to the business.

In performing these operations, the analytics module may collect or be fed a number of data, as described herein above, which data may be analyzed and a number of insights can be generated therefrom. These insights can then be used to determine performance and impact and/or relevancy. For example, the lists of keywords, the traffic and volume data, as well as the rough hierarchy of keywords, provided by the search engine platform, may all be fed into the LLM, such as a prompt, and one or more sets of metrics, factors, parameters, and/or signals as well as other associated data, may then be employed by the LLM to develop, or otherwise apply, one or more models that can then be used by the LLM to determine one or more of performance, impact, and relevancy.

In various instances, other data, such as market evaluation data 212, consumer behavior data 213, business behaviors data 214 as well as qualitative 218a, quantitative data 218b, and/or meta relevant thereto can also be fed into the LLM as prompts. For instance, consumer 212 and business 214 level data, such as data that characterizes the consumer or business, or otherwise describes the business, such as business name, business description, and other business related data, can all be collected by the system and be fed into the LLM as a prompt. Specifically, this type of data can be collected for the business 214c itself, its competitors 214d, as well as with regard to overall online business activities, such as to determine what is trending not only with regard to keywords 211, but also in relation to business listing descriptors, such as related to what are the types of communications and messaging business are promoting and with which consumers are engaging.

Determining what is trending is useful for determining the overall context within which the trend is occurring, what factors are attributable for provoking the trend, and for identifying the impact those factors are having on the consuming public. Specifically, this process is useful for identifying keywords and/or business descriptors of impact, and especially determining their potential relevance and impact if used within the messaging of particular businesses, such as with regard to how these trends and/or keywords relate to the business descriptors and key offerings of the business. From this data it may be determined whether the identified trends and/or keywords are relevant to the business and its descriptors, and if so, to what degree. In this manner, the keywords, trends they provoke, and the consumer data surrounding them can then be compared to the key offerings of the business, e.g., business descriptors, to determine to what degree they are relevant to the business offerings, and to what extent they will potentially be impactful if employed in the messaging, e.g., business listings thereof, such as to promote more conversions and driving an uptick in sales, such as based on the relevance determination.

These data are used to identify the keywords that are useful to the company for performing higher in business rankings. Another form of insight that may be collected and used in these regards are with respect to how consumers not only engage 213c with the content, but also how they promote it online, such as via reviews, comments, forwards, recommendations, upvotes, thumbs up, +1s, and the like. All of this form of engagement 213c and review 213d data can be collected by the system. In such instances, such engagement and review data may be fetched, such as by scraping it from the web via an API, along with all the other collected engagement and metric data that may then be analyzed by the system. Once collected the data may be analyzed.

However, in various instances, when directed to perform an analytic operation, the analytics module, such as the AI module, may determine more information may be useful for more efficiently and/or more accurately determining a result. In such instances, the AI module, e.g., an LLM thereof, may direct the system 1 to retrieve or otherwise collect data the AI module determines is useful.

Consequently, the LLM may be configured to evaluate the collected data in relation to a directive to perform a task it receives, and then it may identify, ask for, or otherwise collect additional information, which may be useful for better determining performance, impact, and/or relevance. For example, a number of different factors and/or metrics can be employed and fed into the LLM by which it can determine context, relevance, and/or impact, and/or the system can search one or more databases so as to identify data necessary, or otherwise useful, for determining such context, relevance, and impact. However, there is a tradeoff between providing sufficient data to the system to enable efficient determination of performance, impact, context, and relevance, and providing too much data that is not of particular impact or relevance, which may then slow the system down and over burden it with needless costs and processing demand, e.g., wasted CPU cycles. Hence, in certain instances, giving the LLM too much information of indeterminant value may cause the LLM, or other model, to get confused, provoking a hallucination effect.

Therefore, as detailed herein, it is very useful for the system to curate the data flowing into the LLM and/or being collected thereby, when performing its function, such as in a manner to ensure the data being considered is relevant to the evaluative returns being sought. The system, therefore, can be configured to generate a window of context, within which the system can limit the amount of data being considered, which window can be shortened or broadened as necessary, depending on the demands of the system. Accordingly, in various instances, there are a plurality of impact and/or relevance steps that may be utilized to curate and/or curtail data being entered into and/or evaluated within the various models, e.g., LLMs, employed. For example, there may be a first impact and/or relevancy step, which may be employed when determining what and which data to be fed into the models, e.g., so as to determine what is likely to be high performing, impactful, and/or relevant. Once the relevant data is entered into one or more of the models, a secondary analysis and evaluation, e.g., knowledge extraction, may be performed so that the system may then determine whether the data, e.g., keyword data, to be evaluated is in fact impactful and/or relevant to the business being considered, and if so, to what extent and what its impact may be.

For instance, the collected data may be analyzed so as to determine how online consumers are interacting, e.g., engaging, with online content, such as a content previously published by the business, e.g., previous business listing and/or social posts 204, which can then be used by the system to determine and/or predict how such consumers will likely engage with new communication content that is the same or similar to that previously engaged with by the consumer. Along these lines, local community level data 202 may also be collected, which can be used for better determining the voice of the local.

Accordingly, in particular embodiments, one or more consumer's review of the products or services of a business or its competitors, and/or the messaging they publish, can be analyzed so as to derive insights therefrom that can then be used to drive future engagements via the publishing of new messaging that is based off of those insights. Particularly, in one implementation, these insights may be extracted from the collected data and may be employed by the system so as to derive a context for the business within which context their messaging and messaging content, e.g., business listings, may be evaluated. Specifically, in a manner such as this, present or past consumer behavior can be determined, and/or future consumer behavior may be predicted, such as to determine and/or predict subject matter and/or content that is likely to evoke engagement by consumers.

The collected and stored data, e.g., the keyword, traffic, volume, and other associated data, etc. in addition to all of the indicators of context data, and any other relevant data, such business and/or consumer behavior data, local data, and the like, may all be fed into the LLM along with one or more, e.g., a series, of prompts and a directive as to what to do with all of the data. The LLM, therefore, may take all of the input data, may analyze it, and may generate one or more insights or knowings, e.g., knowledge, which knowledge may form a first, base, layer of a data structure, e.g., a knowledge graph or vector database, that may be stored separately or in conjunction with the other data collected by the system. These insights may then be used by the system to determine, rank, and list the various keywords both with respect to their relevance to a given business under consideration as well as its key offerings, and with respect to the predicted impact these keywords will have on the overall ranking for that business when a search is queried and a list of results are returned.

Accordingly, the system collects data 220 through a number of system integrations to a variety of sources, this data can then be stored and then accessed and used by the analytics system such as to determine meaning, context, tone, and voice of messaging, as well as identifying top performing content that can be used in that messaging. Hence, the system may be configured to employ one or more linguistic, symbolic, and/or graphical elements within a communication so as to ensure that the structured or otherwise crafted communication presently being generated has the voice as well as a look and feel of other communications that have previously been posted by the same communicator, be they from corporate headquarters, a local shop or owner, or other communicator. Any number of these elements can be used, just so long as the machine generated communication does not sound like “a machine generated communication.”

A further unique aspect of the system, as set forth throughout, is that the system is configured for managing communications throughout an organization, e.g., it is vertically integrated, and amongst any number of competitor or non-competitor brands, e.g., it is horizontally integrated, all while maintaining the unique voice and individual look and feel of all representatives using the system to communicate. This is important because every brand has its own unique look and feel and its communications have their own voice, which voice may be formal, informal, quirky, and the like. The system, therefore, can analyze and model previously transmitted messaging, determine its unique factors, and can employ those factors in the generation of communications in a manner that the communication retains the brand's look and feel as well as the voice of the original author(s). Further still, the system is able to manage all of these communications, with all of their voice, look, and feel, all the while ensuring that the communications being unicast, broadcasted, or otherwise transmitted, either vertically or horizontally are consistent and non-conflicting.

In view of the above, in one aspect, the business listings and communications systems set forth herein are configured, generally, for identifying and collecting potential high performing communication content, as well as for identifying the relevant factors, metrics, and/or signals that can be used to evaluate the collected data. In this regard, in various iterations, factor data may include elements the search engine considers and/or weights when deciding the rank order of the search results, whereas metric data may include elements that are used to measure and weight the factors, thereby pushing business listings up in the rankings. Signal data, including elements that the system collects, generates, and uses to determine relevance, can all be collected and used by the system to perform the analysis and evaluations disclosed herein. Specifically, the collected communication content can be evaluated so as to determine if the content is indeed high performing, and if so, further determining to what extent, in what regard is it high performing, and additionally whether the high performing content is impactful and/or relevant to any given communicator and/or their business offerings.

For these purposes, as can be seen with respect to FIGS. 3A-3C, communication content 211 and other related input data 210 from a number of different data sources may be fed into, or otherwise be collected 2, by the system 1. All of the collected data 210 may be aggregated and integrated, and then may be analyzed so as to determine a number of factors and metrics by which to evaluate communication content 211 that can potentially be used in a communication, such as in a business listing or other communication, being published 320 or otherwise distributed by the business. Particularly, as can be seen with respect to FIG. 3A, the system 1 is configured for collecting 2 communication content 211, e.g., from a number of sources, that is identified as potentially being high performing content.

Specifically, the content may include a number of keywords 211a that have previously been used in search queries entered into one or more search engines, such as with regard for what consumers are currently searching, how they are searching, and the type of search results with which they are engaging. In various iterations, this keyword content 211a may be collected 2 directly from various search engine platforms with which the system 1 is connected. In particular instances, the keywords 211a may be provided as a list of words that makeup a majority of the searches being entered into one or more search engines thereby signaling that consumers are interested in these topics, e.g., goods or services, thereby making these words “trend.” Such words “trend” because the search engine(s) keep seeing them entered into searches, from a variety of different consumers, and further, keep returning a number of results of companies that have listed those keywords within their business description as being related to the services and/or goods that they offer to meet consumer needs.

In various instances, these keywords 211a may refer to a number of different categories that the search engines publish as being searchable. In other instances, the keywords 211a may not directly refer to categories identified by the search engine, but may be so associated with that category in the mind of the consumers to such a degree that they use those keywords 211a when performing searches directed to that business category. The use of such keywords, e.g., trending words 211a, in their business listings, therefore, may be important for businesses hoping to have their businesses found by consumers using those keywords 211a to search for such goods and services those businesses offer to meet those consumers'needs. Consequently, in one aspect, the system 1 is configured for determining exactly what keywords are being entered into the various search engine platforms 3, as well as determining their impact 3a for businesses generally. Once the various impactful keywords 3a have been identified and/or determined, the system 1 may then define their contextual meaning 4, so as to determine whether the use of those generally impactful keywords 3 would be relevant to any given business 6b, as well as for predicting to what extent their use in a business listing might be impactful and/or high performing for that business 6a, such as for increasing engagement, e.g., with their communication content, and/or thereby increasing sales.

For these purposes, as can be seen with respect to FIG. 3B, the system 1 will access or otherwise collect communication content and/or data 211, which will typically be of two types. First, the content may be a number of keywords 211a, or any words the system identifies as potentially being impactful, and second, the data may be keyword metric data 211b. In particular instances, the keyword metric data 211b may be any data that is useful for measuring or otherwise determining an objective indication of usage prevalence over a large number of sample sets over a prolonged period of time across a number of search engine platforms. For instance, in a particular iteration, the keyword metric data 211b may include keyword search traffic data 211c and/or keyword volume data 211d. In this regard, the keyword search traffic data 211c may be search data that includes a number of keywords that have been entered by a number of consumers into one or more search engine platforms with regard to performing searches for businesses proffering goods and services that appear to currently be trending, e.g., a large number of consumers are searching for information pertaining to the same topics thereby making those topics trend. Likewise, the volume data 211d may refer to the number of people performing such searches and/or the number of searches being performed using those keywords across one or more search engine platforms.

Further, as can be seen with respect to FIG. 3A, in various other instances, a number of additional data can also be collected and used for determining what keywords are trending and/or high performing 3a, what keywords are impactful 6a, which keywords are relevant to which businesses 6b, and which keywords should be recommended to those business 8, such as for the purposes of increasing the reach, impressions, conversions, and/or overall engagements of the listings of those businesses. For these purposes, a number of market content evaluation 213 or factor data may also be collected, such as data that provides a number of metrics and/or factors that indicate the potential performance, impact, and/or relevance those keywords are currently having on search result rankings. Such data may include a number of times these words are used in searches and/or business listings, or the number of times such words are used in combination or proximity with such keywords, and may further include the number of categories within which such keywords are used, the number of times the words are engaged with by consumers, the breadth of consumers that engage with such words, the time span and duration of the usage, the number of platforms on which they appear, the diversity of platforms on which they appear, and the like.

In specific instances, such auxiliary evaluation or factor data 213, which may be collected, may also include impression data 213a, conversion data 213b, engagement data 213c, as well as, in some instances, review or other evaluation data 213d. In some instances, other data, as explained in greater detail below, may also be collected, including consumer behavior data 212, such as consumer use data 212a and other consumer information data 212b, and business listing data 214, such as business information 214c, including what a business does 214a or what the business offers 214b, and/or competitor business information data 214d, can all be used by the system 1 as inputs in any of the variety of analytic processes herein described, such as for determining performance, impact, relevancy, reach, engagement, and the like. A number of these data can be collected, evaluated, e.g., collectively or individually, so as to derive insights that can then be employed by the system 1 to generate 300 and/or recommend 280 high performing, impactful, relevant content to be used in business listings and/or other messaging and communications.

In particular embodiments, as can be seen with respect to FIGS. 3B and 3C, these insights and/or signals may then be used to drive the communication generation platform 200 in the crafting of new, bespoke communications which may be recommended and/or used by the system, such as upon approval from the communicator 312. Specifically, upon approval by the communicator, the system 1 can publish the new communication, for example, as a listing, e.g., on a business listing platform, and/or as a social media post that can be broadcast throughout one or more social media channels. In these regards, whether the new communication to be generated and/or recommended is a business listing, to be published on a listing website, or a social media posting, to be broadcast via a social media platform, some key goals of the new communication is to garner views, e.g., impressions 213a, maximize interactions with the communication, e.g., conversions 213b, and ultimately to generate buzz around the goods and services being advertised, e.g., engagements 213c, so as to increase sales, e.g., lift.

As a first principle, in order to achieve these goals, the new communication needs to be seen, and where the communication is a business listing, the higher up the business listing ranks in the returned search results, in response to a query entered into a search engine, the greater the chances are that the new, or otherwise improved, business listing will be seen. Particularly, as described above, when a consumer needs something, whether it be goods, such as materials by which to accomplish a home improvement project, or services, such as to provide the know-how and/or labor for accomplishing that improvement project, the consumer will often turn online, such as to YOUTUBE®, to view how others have previously performed the project, what materials they used, and how long it took to accomplish.

Likewise, next, the consumer will either go to a brick-and-mortar store to purchase the goods and/or services they need, or they will go to an online search platform by which to seek out businesses that sell the needed goods and services. For example, whether turning to an online video platform, so as to watch videos setting forth the projects one wishes to engage in, as well as for defining the goods and services needed for accomplishing those projects, or turning to an online search platform, so as to seek out businesses selling those goods and/or services, a first step in the process is performing a search request. In these regards, in performing a search, the consumer-user enters a number of words, or phrases, or sentences describing what they are looking for into a search engine, like GOOGLE®, or BING®, FACEBOOK®, or the like, and the search engine then returns a list of results of businesses, e.g., business listings, which the search algorithm has analyzed and determined to best match the search query.

More specifically, upon GOOGLE SEARCH® or GOOGLE MAPS®, BING®, FACEBOOK®, YELP®, etc. receiving a search query, the search algorithm will parse the query into keywords, and then characterize and classify those keywords into a number of different categories, and will then weight each category based on what the search engine platform, e.g., GOOGLE®, estimates what will best return results that match the subject for which the consumer-user is searching. Because the keywords and categories are weighted, the business listings returned will be placed in an order where the businesses that best match the search criteria will be placed, e.g., ranked higher in the returned search results. This ranking, e.g., GOOGLE® ranking, system and the rankings it provides is important because the higher up in the returned rankings a given business listing is placed, the greater the chances are the consumer will see the listing, and likewise, the greater the chances will be that the consumer will actually engage with the listing by clicking on the business link and/or making a purchase.

Overall, this process of performing a search using natural language and returning results is an organic process that directly connects a warm consumer, e.g., who may likely have well defined needs, with a business that can meet those needs. This organic process is important because the vast majority of online sales happen in this manner, at minimal cost to the business owner, e.g., they do not pay for their listing to be placed higher in the ranking results, and at virtually no cost to the consumer who does not pay for using the search engine. This is in distinction of the various advertisements placed on the borders of the search results, often labeled “sponsored,” which ads are placed on these borders because their respective business owners have paid, via an online auction process that takes place virtually at the speed of light, for them to be there. Hence, the online business that is best able to fit itself within the search criteria being valued by the search engine, and is thus naturally placed on the top row of the returned listing, e.g., just below the sponsored content, has a vast competitive advantage over the online businesses that have to pay to be placed on the borders of the returned results because those borderline businesses had to pay to be there, whereas the organically placed business did not.

It is not widely known what factors these various search algorithms consider to be important, what metrics are used to measure them, nor to what extent or in what regard these factors are important, but what is known is that it is largely the business listing that is being considered and evaluated by the search algorithm. Particularly, what is known, however, is that the search algorithm looks at the various business listings it has stored within its databases, parses the words and/or phrases used to describe those business, places them into categories, compares them to the parsed and weighted keywords of the search query, and then weights the likelihood that any given business listing meets the requests being made by the search query, whereby those business listings that best match the criteria of the search query will be ranked and therefore placed higher in the returned results. Consequently, in view of these dynamics, it is useful for businesses, as well as other goods and service providers, to not only provide their business listings to these various search engine platforms, but to also optimize those business listings with regard to what factors the respective search engine algorithms are looking for, or otherwise valuing, what metrics they use to derive that value, and especially with regard to how, to what extent, and why those search engines weight those factors, in accordance with the determined metrics, in the manner that they do.

More particularly, as indicated, the actual algorithms the search engines employ and how they perform their rankings is not known, however, what is known, generally, is that these search algorithms look at the keywords of a search query, categorize these words, classify them, weight them, and then perform a search of their databases, such as a listings database, so as to return relevant results, e.g., hits, which are ranked as to the degree of confidence the search algorithm attribute to the returned result being relevant to answering the query. The devices, systems, and the methods of using the same provided herein, therefore, are configured for determining and analyzing those factors and/or other elements the search engine determines are important, e.g., most likely to be considered by search engine algorithms, when determining the rank order of business listings to be returned in response to a search query. Likewise, the metrics by which those factors are to be weighed as well as the contexts and manners in which they are to be employed may all be determined and analyzed by the system components in accordance with the methods described herein. Specifically, all of this data may be analyzed so as to generate insights into how these factors and metrics can be employed in subsequent business listings to improve the probability that the updated business listings perform better, e.g., achieve a higher ranking on search results.

Hence, the devices, systems, and methods described herein are adapted for optimizing business listings and other such online communications so as to increase marketing performance, such as by increasing the probability of maximizing impressions, conversions, engagements, and overall incremental lift. Accordingly, in performing these functions, as can be seen with reference to FIG. 3B, the system will collect a number of data 210 that can be used to determine and estimate the factors 213 and metrics 211b that given search engines are deeming as important and why, with regard to what listings they return when responding to a search query. For example, the system may identify and collect high-traffic words, e.g., keywords 211a, that appear to be considered favorable to various search engine algorithms, words and actions that appear to reflect the interest of consumers 212/213 in their use or reaction 213d to those keywords 211a, and/or the words and actions that appear to reflect the interest of other businesses 214 and other search engines in their use or reaction to those keywords 211a. Specifically, in further embodiments, data pertaining to how those keywords 211a are being valued by the consuming public, such as by the public's use of those keywords in searches and reviews 213a, the public's engagement with the subject matter referred to by those keywords 213, as well as their willingness to make purchases of products and services that use those keywords in their descriptions, can all be collected by the system 1.

Such data can be collected in a number of ways, and may be used by the system 1 to determine the relevant factors being considered by search engine algorithms, determine the relevant metrics by which to weight and evaluate those factors, and to use the resultant data to better determine the signals or indicia of higher ranking, e.g., learnings, that can be employed by the system to generate and/or recommend optimized communication content, e.g., business listings, which is predicted to be higher ranking than such communication content that has not been optimized. For instance, raw data 220 may be collected by engaging a multiplicity of online connection mechanisms, such as webhooks 220b, scrapers 220d, web-crawlers 220e, and the like, as well as through a number of feeds, such as RSS, API, and other feeds whereby data may be pushed to or otherwise be collected by the system 1. More specifically, data 220 relevant to user actions, whether taken by consumers 212b or businesses 214a, can be collected and used in the evaluation and analytic processes described herein, such as for defining high impactful keywords 211a, identifying their relevance, if any, to any given business seeking to potentially use them in their communications, e.g., business listings, as well as for determining what impact using those keywords might have, such as if recommended 280 for use in the communications of the business. All of this data, as well as any other data associated therewith, such as factor, metric, and/or signal data, can all be collected and stored in one or more databases 230 of the system, such as in a structured, clustered, and/or labeled or otherwise classified manner 240.

Once the data has been collected, it can be evaluated, aggregated, parsed, analyzed, symbolized, clustered, and/or classified 240. More particularly, as can be seen with respect to FIG. 3B, the system 1 is configured for both identifying and collecting keywords 211a and keyword metric data 211b, such as keyword search traffic data 211c and keyword search volume data 211d. Other data, for instance, consumer characteristic data, such as consumer behavior data 212, consumer keyword use data 212a, and/or other consumer characteristic and information data 212b may also be collected. Additionally, related marketing and evaluation data 213 as well as business related data 214 may also be collected.

This data may be input 210 into the system in a number of manners, such as by being collected by and/or pushed into the system 1. For example, in various embodiments, in addition to the collecting of communication data 210, such as including and/or related to a number of natural language searches being entered into search engines, the search engines themselves can push such data and/or updates into the system. In such instances, the search engines themselves, such as GOOGLE®, BING®, FACEBOOK®, YELP®, and the like, can all push data related to the natural language search queries they collect, as well as various of the metric data their algorithms use to evaluate the search language. For example, each individual search engine can parse the search query and push what they consider to be keywords, keyword categories, and/or associated metric 211b and/or factor 213 data, to the present system 1, such as over a suitably configured and networked API. All of this pushed data can be aggregated and thus may need to be parsed and evaluated with regard to the subject matter to which any particular search is referring.

Specifically, not all of the pushed keywords 211a are likely to be useful when evaluating what words should be used in relation to any given particular business listing, because not all pushed keywords will have a universal impact, nor will they have universal relevance.

Such keywords 211a, therefore, may need to be filtered and evaluated 240 by the various processing modules detailed herein so as to determine a context within which each word, e.g., in a search query or a business listing, is being used by the various buyers and sellers within an online market. Likewise, the contextual relevance of any evaluated keywords to a particularized business listing being assessed should be determined, so that the contextual content of the keyword, as used by the consuming public in its searching, can effectively be compared to the context of the goods and services being offered in the business listings of a business.

In this manner, the originally determined context, as organically entered into search queries, may more effectively be compared to a context of a business, so that it may be determined if any particular keyword is applicable, e.g., relevant, to the present purposes of the business, as described herein. Such evaluations may involve the analysis of the various keywords 211a, their keyword data 211b, and/or their respective keyword metric 211b and/or factor 213 data. In such instances, additional data, such as behavior data 212/214, may be requested by the analytics module so as to be considered. For instance, behavior data, as to how consumers 212a are responding to the subject matter of the searches being performed, as well as to the search language itself, can also be collected or otherwise input into the system, and this data may then be employed by one or more analytics modules of the system 1 to determine meaning and context. For example, the analytics modules of the system may be configured for determining the context of the natural language being entered into the search engine, as well as for determining the individual words, e.g., “keywords,” employed therein, and further for determining the context of the various different keywords, with regards to how those words are used within a search query. Further, this and other collected data, such as business analytic data 214a, b, can further be used along with the above, to not only determine context, e.g., of keywords, but also to determine tone and voice being conveyed by the natural language being used either in the original search and/or in the responses thereto as well as the other relevant communications being published online, which may be in some manner related to the original search query.

In particular embodiments, the consumer marketing 212 and behavior data 212a provide factors and metrics by which the analytics system 240 may apply the marketing 212, consumer data 212b, and business data 214a to the keywords 211, in order to determine a variety of signals that can then be used to evaluate the level of interest and/or relevance various businesses and consumers have in any given set of collected keywords 211a, such as used in a listing or other posted communication. In a manner such as this, the system 1 may evaluate the natural language and or keywords 211 collected with respect to determining a predicted level of impact that any defined keywords may have on the behaviors of an online consumer when used in listings and/or messaging targeted to that and other such consumers. Accordingly, along with the natural language employed to perform the search, the system 1 may be configured to collect marketing data 213 by which to identify and evaluate the identified keywords 211 that have been evaluated and identified as being of interest to consumers, such as with regard to its ability to increase lift and drive sales.

There are a number of marketing factors 213 that can be used to determine signals of impact that can then be used to predict, or otherwise determine, the ability of identified keywords 211 to generate interest in a consumer so that the consumer will not only look at the posted content, but will leave the consumer a positive impression 213a of the messaging conveyed by the content. Better yet, the keywords 211 to be evaluated will not only positively impress the consumer 213a, but will convert 213b that impression into an action, such as by getting the consumer to click on the posted content. Even better, the keywords, and/or overall messaging content, will provoke the consumer to further engage with the content, such as by getting the consumer to engage 213c with the content by either making a purchase, leaving a comment, or providing a review 213d of the messaging content or its subject matter.

In addition to all of these keyword 211a, impression 213a, conversion 213b, and engagement data 213c, a number of other data may further be collected and used as factors in evaluating whether any given keyword 211 will be impactful or not, e.g., generally, as well as whether any such word will be relevant to a given business being evaluated, in particular. For instance, in addition to collecting keyword 211a and keyword data 211b, marketing data 212, consumer behavior data 212a, and business behavior data 214, as well as their respective volume, breadth, and other associated metric data can all be collected by the system 1. Particularly, this volume and metric data is useful, e.g., as a filter, for evaluating and stratifying potential impactful keywords, based on the extent, e.g., volume and/or breadth, of their usage, for example, as a cutoff below which no further keywords need be considered.

Additional filters can also be employed to narrow down the list of keywords being considered. For example, in addition to an impact filter, a relevancy filter can also be used to narrow down keywords to be considered. Specifically, a relevancy filter can further be configured and employed to evaluate potential keywords based on their relevancy to the business listing and/or other communications for which the processes of the system 1 are being employed so as to generate recommendations.

More particularly, when evaluating keywords for potential use within a business listing of a business, a first list of keywords that are proposed for potential inclusion within a business listing can be compared to the characteristics of the business listing so as to determine whether or not any given keyword is not only high performing, e.g., impactful, but is also relevant to the business in which the content may be included as a description. Accordingly, for these purposes, as indicated, a set of business information 214a, b about the business utilizing the system 1 for generating recommendations 280 may be collected and used to determine relevancy, such as where the business information may be related to a national brand, may be related to a local franchise thereof, or may be a small business owner. Such business-related information may include descriptions of the business, its products and services being proffered, its location and location specific data, its prior postings, listings, and advertisements, and the like.

This data may then be fed into the system and be used thereby, e.g., by an analytics module of the system 1, to cull the list of keywords being considered, e.g., based on their relevance to the business, e.g., on a local and/or national and/or global level. Additionally, review data 213d, other consumer information 212b, business information 214a, and/or other such commercial relevant data can also be collected by a content collector 22 of the system 1 and be used by the analytics platform 20 to evaluate the keywords 211 with respect to the benefits incurred by recommending 280 their use in generating communication content that may be used in generating a business listing or other communication of the system 1. This data can then be used by the system 1 so as to determine not only the impact of a list of keywords, but also their relevance to a given business or other entity. For example, all or some of the collected data can be evaluated, relevant data factors and metrics by which to measure impact and relevance of the various data can be identified, and the data may be evaluated, such as by an analytics platform 200 of the system 1.

In particular instances, as can be seen with respect to FIG. 3B, the collected data may be analyzed for the purpose of extracting knowledge therefrom, such as insights, which insights can then be used to determine impact and relevancy. Particularly, as discussed above, the data entered into the system may be contextual data that may be used by the system to generate knowledge, e.g., contextual meaning, of the words, word fragments, and phrases, being evaluated by the system. This knowledge can then be analyzed by one or more analytic, e.g., artificial intelligence, modules associated with the system, such as in relation to one or more metrics by which the relative value of the data may be determined in relation to its impact and/or relevance in view of one or more communications to be generated and/or recommended for use by the business. Specifically, the knowledge extracted can be used to identify the factors deemed to be important to search engine functioning, and the system can then apply this factor knowledge to other determined data sets, e.g., metrics, whereby the data therein, e.g., meaning, can be defined, symbolized, and then clustered, and/or labeled.

For example, keywords and associated keyword data may be entered into the knowledge extraction system. However, outside of being able to look up the accepted dictionary definition of each word, the meaning of each word within the context that it is used, e.g., its contextual meaning, will not be known, or readily discernible by the analytics system. Consequently, in order to evaluate whether any given keyword is relevant for use in the business listing, or other communication of a company, the system must not only discern the meaning of the keywords as used in other trending use cases, but must also understand the context of the businesses proposing to employ those keywords in their communications so as to determine if any given key word is actually related and/or relevant to the goods and/or services being provided by that business.

For these purposes, the system may collect a number of data related to the keywords and their use by which their context may be determined, or at least predicted. More particularly, in various embodiments, the analytics system may include an AI module such as for generating a language model by which model the meaning underlying language being used, such as for communication content, can be discerned, such as within the context in which it is being used. In this regard, along with the collected keyword data, the system may collect other word, word fragment, phraseology, sentence, paragraph, and/or image data known to be related or otherwise relevant to the collected keywords, and once collected, the system may collectively use this data to generate a model, as described herein, so as to determine the context and meaning of the keywords themselves.

Likewise, this process may be implemented and/or repeated with respect to the business for which the system is being deployed in order to generate and/or recommend communication content, such as in the generation of a business listing that employs those identified keywords of high impact. As described herein below, once the meaning of the keywords have been determined, and the context within which the business will be employing those words is determined, then the relevance of those keywords to the business as well as its impact can also be determined. In like manner, the potential level of impact the use of those keywords by the business can also be determined.

Once the model has been trained, then less and less contextual data need be employed by which to determine meaning in future use cases. For instance, once adequately trained, meaning can be determined primarily from the mere use of the words themselves, such as with minimal to no regard to having to contextually determine use cases, e.g., instead such use cases may be inferred. Nevertheless, in various implementations, the contextual data may be entered into the system along with related image, e.g., photographic data, which image data may be analyzed in conjunction with the collected keyword and/or contextual data that is associated with those words and images, and together these data may further be used to train the language models being generated and/or otherwise employed by the one or more AI modules so as to be able to determine the meaning of the various different visual elements depicted in the images.

Like as above, once the model has been trained on the image data, then collected images themselves may be employed by the model so as to determine meaning of the elements contained therein. For instance, in various embodiments, one or more AI modules of the system may implement, or otherwise access, a large, trained (e.g., pre-trained) language and/or image classification model that may be implemented by one or more natural language and/or image processing engines. In such instances, the model may be trained or otherwise configured for receiving written language and/or image data and thereby upon applying the model to the received data, e.g., via one or more natural language processing (NLP) engines, the meaning therein can be derived, or at least predicted, within a given level of confidence, such as with or without consideration of additional contextual and/or use case data.

More specifically, in particular implementations, a natural language text and/or image-based classification model, such as implemented by a zero or one shot classification modeling sub-system, may be employed to derive the meaning of the keywords, and/or images associated therewith, which are entered into the system so as to thereby classify the received keywords and images. For example, in this regard, natural language, e.g., a prompt, may be entered into an AI module employing a meaning and/or classification model, which, in certain instances may be a large language model (LLM). Particularly, upon receiving a prompt, such as including keywords and/or images, a set of natural language and/or image processing engines of the AI module may then analyze the received keywords and/or images and determine the meaning of those keywords and/or images, and may also classify or otherwise categorize them and/or their elements. For these purposes, the AI module may implement a model that has been trained on known, e.g., classified and/or labeled, example data in such a manner that, after training, upon receipt of the various keywords and/or images, without their respective labels being present, the model can infer the label and the words and/or images may be substantially instantaneously classified with respect to their predicted contextual, e.g., semantic, meaning. A probability score indicating the level of confidence that the classification is correct may also be generated.

In this manner, the meaning of the various keywords received by the analytics system, such as by being pushed to the system by the various search engine platforms, may be determined, and the various keywords may be classified, e.g., provisionally classified, based on that derived meaning. Not only can meaning be derived and the list of keywords be segregated by that meaning, but also various of the collected factors and/or metrics can be applied to those keywords through which their general impactfulness may also be determined. Additionally, as explained herein, the model may also be configured for receiving various business information 214a, business competitor information 214b, consumer behavior data 212a, consumer information 212b, reviews 213d, and the like, which data can all be employed by the model so as to determine, e.g., extract, a particular context for a business and/or its consumers, and using this business and/or consumer context(s), e.g., extracted knowledge, can then be employed to determine the particular relevance of the keywords to that business.

Similar methods can also be employed to extract corresponding meaning and contexts from image data. In this regard, all or some of this data, e.g., extracted knowledge, can then be compared to the business listing for a business being analyzed, and the language used therein can be assessed relative to the previously determined strength, e.g., impactfulness of the keywords. In a manner such as this, the comparative strength of the business listing can be determined, and the words used therein can be evaluated. The system can then use the results of this analysis so as to determine if by changing one or more words of the business listing to one or more of the analyzed and evaluated keywords, various analytics, e.g., metrics, of the business listing can be improved, such as by ranking higher in the search return listings, improving impressions 213a and/or conversions 213b, enhancing engagements 213c, and ultimately generating more sales.

This process is not a simple process, however, because words often have several different formal definitions which may be colored and/or change by a number of contextual implications, and of course, words can often be used ironically. For instance, sometimes the words “bad” or “sick” can be used in a manner that their implied meaning is the opposite of their literal meaning, and thus, in context, either of these words may mean “good”. Additionally, words have one meaning when used in a first context, but a different meaning when used in a different context. It is important for the system to be able to distinguish between such different usages, because when trying to determine the equivalency between different words, two or more words may be substantial equivalents in one context, but not be equivalent in other contexts. This is of key importance to the efficient and accurate functioning of the system where it is tasked with comparing a list of word descriptors in the business listing of a business to a list of potential high impact keywords that are currently trending, whereby the system must determine to what extent any given word in the business listing can be replaced by an identified impactful keyword.

If the system substitutes a high impact keyword as a descriptor of a business listing where given the context of the business listing the two words are not equivalent, the business listing may be flagged as being inaccurate and may then be under threat of being delisted. To overcome this challenge, the system may convert the various words being evaluated into symbols, such as mathematical representations, and can then cluster these mathematical expressions in accordance with their contextual, e.g., semantic, meaning. Specifically, the system may convert the words and/or images into numbered sequences, whereby words having the same or similar meanings will be represented by a number that is within a given range of other number represented words that have that same general meaning, e.g., they generally fit within the same classification of meanings. In this manner, the same words can fit within several different classes, based on their potential contextual meaning, and the number by which they are represented will be different, e.g., for the same word, but similar to all the other words fitting within that classification.

Hence, words having the same or similar meanings may be represented by a similar number sequence, whereby the degree of separation by numeric value represents the degree to which the contextual, e.g., semantic, meaning of that word fits it into that class. In such instances, “bad” may be represented by one number that places it squarely within the classification of words representing the concept of “not good,” but it may also be represented by a different number that places it more tangentially within the classification of “good.” In this case, the number representing “bad,” where the semantic meaning for “bad” is actually a form of “good,” the numerical value for “bad” in this case will be further distanced away from the other words in that class representing the concept of “good,” such as where the other words representing the class “good” are not being used ironically. Hence, in addition to determining meaning, e.g., semantic meaning, and provisionally generating classifications, the model may further cluster the various analyzed keywords such as based on their semantic text similarity and/or the provisionally determined classification, which, in some instances, may be a multi-class classification.

As can be seen with respect to FIG. 3A, in one implementation, the collected 2 keyword, listing descriptors, and/or other associated data, e.g., context and/or use case data along with characteristics thereof, may be analyzed, semantic meaning may be defined 4, and each word may be semantically classified via a number of different classification methodologies 4a, such as via a one or zero shot classification model, whereby the resultant analyzed and/or characterized data may be embedded with one or more identifiers and/or classifiers, e.g., based on the attendant characterizations and conceptualizations. Once semantic meaning has been determined for one or more keywords, then the keyword may be symbolically represented 4c, such as numerically, whereby words that have the same or similar meanings can be represented by similar symbolic representations. For instance, in various embodiments, the semantically, e.g., contextually, defined keywords can be represented by a sequence of numbers, such that the closer the semantic meanings are between any two words or phrases, the closer together they will be in the numeric sequence. Hence, words having virtually the same meaning, e.g., synonyms, may have number sequences that do not differ greatly by numeric representation, whereas words that are less similar may have number sequences that are separated by a greater numeric value. Further, words that are used ironically in a manner so as to have a similar meaning that would not traditionally be thought of as similar can be placed within a common cluster of words, based on the ironic meaning, but, they would be represented by a number sequence that is sequentially much further apart than words that are true synonyms.

Once the keywords being evaluated have been defined contextually, 4a such as with regards to their semantic meaning, and have been represented by numeric values 4b, the numeric values 4c can then be converted into vectors 4d, e.g., vectorized, which vectors can then be clustered together 4e based on their semantic meaning. Hence, once vectorized 4d, the vectors can be stored in a structured, e.g., clustered 4e, manner in a database, such as a vector database. This conceptualized, vectorized, and clustered keyword and/or other data may then be used by one or more other analytics modules of the system, such as for determining if any given semantically defined keyword should replace an analogous word in a business listing, or otherwise be added thereto 8. In this regard, each descriptor in a business listing may also be analyzed 4b in a similar manner as described above with reference to keyword evaluations, and each of the descriptors of a business listing can then be defined by its semantic meaning. Likewise, the semantically, e.g., contextually, defined business listing descriptors can also be represented symbolically 4c and be vectorized 4d as well as clustered 4e.

Hence, in various embodiments, once the keywords and business descriptors have been semantically defined, numerically represented, vectorized, and clustered, the keyword vectors and the business listing vectors can then be compared to one another 7, and the analytics module, e.g., knowledge service of the system 1, can then determine if any given keyword is likely to be high performing and/or impactful 6a and/or relevant 6b for a given business being evaluated. Consequently, based on a predicted level of performance, impact, and/or relevance, potentially relevant high impactful keywords can be identified, and the analytics module can then determine if any of such keywords should be used as business descriptors in the business listing for the business. In this manner, a number of predicted high performing, impactful, and business relevant keywords can be coupled together to generate a communication, e.g., business listing, that can be recommended 8 for use by a business owner, or other communicator, user of the system. Specifically, a content generation module of the system may generate 9 a communication, e.g., a business listing, that can be posted such as on a search engine platform.

As indicated, clustering allows for different words that may not be related with regard to their look, e.g., the words do not have the same or similar lettering or sound, but may be related with regard to their feel, e.g., their meaning or semantics, and thus, such words may be clustered together, such as post vectorization, such that words having the same general meaning are grouped together within the database. Consequently, this vectorization is useful for characterizing and representing the keywords both conceptually and symbolically, e.g., numerically, whereby the words that have the same or similar meaning can be sequenced, numbered, vectorized, and positioned within the database so as to be placed closer to one another, e.g., numerically, and the words that are not as closely aligned, e.g., semantically, can be positioned in order further away from one another, such as where the degree of dissimilarity is represented by the larger the degree of numerical difference separating them, e.g., sequentially. In this regard, words are simply formed of characters, which are themselves simply symbols that appear together in a particular order by which sequence identity and order meaning can be encapsulated, and thus, the system is configured for further symbolizing these words so as to include additional values that can represent both their conceptualization, as well as the degree to which any given word embodies that conceptualization.

Hence, representing words, images, and communication elements mathematically further allows the degree of conceptualization to also be represented. In this regard, the degree to which any given word, e.g., a keyword, encapsulates a concept can also be encoded mathematically. In such instances, words that more fully encapsulate a given concept may be represented by similar numbers and the closer aligned with the concept the closer in sequence the numbers will be, whereas words that only partially encapsulate the concept will be represented by numbers that are further apart.

Likewise, these numbers can then be additionally represented as vectors, whereby the direction of each vector expresses the degree to which the vector represents the concept. In such instances, the degree to which similar words represent the concept can then be measured by the angle formed by the intersection of their vectors. This process is useful because it allows the system to efficiently store, retrieve, and compare items, e.g., communication elements, based on their conceptual, e.g., semantic, similarities. Such comparisons, therefore, may be made between the concepts the words represent, e.g., the concepts of the keywords, business listings, and the like, and the concepts of the various categories being advanced by the sundry search engine platforms being queried.

For instance, once represented numerically, then communication elements, e.g., of keywords and representative categories, can be analyzed, characterized, e.g., conceptualized, and be grouped conceptually together, and can efficiently be searched by concept and degree of representation within the concept via prompts such as: “Return the top 10 things that are not roses, but are similar to roses.” A typical search system receiving such a query would then attempt to find the results within a structured look up table via one or more text-based tags or labels, and if such a tag or label had not been used when storing such items, no results would be returned. However, when employing the semantic vectorization, storage, and retrieval methods disclosed herein words and the concepts they represent can be searched conceptually via their symbolic, numeric, representation, and thus, the system can return matching and similar words not based on the words or their dictionary definitions themselves but the degree to which their numeric representations, e.g., their vectors, align.

In such instances, for determining and analyzing the meaning, e.g., the contextual meaning, of keywords and/or business descriptors, as well as for determining which keywords to apply to which business descriptors the system may access one or more analytic processing modules, such as one or more keyword and/or business listing semantic meaning and/or relevancy processing modules. Such processing modules may be instantiated in a single or multiple servers, where the one or more servers may include one or more processing engines that are configured for implementing the various operations described herein. In particular instances, the processing module may be configured as, or may otherwise access, an artificial intelligence (AI) module, such as an AI module that may implement a large language module (LLM). In such instances, to initiate one or more of the processes disclosed herein, a series of prompts may be crafted or otherwise generated and may be fed into the LLM.

The prompts may be configured for engaging one or more models, directing a model to determine a requested business insight, such as with regard to how a potential change, e.g., to a business communication or listing, may impact the business, and further directing the model to determine whether it makes business sense to make the proposed change, e.g., determining if this proposed change is both impactful and relevant for this specific business. In one implementation, the language model to be employed may be a model generated by the system with respect to a given one or more business entities, e.g., based on data specific thereto, or may be a large universal and/or global language model, such as one that has been trained on global data, such as GPT-4®, GEMINI®, and the like.

These models may be engaged at the same time or differently, such as where one model is used to perform one process, and another model is used for performing another process. For instance, with respect to the above, GPT-4® may be used to analyze a number of keyword and/or business listing data, to extract knowledge therefrom, such as to generate insights and/or embeddings, and to determine which keywords and/or business descriptors may be high performing. Likewise, GEMINI® and/or GPT-4®, may be employed to utilize the insights from the first LLM, so as to determine which keywords may be relevant to which business listings, as well as to analyze the collected data so as to generate insights thereof. Further, GPT-4® may further be employed to utilize the relevancy insights so as to determine which keywords to recommend for use in the generation of which business listings. It is to be noted that any of these LLMs can be swapped or exchanged for any of the others, but there are efficiencies that can be achieved in processing time, if employed in the manner herein described.

Hence, in various embodiments, the system is configured for representing conceptually similar communication elements mathematically, e.g., vectorially, so as to have similar numbers, e.g. vectors, such that they occupy similar positions in vector space, and thus, the very manner by which such words are stored, e.g., semantically, allows similar words representing similar concepts to be searched and returned swiftly, e.g., as a group, and in a manner that the words within a group can be quickly evaluated individually with respect to their relevancy to any given business or other user communication, such as business listing, and from such analyses, which words to recommend for use in a communication can be determined. Thus, when asked to return results that are similar to, but are not roses, the system can use received data to determine the contexts of the prompt, and based on this context can extract the core concept therein, and can then, based on that determined concept, return the top 10 hits that best fit that determined concept via search and retrieval, as described herein, within vector space.

Based on the contextual conceptualization, in a first instance, the system can recognize that the category is “flowers”, and thus return different categories of flowers, e.g., tulips, etc., or in a second instance, the system can recognize that the category is “color,” e.g., “red,” and thus, the top 10 “red” item “bunches” may be returned, e.g., based on their numeric representation, e.g., vectorization, such as based on the angle between their vectors. Such extraction of meaning and embedding of degree of conceptualization can be performed for all of the communications of a business, or other online communicators, as well as with regard to extracting meaning from the collected data, such as with respect to collected search engine data related to the categories being searched, impactful words being used to search, impactful words being identified as keywords within a category, all of this data can be analyzed, conceptualized, numericized, vectorized, and thus, be represented and stored by degree of relation in vector space. This vectorized data can also be analyzed with respect to one or more of the factors and metrics disclosed herein, such as with regard to their predicted ability to increase their rankings within returned search results, to increase impressions, conversions, engagements, and the like, as well as to drive an uplift in sales.

Further, in this regard, clustering is useful because it gives the system optionality in determining which, of a group of keywords having the same or similar meanings, to use when recommending language to be employed in business listings and other such communications. For instance, in various embodiments, along with determining the meaning of keywords, the system may also determine and/or measure the impact of the various analyzed keywords. For example, various words having the same or similar meaning may not register as being the same within the minds of businesses and/or consumers. In such instances, a business listing of a company may find itself positioned lower in the ranking results in response to a search query than its competitors simply because its word usage has not been optimized for increasing impact.

Consequently, a useful aspect of the present systems and methodologies is that they may be employed to optimize for impact. In such instances, vectorized clustering, as described herein, allows the system to easily swap words in and out of business listings, such as based on their relative, predicted impact. Particularly, in determining what keywords are potentially impactful for achieving high ranking keyword results, a useful methodology, as referenced, is the implementation of a classification protocol, such as a zero or one shot classification protocol, that is used to analyze, in this instance, keyword, business descriptor, factor, metric, and/or other associated data, which can then be used to determine meaning and/or generate signal data, as described herein, so as to derive insights that can then be used by the communication evaluation and/or generation system 200 to make one or more communication recommendations.

In various embodiments, a classification methodology so as to perform text and/or image classification tasks, such as with regard to natural language processing, may be instantiated. In such embodiments, a text and/or image-based model, as indicated above, may be developed and trained, such as on a set of known examples, e.g., where the classification is known, but withheld from the model, and the model is then directed to evaluate the data and make a classification decision and then adjudge the probability that the decision is correct. In this regard, the classification may be with respect to the actual meaning of the keyword, such as within the context in which it is used, and the model generated answer may then be compared to the known answer, e.g., the known semantic meaning of the keyword.

Where the call is correct, the model is rewarded, and the decision steps are increased in weight. Where the call is incorrect, the model is punished, and the weighting of the decision steps is decreased. This process is repeated over and over again until a desired accuracy level is determined, and then less and less contextual information need be provided to the model, as described in detail herein below, so as to wean the model off of the need for this contextual data. Once fully trained, the model can be fed textual and/or image data, which upon receipt the model may rapidly, e.g., substantially instantaneously, make a semantic meaning classification, with a high degree of accuracy.

Accordingly, after training the model to a sufficient degree of accuracy, on text and/or image data that has already been defined, classified, and/or labeled, the trained model may then be used to classify new examples, e.g., in natural language and/or images, from previously unseen classes that have not been previously classified and/or labeled. The model can then classify and/or label new, never before seen words and/or images directly, not necessarily based on attendant contextual data, but rather, by direct application of the model, and can further determine, e.g., based on cluster analysis, which keywords can be substituted for which similar words currently being used in a business listing or other form of communication.

Specifically, in various embodiments, the classified and/or clustered and/or labeled word or visual image elements may then be analyzed and scored with respect to the percentage confidence the system has that these elements accurately fit within the provisional clustering and/or labeling, and one or more word substitutions may be recommended, so as to improve potential impact. As described in greater detail herein below, this process may subsequently be repeated, and the word and image elements may be re-scored, either individually and/or collectively, but this time against the various other words and images in the cluster and with respect to its relevance to a given business and its offerings, e.g., which word within a given cluster is the best fit for this business, and which is predicted to have the greatest impact. Particularly, once the word and/or image elements have been characterized and/or conceptualized and can be semantically defined and/or provisionally classified, the keyword and/or key image elements can be converted into symbolic form, such as to be represented by a string of numbers, which numbers can then be converted or transformed into numbers, e.g., vectorization, and then they can be stored within a database of the system, e.g., within vector space, in a manner to form a cluster with numericized keywords that share common features, e.g., have the same or similar semantic meaning.

In this regard, the classification processor may be configured to parse and cluster language and/or images, for instance, with regard to the words, e.g., keywords or key elements, used therein, and can then apply a semantic filter whereby text and/or context similarity may be analyzed, and the language, words, and/or visual elements used therein can then be classified based on degree of similarity and/or be clustered together. In this regard, various communications relevant to a business, or the communications it has published, such as related to its products, services, and evaluations thereof, may be collected and be input into the system, such as in natural language and/or image format. The words thereof can then be parsed, characterized and/or conceptualized, and can be clustered, and/or labeled, e.g., provisionally, with regard to their intended semantic topology, and can then be compared with other keywords of a relevant cluster, so as to determine if any of the language used in the business listing, or other communication, should be replaced with any other keywords or language within the cluster.

In such instances, then, an AI implemented model of the system, such as in response to a prompt, can perform a search not based on defined meanings, but based on system derived conceptualizations, such as by performing the search within vector space. Particularly, a user of the system can ask the system, such as via a client application running on an associated computing device, to review their communications, e.g., business listings, and can further ask one or more of the AI modules, e.g., implementing a large language model (LLM), to compare the business listings to known or determined categories of a search platform. The AI module may then determine which categories apply to the business listing, and which impactful and relevant keywords should be employed in the business listing to increase the ranking of that business listing when those keywords or similar communication elements are entered into a search query on that platform. The AI module then will return a list of search engine platform identified categories and/or keywords that have been evaluated with regard to one or more of their impactfulness and/or their relation to the business.

As explained herein below, the AI model will evaluate the intersection between the potential categories and/or keywords that are both relevant to the categories of the search engine as well as to the business and its communication objectives. In this regard, the analytics platform can analyze a business communication, e.g., a business listing, identify the present categories to which the business currently applies, and can then determine whether it would be beneficial to increase the number, identity, and/or characteristics of the identified categories being employed by the business listing, so as to increase the likelihood of the business listing being included in a greater number of search results and/or with a rise in the returned rankings. In a manner such as this, the reach of the business, or other communicator can be increased. The result of these cluster and/or keyword extraction analyses may be a pool or list of potential categories which may apply to the business listing, as well as list of potential keyword candidates, or at least of a number of clusters of keywords that can then be evaluated to determine which clusters apply to a given particular business and its determined associated categories, and which keywords within the identified clusters may be relevant to the business.

Accordingly, in various embodiments, this clustering may then be subjected to further analyses so as to extract various insights, e.g., signals, by which the data, especially as it relates to category and/or keyword and/or business description data, can be evaluated and weighted, such as with regard to their ability to impact consumers and/or to determine their relevance to any given business and its products and services. In various instances, additional data can be employed in the performing of these analyses, such as factor and metric data, as well as other data related to determining context and meaning, such as usage data. All of this data can be evaluated, such as by a relevance determining analytics module of the system.

For instance, once the system has received one or more lists of keywords, images, or other associated communication elements, the various keywords, etc. can be parsed into one or more categories, which categories can be generated by the system itself, or may have been pre-designated, such as by the search engine platform, and the relative fit of the keywords within any given identified category, as well as their strength, from an impactfulness standpoint, can be determined. As indicated above, the system can collect keyword 211a as well as keyword factor 213 and/or metric data 211b, such as where the factor data 213 can be used to determine they keyword's 211a fit within any given category, and the metric data 211b can be used to determine its impactfulness. Specifically, keyword data 211a, factor or marketing content 212, such as impression 213a, conversion 213b, and/or engagement data 213c, as well as consumer data 212a, b, and business data 214a, b, can all be collected, aggregated, and may be applied as factors by which each keyword 211a may be evaluated so as to determine to what category those words belong and further to determine to what types of products and/or services those words apply.

Likewise, the referenced collected keywords 211a can further be evaluated so as to determine what kind and level of impact those words are currently having in the search and/or purchasing habits of the consumer. In this regard, metric data 211b, such as search traffic and search volume data, can be employed by the AI models of the system such as to determine impact. Particularly, such keyword 211b, marketing 212, e.g., behavior, factor, and/or metric data may include the number of times the word, or other communication element, was used in a search, the number of times the word, or other element, was evaluated or used to evaluate other online content, as well as the number of times within a given period such evaluations occurred or those keywords, or other elements, were used or referenced by various online businesses, which business may have been previously categorized, e.g., by the system or the search engine platform.

Such evaluations may be made with regard to the word or its referent, and may include the number of times it was liked, disliked, received a thumbs up or thumbs down, up or down votes, +1 or −1s, forwards, re-sends, and the like, all of which may be used to determine the estimated impact those words are having on generating search results. In various embodiments, one or more of the evaluated factors above may be characterized with respect to its volume of occurrence within a given time period. Hence, various traffic 211c and volume data 211d may be used as a measure or metric 211b by which impact can be relatively determined or at least predicted. Particularly, all of this data can be mined and used to generate, or otherwise extract, a number of different insights by which various keyword, images, and/or other communication elements, e.g., business listing descriptors, can be analyzed, compared one to another so as to determine or otherwise predict the ability of the use of those words or other communication elements to increase one or more factors by one or more metrics, such as to increase one or more measurements of impressions, conversions, engagements, sales, positive reviews, and the like.

In particular embodiments, the amount and/or volume of traffic, e.g., traffic data 211c, can be analyzed and used to determine what keywords, and/or in what contexts, are having the greatest impact. Likewise, as explained herein, various business information 214a, e.g., business name, business location, business type, business category, business description, and the like, as well as business competitor 214b information, and/or other business contexts data, can be collected, e.g., fetched, by the system 1, may be analyzed, and used to determine a degree to which any of the above elements may be both impactful and/or relevant to a given business context. In such instances, the type of business information 214a that can be collected and analyzed by the system may be that type of information that may be used to determine the context of the business.

In this regard, because businesses may be both nationwide organizations, as well as localized, community invested shops, the referenced contexts can be manifold. Such contexts may be determined on the global, e.g., nationwide level, a mid-regional level, a state level, a city by city level, a town by town level, or a single shop, location by location, level, and anywhere in between. Thus, in various instances, the system may be configured in accordance with what contexts any given impact and/or relevancy determination is to be applied, and a multiplicity of such determinations may be performed, all or some of which may have the same or differing results based on to which level the determinations are being performed. Once the various keywords, images, business listings, or other messaging descriptors, have been collected, they may be preliminarily evaluated, classified, and/or clustered by the system, and these elements can be further subjected to additional analysis, such as by a secondary AI module, such as for determining their projected level of impact and/or relevance to a particular business entity.

Specifically, the system may include a further Artificial Intelligence Module, which may be configured for accessing analyzing the various forms of factor and metric, e.g., traffic, data so as to generate insights, which insights can then be employed so as to determine potential impact, or a predicted lift in impact, with regard to one or more factors, that utilizing one or more of those keywords within a communication might have. In various instances, this insight generation process may be a multi-step procedure that involves a secondary AI module. For example, the secondary AI modules may be configured to generate and/or implement one or more of a generative AI and/or Large Language Model (LLM), by which fetched or otherwise collected data may be analyzed with reference to one or more keywords, images, and/or other associated communication elements, and the impactfulness and/or relevancy of those communication elements may be determined, such as generally or to a specifically identified business, e.g., based on its contexts.

For instance, in a first step, the insight generation process may involve generating a prompt, such as whereby a prompt engineer, or other system component, may generate a prompt directing the generative AI, e.g., LLM, to analyze the fetched or otherwise accessible data in relation to a set of key factors to generate insights for the achievement of a determined business objective. In this regard, the business objective may be any objective of the business, but is typically related to how the business can better generate impressions, conversions, and general engagements so as to drive an uplift in sales. For these purposes, all or a subset of the collected business related data, e.g., business contexts determining data, may be fed into the AI module, e.g., LLM model, along with a prompt directing the LLM to determine insights related to determining the contexts of a given business being evaluated. Likewise, all or a subset of the collected keywords and/or keyword related data may also be fed into the LLM, along with a further prompt directing the LLM to determine insights related to determining the impact that any given current keyword, or associated keyword element, may have generally. Further prompts may also be generated and fed into the LLM, such as with regard to determining a degree of relevancy any of the predicted impactful keywords may be relevant for use by the business, such as in its business listing, whereby the use of those keywords within the business listing is predicted to help the business achieve one or more objectives.

In various embodiments, the order of determining contexts, impact, and/or relevancy, may be changed, as necessitated for promoting efficiency, and in certain instances, the quantity, quality, and/or sources of data being fed into the LLM may be prefiltered so as to cut down the amount of data being fed into the LLM. Such filters may include keyword filters, factor, metric, and/or measurement filters, impact filters, relevancy filters, business filters, location filters, category filters, and the like can all be used to filter and/or limit the words, data, and other elements being fed into the LLM. In various embodiments, an additional AI module may be used to perform this filtering and/or the referenced prompt generation. In particular embodiments, the LLM may be configured for recognizing when the AI module does not have enough relevant information for efficiently and sufficiently answering one or more directives of a prompt, and may then request or may seek the needed information, such as by accessing one or more other AI modules and/or databases of the system. Particularly, as described above, the AI module may implement a retrieval augmented generation (RAG) protocol whereby the AI module may access data external to itself, and/or the models it implements, so as to better produce a more enriched, in-depth, relevant, and/or accurate response to the prompt, such as by accessing diverse data sources.

For example, an information retrieval protocol can be implemented in addition to a LLM, whereby the LLM may be enabled to ask the AI module questions, e.g., to perform search queries of the system, thereby giving the LLM access to the central and/or distributed databases of the system, whereby data specific elements can be looked up and be used by the LLM to generate communications. This is useful because a well-known problem with LLMs are that when presented a search query, e.g., a prompt, for which they do not have enough information to generate an accurate answer, the LLM may return a fake answer, e.g., an answer that it makes up all on its own, so that it may return a result, regardless of the accuracy of the result. This is termed the “Hallucination”effect.

The present system may solve this problem by giving the LLM limited access to various portions of the central, and/or location specific repositories, so as to ensure that the LLM has access to all the data files by which the LLM can perform searches, identify corresponding data within the memory system that are relevant and accurate, and can then use that data to generate a response to a query that is correct, thereby resolving the Hallucination effect, which commonly affects the functioning of LLMs. In particular instances, the type of data by which the LLM may access system repository is within the context of determining the various contextual, impact, and/or relevancy factors so as to generate accurate signals that are important for returning an accurate response to a prompt, which data may then be used by the LLM to provide the necessary context by which the system can generate tailored responses to prompts.

For instance, various of these factors, metrics, insights, and/or signals may be used to inform the search of the LLM, such as to better provide context to the LLM, so that it may more efficiently locate, identify, and evaluate internal and/or external data, in a uniform and standardized way so as to proficiently extract the data necessary to accurately answer prompts. This data may be searched and identified on the local and/or national levels, the results can be compared to one another, conflicts therein can be identified and resolved, and a more accurate result can then be returned in a manner that can be applicable to the national wide interests of the corporate brand and/or also be narrowly tailored to the interest of the local brand, such as where the generated communications to be recommended and/or posted may be different in content, tone, voice, look and feel, and the like, and yet still be 100% accurate given the different contexts of the global and local arenas.

One difficulty in this process revolves around the system determining to what databases it will look for an answer in response to the query, and to what data it will consider as relevant to answering the query. In this and other instances, the system may use one or more of the known search engine categories as a guide for identifying and determining relevant information for answering the prompt. In such manners as this, the AI module may fine-tune the LLM so as to adjust its trained, e.g., pre-trained, models so as to become domain specific, with higher accuracy. In various instances, this and other such processes may include comparing past and present answers to prompts and/or searches, such as with regard to generating a recommendation, so as to ensure that any answer given, e.g., present recommendation, is not needlessly duplicative of past returned answers, e.g., recommendations.

In any of these instances, the results of these analyses may be a number of insights, e.g., signals, as to what keywords businesses can employ in their business listing so as to better increase the chances of that business listing appearing higher in one or more ranking regimes employed by one or more search platforms, so as to increase one or more of their business metrics. Specifically, these business insights can be used as signals that the system can employ so as to determine the search categories that may potentially apply to a business listing of a given business, and further for determining whether adding or substituting one or more words in the business listing for a keyword that is adjudged by the system to be impactful and/or relevant for a business, might in fact be beneficial for use in the business description of that business with regard to achieving one or more of its business objectives. However, it is to be noted that where the result of such analyses is a determination of what keywords are impactful for which business categories, a further determination can be made as to whether any of the identified impactful keywords are actually specifically relevant to a particularized business. Further, once impact and relevancy have been determined, the predicted extent of impact and/or relevancy may also be determined.

More particularly, in order for an AI generated insight to be useful it must be relevant to the business and its operations, and it must be accurate. For instance, the AI system may determine that Spiced Mint Cappuccinos are currently trending and that these keywords are currently very impactful for driving impressions for businesses fitting within a given search category, e.g., coffee shops. Likewise, ACE HARDWARE ® may give away coffee to its customers, and may advertise that fact. A system therefore may see that ACE HARDWARE® serves coffee and may recommend ACE HARDWARE ® employ the words “Iced Mocha Macchiato” in its listings so as to increase its ranking in various searches being performed, e.g., searches looking for: “business serving iced mocha macchiato.” However, the likelihood that a consumer searching for coffee shops selling Iced Mocha Macchiato is going to click on an ACE HARDWARE® link is pretty minimal, because most consumers know that a hardware store is not a coffee shop, and so an AI generated insight prompting the use of Iced Mocha Macchiato in the ACE HARDWARE® business listing is not particularly relevant to the business objectives of ACE HARDWARE®. Thus, since such a recommendation is not useful because it is not relevant, the system should be configured for filtering for relevance.

Further, simply because ACE HARDWARE® gives away coffee, does not mean that it gives away “iced mocha macchiato,” and thus, the likelihood of it giving away “Iced Mocha Macchiato,” is also likely to be inaccurate. Thus, implementing such a change to the business listing is likely to cause the business to be listed in a category, e.g., “coffee shops” that is inaccurate, and this can result in the business being delisted from the business platform for being inaccurate, and thereby may result in the business actually being penalizing for implementing the recommended change to its business listing. Therefore, the system should also filter for accuracy as well. Accordingly, once these data have been collected and impactful, relevant keywords and/or visual elements have been identified, generally, any given keyword or key element, may further be processed and analyzed, e.g., filtered, such as with regard to their recommended use in specific business or other communications, e.g., business listings.

These analyses may result in a number of insights being derived therefrom, which insights can then be employed by the system to evaluate which, e.g., of a list or cluster of identified keywords and/or associated categories, should be used in relation to future communications. These keywords, categories, and other input data may be processed by the system in a number of manners for a variety of different purposes so as to generate a particularized list of signals by which the impact of any specific keyword, business listing, category, or other business analytic, can be measured and its impact and/or relevance for use within a given communication, e.g., within a specified category, can be determined. Particularly, the impact and/or relevance of one or more of the evaluated data may be evaluated based on the specific commercial and/or business objectives for which the communication is being crafted and/or recommended, and in relation to the specific business and/or its business category.

As can be seen with respect to FIG. 3C, a relevancy determination can be performed such as for the purpose of evaluating whether any given keyword should be used within any identified search category for any particular business communication. For these purposes, the analytics system may implement a plurality of sets of processes, such as a knowledge extraction process, so as to determine contexts, a vectorization process, so as to represent words and/or image elements semantically, as well as clustering and/or labeling processes, such as for grouping different words and/or images thematically. Such themes may be related to one or more categories, such as categories defined by one or more search engines, and/or with relation to one or more defined classifications and/or labels. Thus, the keywords, business descriptors, images, and/or other associated elements can be correlated and stored based on their similarity with regard to semantic meaning and/or in relation to their classification and/or other defined categories.

Hence, clusters of categories forming pools of semantically similar classifications can be formed and stored, such as in a vector database, in relation to one another. In various embodiments, the generated semantic vectors, such as for the keyword and/or business listing descriptors, may be stored in one or more vector databases of the system, whereby when making a recommendation, the system can decide which of any given words having the same or similar semantic range to select for use in a communication, e.g., a business listing, by a business being evaluated. For instance, in the overall process of making a recommendation, the analytics system may perform a knowledge extraction process such as for determining the categories that may apply to a business and the keywords that may be impactful within those categories, such as for the purpose of determining the particular relevance an identified keyword may have to an identified business listing. In this manner, a number of keywords and a number of business listings can be evaluated in relation to a number of evaluated categories so as to determine the relevance of those keywords for promoting the interests of those businesses.

In such an instance, in the performance of this knowledge extraction process, a number of data can be entered into one or more artificial intelligence modules of the system, for analysis thereby, and a plurality of insights can be determined by which the relevance of a particular keyword and/or associated categories can be determined in relation to a specific business, such as for determining to the extent to which any given keyword, category, and/or other business insight is impactful and/or makes sense for use in advertising the products and services of the specific business. For example, one or more models of an AI module of the system may access collected data, such as category, keyword, consumer, and business data, can analyze that data, extract insights therefrom, and can then recommend categories and/or keywords within those categories that the business can employ in order to better achieve their business goals, e.g., increase impressions, conversions, engagements, sales, and the like. Particularly, the system can analyze a plurality of data, define particulars for the data, and with respect to those particulars, the system can determine top categories and/or keywords that are potentially impactful and relevant to those particulars, and can then filter this data down with regard to identifying what particulars are impactful and relevant to a particular business.

In these regards, the model may filter a large number of categories and/or keywords, such as from about 1000 to about 500 to about 250, to about 100, to about 50, to about 25, to about 12 to about 10, or 5, or even to the top 1 or 2 categories and/or keywords that have been evaluated and determined to be impactful and/or relevant to a particularized business. Likewise, the model can evaluate these data and can generate new keywords and/or categories that it predicts will be both of use, e.g., relevant and impactful, for the business, and likely to be employed by one or more search engines in its evaluations and rankings of search results. And as explained above, all of these processes can be performed both on the global, regional, and/or local levels, using the same or different data, as the system determines is relevant to the designated level, and can therefore generate the same or different results for the same business organization, whereby the results will be particularized to the specific business entity at the location level. In these regards, the system can thereby determine whether the generated business insights and results thereof make sense for a particular business entity, at a particularized level of the organization, and/or at a specified geographical location.

Accordingly, the system 1 may include a number of AI modules implementing a variety of models for analyzing consumer, business, and communication, e.g., search engine, platform data, for ingesting the data, for extracting knowledge therefrom, for determining insights, for deriving signals therefrom, and for using the signals to generate business insights therefrom, which can then be used to make recommendations to a communicator, such as a business owner, with regard to the types and content of the communications, e.g., business listings, they publish. In particular embodiments, the various models may include a first model, such as a classification model, e.g., zero or one shot classification model, for receiving and/or accessing data, analyzing the data to determine contexts, e.g., semantic classification, and then feeding the results thereof into a set of processing engines that can then symbolize that data, e.g., represent it mathematically, vectorize it based on semantic classification and/or category, and then store it in vector space, such as in a clustered manner whereby words and/or images having the same or similar meanings can be grouped and accessed together. In certain iterations, this process may involve analyzing input data, such as with regard to words, phrases, images, and/or content elements thereof so as to extract the “concept” that those various content elements represent, or otherwise refer to, vectorizing those elements based on the extracted or inferred “concept”and then clustering all content vectors together as a group based on that concept.

This process can be performed a number of times on different data sets, so as to extract and conceptualize language and images into keywords, classifications, and categories, and further creating a matrix of relationships indicating the manner and degree by which the conceptualized elements are related and/or relatable. In other words, using these processes meaning, concepts, and categories can be determined, and similarities and/or congruencies between them may be determined, and data having similar, or collectivized meaning, can all be correlated and stored within the same vector space, e.g., semantic based storage, such as within a cluster. In such instances, because similar elements are stored within a similar space, e.g., mathematically and semantically, they can also be retrieved in like manner, such as using a mathematical formula or algorithm generated and applied by the system, e.g., such as using a cosine similarity formula.

Specifically, as indicated above, the various data elements collected by the system can be represented numerically, whereby words within a cluster can be designated a number based on the degree to which those data elements represent the attributes of the classifications and/or categories that define, or otherwise make up, that cluster. In such instances, the words, images, and other such communication elements that most closely represent the overall concept of the cluster can be given numbers that are numerically closer together and can also be stored correspondingly closer together in vector space so as to represent their degree of similarity. As these communication elements are defined both conceptually and mathematically and are correspondingly stored in vector space, in a non-zero format, the degree of similarity between any two of the elements, e.g., represented by vectors, can be measured by the cosine of the angle between the two respective vectors, whereby it may be determined whether the two vectors point in the same direction and to what degree.

Vectors that point in the same direction and have the same or similar angels, will represent words that have the same or similar semantic meaning. This storage and retrieval process allows the system to efficiently store and retrieve items based on their conceptualized, e.g., semantic and vectorized, meaning, such as by employing a cosine similarity algorithm generated, e.g., on the fly, by the system, based on the characteristics of one or more tasks, e.g., prompts, initiated by the system. In particular embodiments, labels may be added to the analyzed data, which data may then be stored and later employed based on their labels, classifications, and/or in accordance with their categorization. This data may then be mined, e.g., in response to a communicator request or query, so as to determine how to generate a flexible milieu of potential communication content that can be mixed, matched, and substituted one with the another, to maximize business objectives. For instance, in one implementation, a business listing can be analyzed and all of its relevant classifications and categories, e.g., classifications and/or categories that accord with each of the relevant search engine platforms, can be extracted from the business listing, and can be correlated with communication content that is relevant to those classifications and categories, so as to maximize the number of times that business listing is returned as a result of a business search being performed at a search engine.

Consequently, a user of the communication platform, such as a local business operator or a nationwide brand global communications manager, can access the communication generation and recommendation system, via interacting with a remote desktop, laptop, or other handheld client computing device, running a client application of the system. Particularly, an application for accessing the system may be a downloadable application that when initiated may generate a desktop or otherwise graphical user interface that is presented at a display associated with the client computing device. The client computing device may have an input mechanism whereby the user, e.g., communicator, can engage the system such as to run a query.

For instance, the user can engage the system by entering an enquiry at a display screen presented at a graphical user interface of a client computing device, whereby the user may provide the system with some initial information, such as about the business they are running or otherwise managing, their consumers, or their competition, and/or the user may ask the system to review the business, e.g., the business communications, such as the present business listings, advertising, and/or other business communication, and the user may ask the system to assess consumer reviews about the business and/or and generate and recommend responses thereto. The user may also ask the system to recommend and/or generate insights and/or communication content, e.g., business descriptors and/or categories relevant thereto, which they can then employ in their communication strategies, specifically with regard to listings, but also with regard to generating review responses and other more generalized communications.

Generating communications that employ words that have been determined to be high performing in that their use in communications is predicted to increase consumer, e.g., target consumer, engagement with those communications, is useful because the more engagement consumers have with a business communication the greater the opportunity will be to make a sale. The same holds true with respect to review responses. Trust is an essential asset of a business, but even more so when the business being conducted is online where the two parties cannot see eye to eye. Hence, responding to reviews in a personalized and empathetic way that both highlights the good, ameliorates and solves any detailed problems is fundamental to boosting and maintaining a company's good reputation thereby garnering greater levels of trust.

For example, in particular embodiments, a workflow manager of the system may be configured to identify when a review is being made that pertains to the business, to identify the context of the review with regard to the sentiments being expressed, and to understand the contextual identifiers that found the review within a given community. From these insights, the workflow manager can determine not only what response should be made, but how to embed the response with textual, image, and contextual factors that will make a reply thereto responsive to the originally reviewer, but also act as a signal to other consumers that engaging with the business is a pleasant experience that can be expected to be repeated, and therefore, can be trusted.

Accordingly, in one aspect, presented herein is not only a listing generation and optimization platform, but also a review response and reputation management platform. As indicated, these platforms have been configured and trained so as to act autonomously within a set of predetermined parameters, e.g., prompts. Hence, in one regard, a reputation management platform is provided whereby the platform may include a number of sets of processing engines that are configured for performing listening and monitoring functions, for determining when a review, or other similar qualitative statements are being made or otherwise posted online, and autonomously generating a response thereto for posting, approval, or both. Further, the platform is also configured for generating insights, e.g., deep learning insights, so as to determine the sentiments being expressed by the review or other evaluative communication being made, and then using those insights to craft a reply that is specifically responsive to those sentiments, which are communicated in a manner to resolve any conflict and promote a sense of well-being and encouragement.

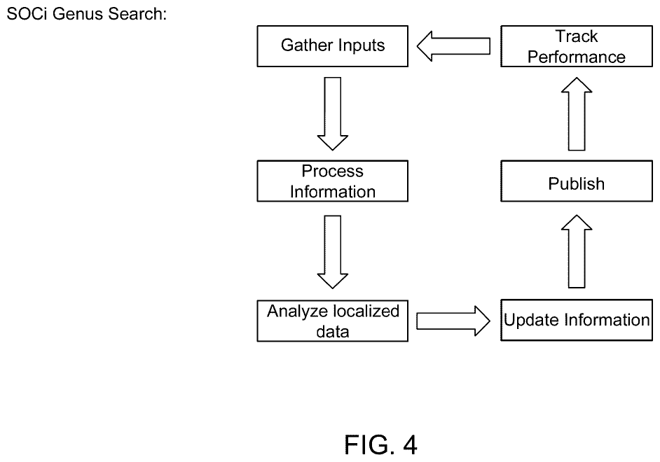

Additionally, the platform may include a further set of processing engines that are configured for monitoring and tracking consumer responses thereto, and if necessary, responding to them as well. See FIG. 4. The monitoring and tracking of consumer qualitative statements are useful because it helps the business know what consumer sentiments are like, how the company is performing, and how the company's competitors are performing. This is helpful because it allows the business to highlight success stories, such as by including them in future communications, but also to respond to negative commentary by taking corrective measures and posting responsive replies that can not only protect but boost the reputation of the company.

For instance, as can be seen with respect to FIG. 4, by collecting and analyzing this information, actionable insights may be generated that instruct the business as to how to improve their operations, processes, products, and overall performance to better serve the communities within which they sell as well as to better meet customer demands and expectations, e.g., by building a greater reputation, improving and enhancing revenue, and providing an enhanced customer experience, all of which can be managed and performed at a single client interface or more throughout the organization. The tracking of these data in comparison to overall consumer and competitor activity allows the business to benchmark their performance, see and understand how and why their business activities are performing in the manner that they are, and allow the system to derive valuable insights about where and how to improve. All of these management activities can be streamlined by accessing and engaging with the system at single client interface.

Another feature of the platform is, in addition to appropriately responding to consumer engagements and commentary, e.g., reviews, the system can also be proactive such as to elicit such commentary and reviews, such as by responding to questions and answers, eliciting viewpoints by requesting responses to surveys, and thereby eliciting reviews from consumers to be written and/or posted. Having a number of positive reviews and good engagements therewith is very important because this also is a factor that many search engines weigh when ranking a business listing in response to a query. In this manner, the reputation management and review response platform can not only autonomously craft review responses, but can also elicit such reviews and/or generate review response recommendations for the consumer that they can then approve of and post, because the more positive reviews a business has the higher up in the rankings they will appear.

In this regard, the platform can also integrate with an associated sales platform, e.g., customer resource management tool, to track inventory, generate insights with regard to maintaining inventory levels, but can also identify customers from whom to elicit reviews, which will further help the business to control how consumers are engaging with their products and may also control the messaging with respect thereto. The application may then transmit or otherwise communicate this information and request, e.g., via suitable communication network, to one or more servers of the system employing the above referenced analytical and communication processing modules. Upon receipt of the request, the system may then initiate the series of steps described herein above so as to evaluate the input or otherwise collected data, determine one or more insights, as described above, and may return one or more communication recommendations.

The communication recommendations may include a list of a variety of potential communications to be generated, such as where the communications to be generated may be advertisements, promotionals, responses to consumer enquiries, requested reviews, review responses, responses to other commentary and online engagements, and the like, where the content, its look, and/or its feel have been evaluated to be more suitable and high performing than its alternatives. In certain instances, these improvements may be implemented by swapping out old, non-impactful descriptors and categories for more high performing, impactful keywords and categories that could be employed within the communications, e.g., business listings, reviews, review responses, that if employed are predicted to increase engagement, e.g., increase impressions, conversions, and the like, and/or to enhance lift. The system can then track performance of these communications by collecting current metric, factor, and other performance related data, compare the current performance related data to past performance data, and determine the lift that has resulted, such as with respect to one or more identifiable categories. These results can then be fed back into the system to better train the models and/or better perform the analytic operations herein described.

Accordingly, in view of the foregoing, in various embodiments, the systems presented herein provide a communication generation and management platform for building a bespoke communication in response to an online posting of commentary (e.g., a review, comment, or other engagement), and for distributing the bespoke communication to a target communication recipient. In particular embodiments, the platform can further generate insights and determine at what time and on which social media platform the posting of the communication will be optimal for that target communication recipient. For these purposes, the communication platform may include a plurality of servers having one or more processing units (e.g., CPU, GPU, QPU), such as where each processing unit includes a set of processing engines, where at least one of the processing engines of one of the processing units may be a trained processing engine (e.g., AI), and at least some of the processing engines may be configured for executing a set of autonomous operations for the bespoke crafting of the communication.

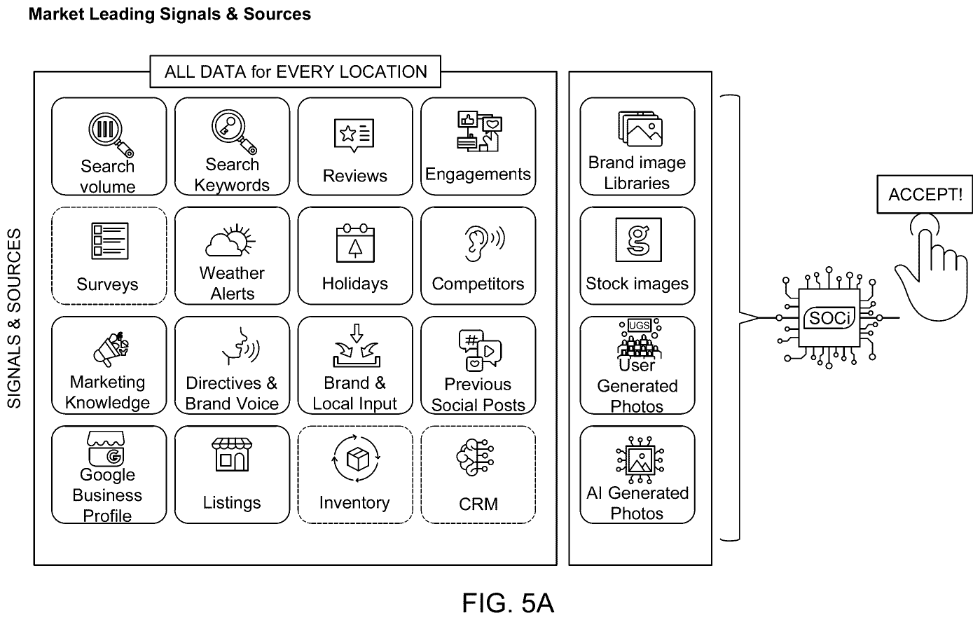

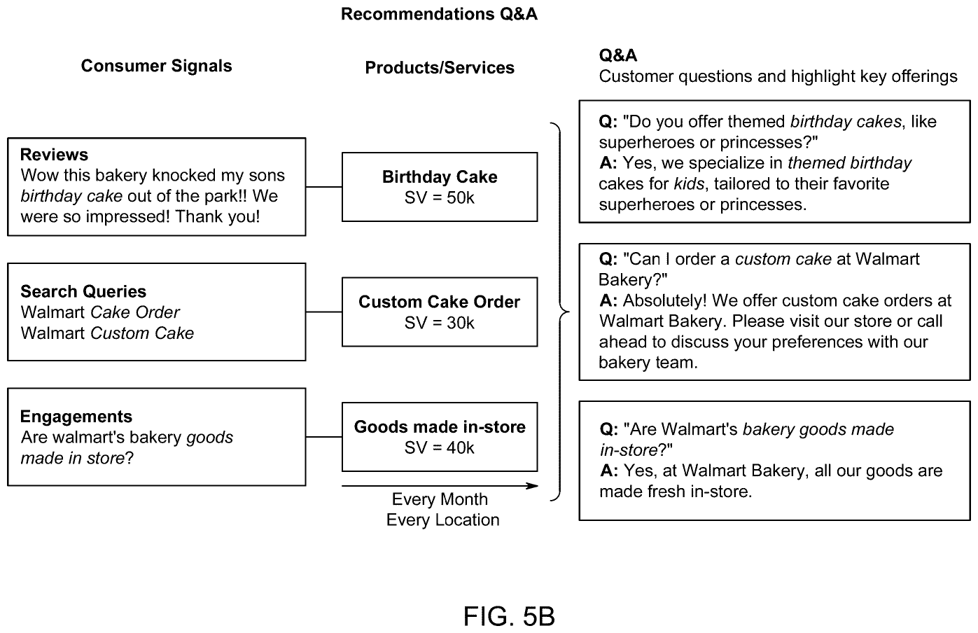

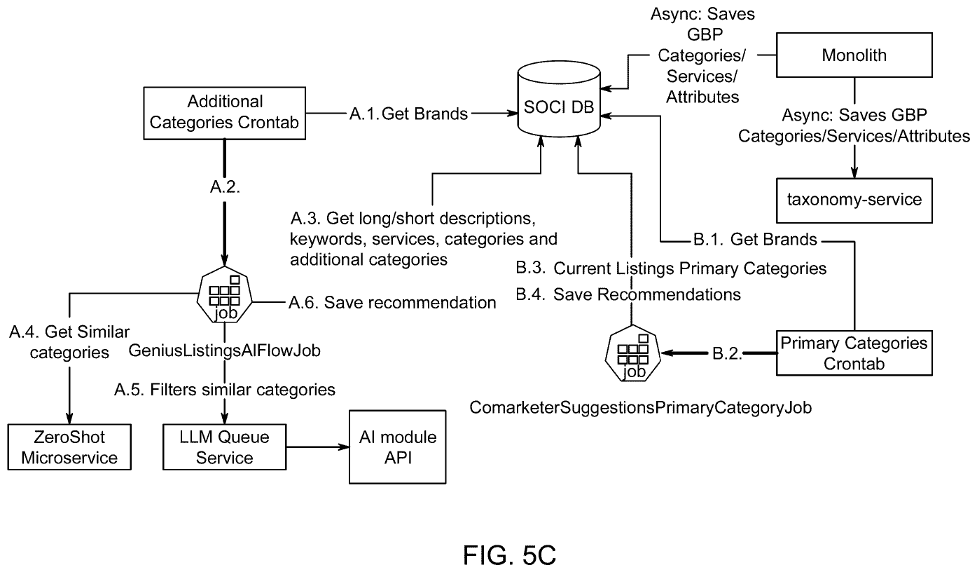

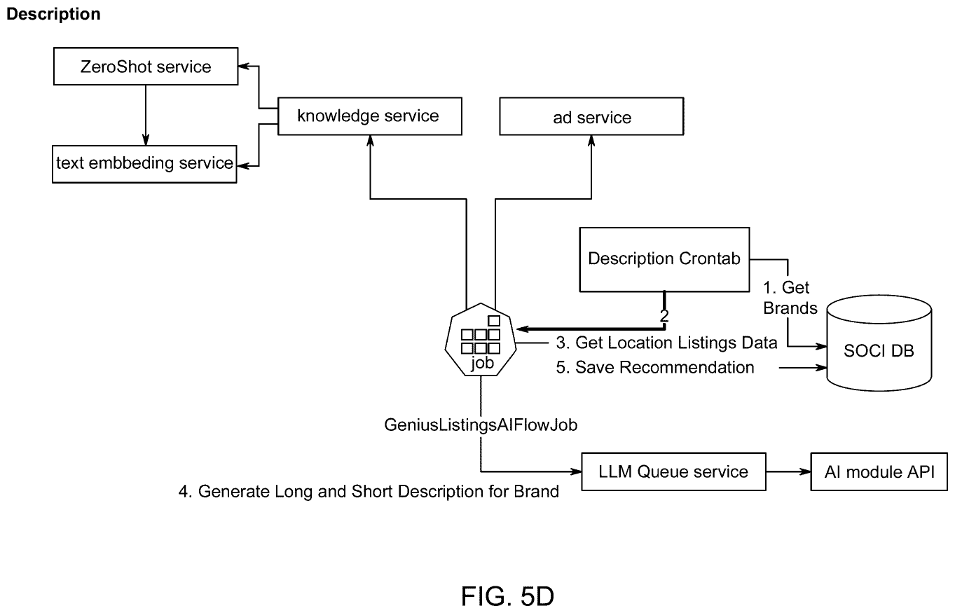

Specifically, as can be seen with respect to FIG. 5A, the communication platform may be configured for collecting a wide variety of data and generating a host of insights therefrom, such as where these insights may then be evaluated by an analytics platform of the system to determine a number of signals that the system can then use to perform the operations herein discussed, e.g., for the building of communications. For these purposes, the communications platform may include an online content monitoring module configured for monitoring postings of online content, such as where the online content monitoring module includes a contextual word recognition filter, which may be a trained workflow manager, such as an AI Agent that is configured for recognizing the posting of consumers, whereby the posting is relevant in some manner to a business, its operations, the products it sells, the services it provides, the manners by which it performs such activities, and the like.

The posting may be a simple evaluative comment, an engagement that implies a sentiment, or it may be a review or commentary posted online, or the like. In various instances, the posting may include a trigger that signals to the communication system that a response to the posting should be generated, and may further include with what urgency the response should be generated and posted, such as immediately or over time, such as when the communication is ongoing and the story is developing. In such instances, the trigger may be a predetermined signal upon which the monitoring module has been trained, which, in various instances, may be a keyword filter that may be trained to not only recognize the important word-signal, but also its context as well as its meaning and the sentiment expressed therein. Particularly, in various embodiments, a keyword meaning and context agent may be provided so as to recognize when a triggering word within a determined context, such as a review, is posted online, e.g., an online review. In such instances, the keyword may include a referent, such as business identifier or a reference to a business communicator, such as a reference to the business that is the subject of the review or comment or other evaluative engagement. And the context may be one of an evaluation, such as where the review evaluates the business and its offerings or is in response thereto.

Specifically, a feature of the communication, e.g., review response, platform is a data recognition module that is configured for executing a set of operations for recognizing, e.g., additionally determining and/or collecting, one or more review associated referents (e.g., content elements such as keywords used in a review, such as a business name or an evaluative statement about the business, to which a response should be generated. Such review associated referents may be any word, term, phrase, image, or even symbol that can be used to designate or refer to a business, such as a business using the system to communicate online with its consumers. In particular instances, at least one of the set of recognized review associated referents (e.g., content elements) may include a name of the business communicator, and another of the set of referents may be a comment, phrase, or term expressing one or more sentiments (e.g., characteristics) characterizing or evaluating, e.g., qualitatively evaluating, one or more features of the online business communicator. More specifically, the data recognition module may be configured to recognize the important elements, e.g., signals, within an online posting, and can determine, e.g., contextually, why those signals are important. The overall system then can determine just how and when to respond to those determined signals in the most impactful manner.

In this regard, the data recognition and collection module collects content and data from a large variety of different sources, which content and data are ingested by the analytics system, whereby a sizeable amount of information can be extracted, and the generated knowledge may then be evaluated so as to identify business related signals to which a response may be generated. For instance, in various embodiments, one or more, e.g., a combination of, AI models, such as a combination of large language models, may be employed to analyze the collected data, determine the relevant signals, and generate a communication that is responsive to the determined signals. In particular instances, the once a signal is generated, a LLM may be employed to determine the meaning of the signal, and a further LLM may be employed to determine a response to the signal.

Further, where useful, an additional model, e.g., a retrieval augmented generation model, RAG, may be employed to further collect and categorize the content and data, such as to assist in the determination of signals and responses thereto, as well as to assist in determining both meaning and context. Ultimately the communication builder can then use these signals and insights to craft a communication that can be posted, or be recommended for posting, in response thereto. And once posted, the post can then be evaluated for effect and impact and then be used as a template for future responses to similar circumstances and contexts. Hence, once the content and relevant data has been collected, such as via a suitably configured and/or trained RAG model, it may be subjected to a knowledge extraction analysis, e.g., via a first LLM, to determine both context and meaning of the content.

Hence, the communication generation platform may include an AI module that may be associated with a plurality of AI trained sub-modules for the purpose of identifying online content to respond to, collecting content and data associated therewith, performing a first set of analysis to extract knowledge from and to give meaning to the collected content, then performing a second set of analysis for categorizing and storing the defined content, and for performing a third set of analysis for evaluating the defined and stored content for use in crafting new bespoke communications. Each of these AI implemented sub-modules may be configured for executing one or more models in the performance of the tasks needing to be implemented in the process of generating and updating communications, such models may include on or more of a Zero or One-Shot Classification model or a Large Language Models (LLM), such as for evaluating collected content and generating insights, a retrieval augmented generation (RAG) model, such as for retrieving additional data to be consider in interpreting the previously collected content, another Zero- or One-Shot Classification model or LLM for semantically defining the content and for categorizing the collected content, and a further generative AI for employing the categorized content in the building of a new communication.

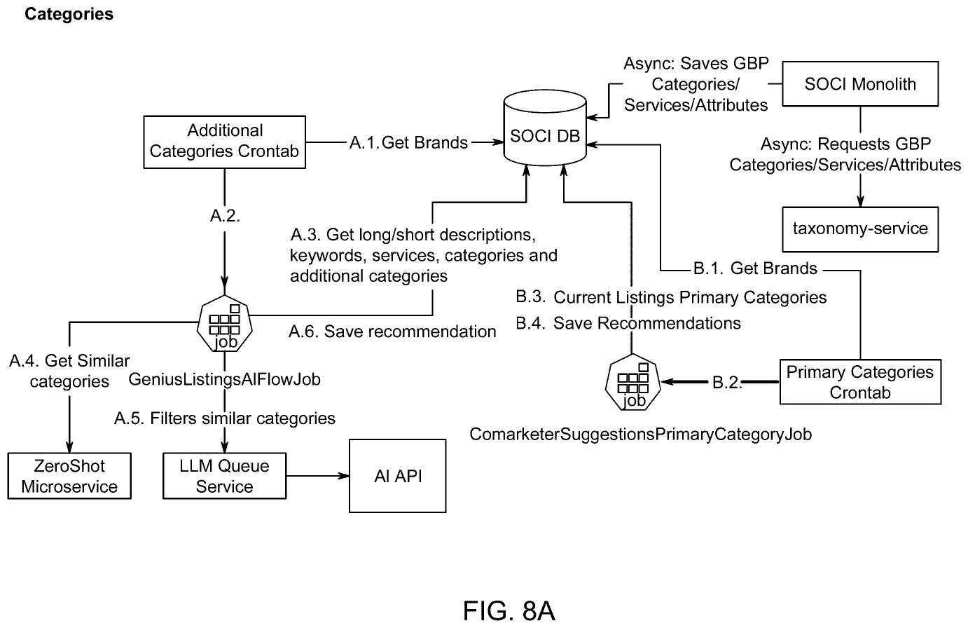

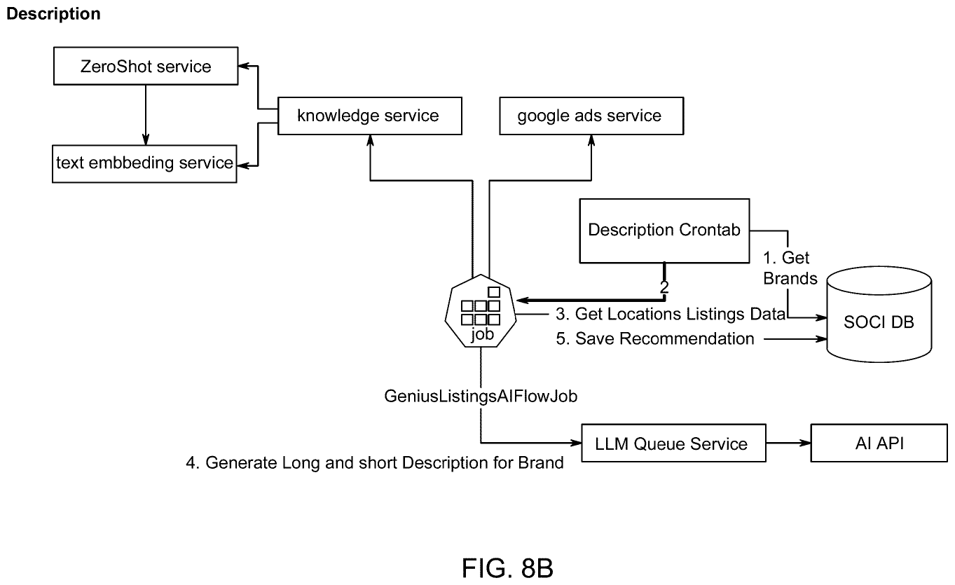

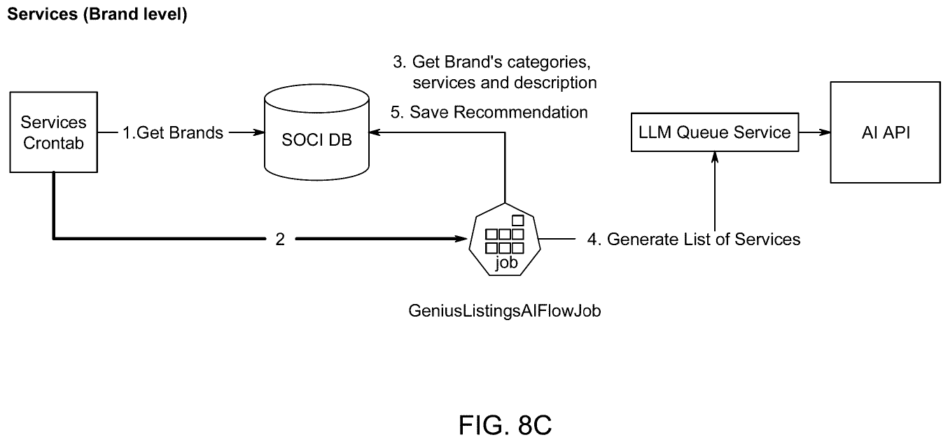

Accordingly, as can be seen with reference to FIG. 8B, in various embodiments, the content collection agent of the data recognition module may be configured for implementing a RAG model to assist in recognizing, collecting, and storing within a memory of the databases associated with the system, one or more of: the business communications (listings), content within the business communications, characterizations of the businesses, communication recipients, business competitors, and published consumer communication content (reviews), as well as other market characterizations. Other associated information and data may also be collected, e.g., as necessary, including indicators of search criteria categories, indicators of concepts of keyword meaning, conceptual referents, key concepts, keywords, categories of keyword concepts, descriptive words, word phrases, characterizations of categories, characterizations of keywords, contextual elements, engagement elements, business objectives, as well as associated data pertaining to the same. As indicated herein, in one embodiment, a contextual word recognition filter may be employed in addition to, or in conjunction with, the RAG so as to better identify online content that is important to characterizing and giving meaning to a business, the practices of the business, as well as the consumers and competitors of the business. In other embodiments, the contextual word recognition filter may be a sub-module of an artificial intelligence module, e.g., an AI agent, which implements the RAG model and is configured for accessing and retrieving, from one or more memories of the databases associated with the system, content and data related to published online content, whether it be listing or review content.

Implementation of a RAG model is useful when the system is in the process of giving meaning, e.g., semantic meaning, to the collected content, such as the collected business content, e.g., business referents, listing content, review associated content, e.g., review associated referents, as well as competitor content and competitor referents within posted communications. In many instances, the RAG model is configured to be implemented in correspondence with an LLM, or Zero-or One Shot classification model, as those models are evaluating the collected content, especially with respect to analyzing of the collected content and data that is being employed by the LLM in determining one or more of meaning and context of various online communications, such as listings and review associated communications. Specifically, the RAG model is useful for giving meaning to the various referents being referenced in communications, such as the review associated referents, for example, in the production of defined and evaluated business and/or consumer or competitor referents.

In such instances, in generating meaning with respect to collected content, as described above with respect to FIGS. 3A and 3B, the collected content can first be subjected to a knowledge extraction process, whereby a zero-or one-shot classification model may be applied to the content so as derive its contextual, e.g. semantic meaning, and once determined, the defined content can then be processed via a text embedding protocol so as to create a symbolic, e.g., numeric representation of the content. Where this content is used by a review response generation platform, the content of a review can be collected and subjected to the knowledge extraction process so as to derive the contextual meaning of the review, who the review is about, what their products and services are, as well as what the sentiments are that are being expressed, e.g., it may be determined if it is a good or a bad review. All of this information may be employed in the process of generating a response to the review.

However, as can be seen with reference to FIG. 8B, where the collected content is used by a listings generation platform, as set forth herein, a listing of the business may be collected, whereby the listing is subjected to the knowledge extraction process. As set forth above, in this process the words of a business listing are evaluated to determine their meaning and context, and then using this contextual meaning, the system will determine if various words employed in the listing can be swapped one for another. In such instances, where the high impact and/or more relevant words are to be swapped in exchange for the words in the original listing, it is because those high impact, relevant words have been evaluated by the system and been determined to be of such high performance and high impact that by exchanging the words in the original listing, the listing when published in response to a search query will appear higher in the ranked search results that it otherwise would have if not optimized.

Hence, in the implementation of this classification and/or categorization process, the original business listing is collected, e.g., in association with a RAG model, or is otherwise accessed and subjected toa knowledge extraction process whereby a zero- or one-shot classification model may be applied thereto. In various instances, the actual content of interest need only be identified and itself need not be collected to be analyzed, but data pertaining thereto may be collected and used in the analysis of the posted content. In either instance, meaning and contexts can be determined. Particularly, the words of the listing can be parsed and semantic meaning thereof can be determined. In such instances, the text may be embedded, and in some instances may be symbolized, e.g., numericized, and stored in a database of the system, such as in a clustered manner.

In various embodiments, the actual listing may include a short form and a long form, and the semantic, e.g., contextual, meaning thereof can be determined and categorized. Associated data, such as location data for each of the local businesses of a big national or multinational brand can all be collected, e.g., in association with a RAG model, so that the communications and listings of each separate business location can all be determined and controlled, such as via a single communication interface. One or all of the listings for each brand location can then be optimized whereby low impact, low relevant words in the original listing can be swapped out for words that have been determined to be high performing and more relevant, such as in accordance with the processes set forth herein above. The end product of these analyses may be one or more bespoke communications, e.g., optimized short form and long form listing descriptions, that may include both global corporate level content and local business level content that have been generated by an LLM, but based on insights derived from the RAG. In such instances, once published, the optimized content is predicted to perform better, e.g., be poisoned higher up in the rankings, than the communication otherwise would be if not optimized.

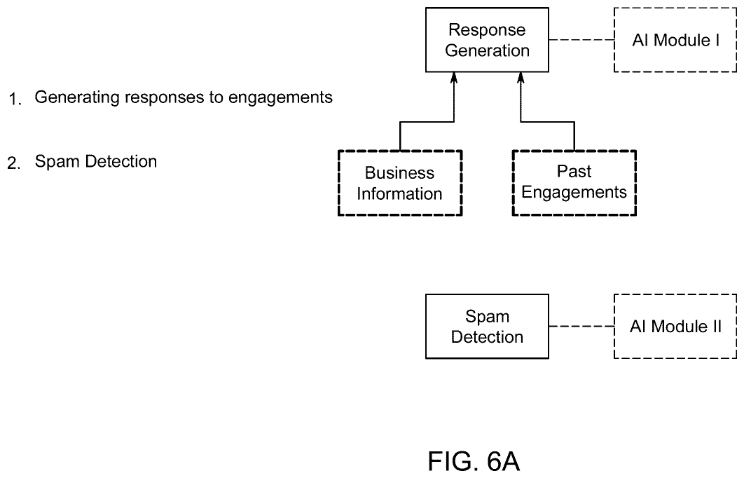

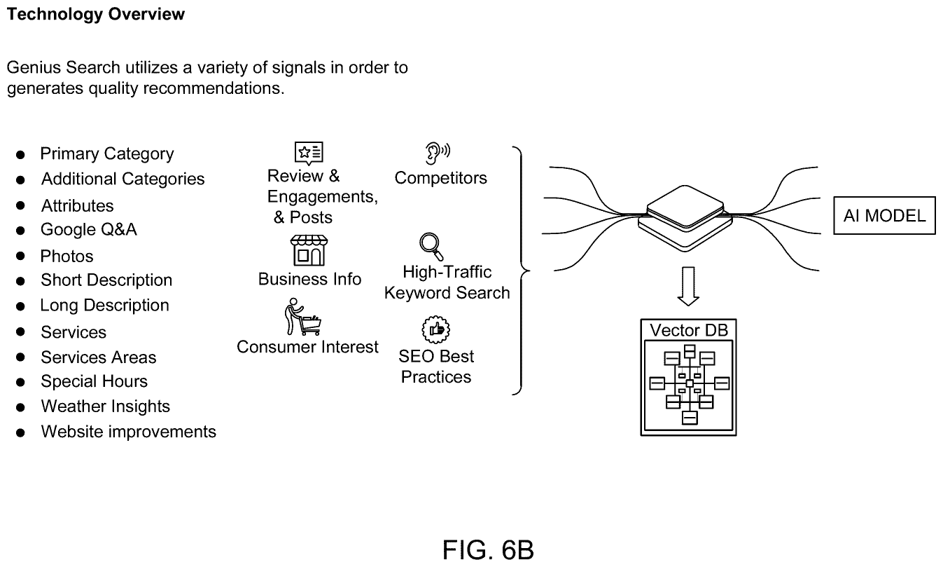

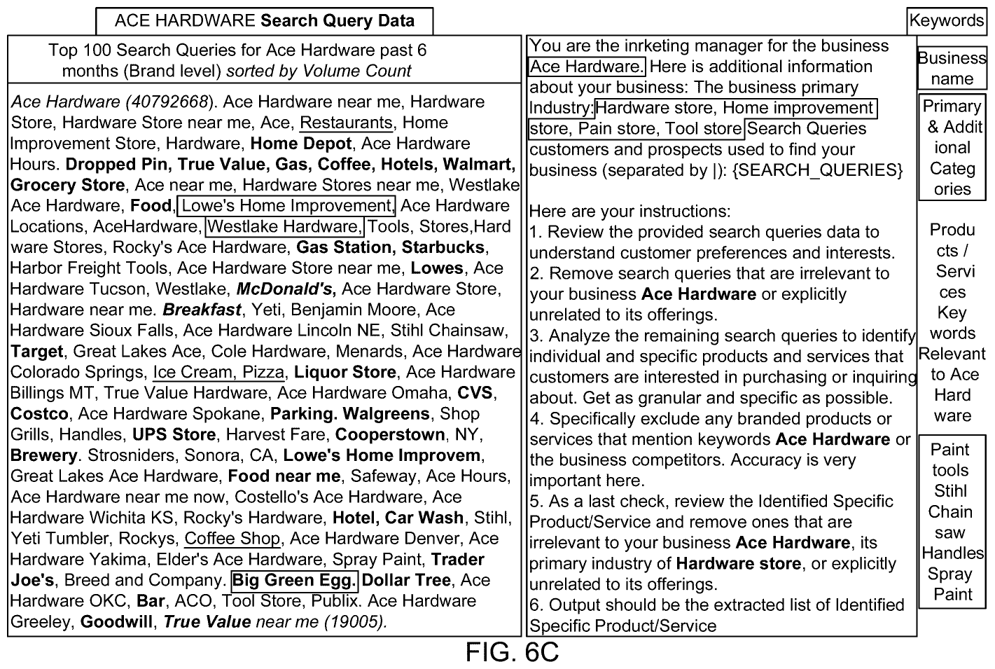

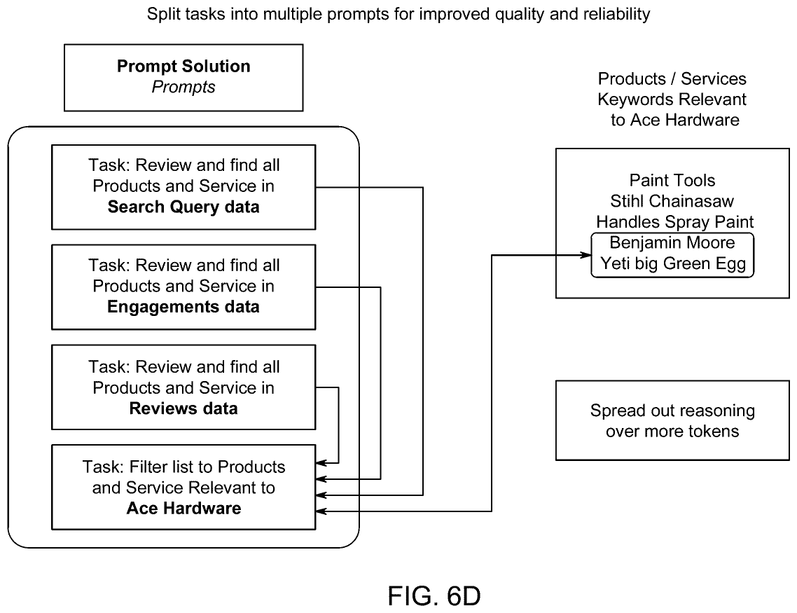

Particularly, in one embodiment, the content and data recognition and collection module may be a specialized agent that is trained to recognize and understand referents, such as references that implicate a certain business, its competitors, or consumers thereof. In such embodiments, a trained referent evaluation module may be provided whereby the analytic module is configured for executing a set of operations for both determining a meaning and evaluating at least one of the set of recognized review associated referents (e.g., content elements, such as keywords and contextual words or phrases) based on a number of characteristics of the contexts of the online communication, e.g., review, the features of the online business, and the sentiments expressed so as to produce an evaluated business referent having a determined meaning, such as to give meaning to the recognized review elements. And as can be seen with respect to FIG. 6A, once the various review signals have been identified and interpreted, then the review communication platform may be employed to autonomously generate a response thereto.

Accordingly, as set forth in FIG. 6A, the communication system may include an autonomous review response communication generation module that is configured for responding to reviews, or other comments being made online, such as in response to the generated consumer signals produced by the monitoring module. More specifically, the content and data recognition and collection module may recognize and identify a variety of consumer signals being posted, such as in reference to a business or person being reviewed, or being referenced in a search query, or in some other manner being engaged with in a significant manner online. This content and/or the data pertaining thereto may be collected and analyzed by the system so as to determine the meaning and context of the engagements, e.g., reviews, search queries, etc.

For example, the collected content and data may be subjected to the knowledge extraction process described herein, whereby the business, its products and services, as well as other characterizing information can be extracted therefrom or otherwise be determined. Using this information, the system can then determine whether a response should be generated, and if so, what content the response should include, and how the messaging should be tailored, such as with respect to what voice, tone, tenor, and with what localized indicators the communication should be crafted. One example whereby this process can be shown to work exceedingly well is within a question-and-answer framework, such as where the consumer asks a question, and the communication builder, e.g., employing a LLM, is then initiated to generate an autonomous response to the referenced questions, and where necessary, the RAG model may retrieve within or outside of the platform, any content or data needed to more fully and accurately generate an impactful response. Thus, in a manner such as this the engagement (review) response communications platform may be configured for executing a set of operations for building a communication in response to a triggering event, e.g., the posting of review, or question, or the like, where the posted content includes one or more business relevant signals to which a response should be generated.

Accordingly, as can be seen with respect to FIG. 4, the review, comment, or other engagement generation platform may include a project builder for executing a set of operations for generating a bespoke communication in response to an identified signal, whereby the communication will be responsive to both the text, content, and context of the signal. Hence, if the context of the derived signal is a review, then communication platform will include a project builder that may be specialized for crafting a review response. In such instances, the review response builder may be a dedicated workflow manager, e.g., AI Agent, that has been configured, e.g., trained, for assessing the context, meaning, and/or sentiments of the evaluated review content, in this instance, business referent(s), and based on that assessed context, meaning, and/or sentiments generating a reply communication that is responsive to the comment expressing the sentiment of the online review.

Likewise, where the review response is to be posted, published, or otherwise transmitted, such as to be posted on a review website or social media webpage, the review response communication platform may include a formatter for executing a set of instructions for formatting the bespoke, review response for display in a manner that is optimized for one or more selected search, review, and/or social media modalities. To effectuate this transmission the communication system may further include a distributor, e.g., distribution engine, for executing a set of instructions for distributing the formatted bespoke communication. In various instances, the communication, e.g., review response, may be distributed to one or more of the selected social media modalities determined to be frequented by the target recipient, and may further be distributed at an autonomously generated scheduled time. In particular instances, the communications platform may include a scheduling module, such as a trained scheduling module, that is configured for scheduling the distribution of the bespoke review response at a time when the target recipient is known to frequent the one or more selected social media modalities.

As described in detail above, in various instances, the communication builder may be directed to autonomously generating a listing of a business to be posted online, whereby the listing is optimized with respect to its company descriptors and designated categories such that in response to a relevant search query, the optimized listing will appear higher up in the returned search results than it otherwise would. Likewise, as shown in FIG. 5B, the communication builder may be configured for autonomously generating an impactful response to a question being asked by a consumer and posted. And as set forth in the preceding, the communication builder may be configured for autonomously generating a response to a review. However, in order to perform these tasks, the communication builder should be directed as to what kind of communication should be crafted and what the contents should be. For this purpose, as can be seen with reference to FIG. 6C, a listening and monitoring module of the system may be trained or otherwise configured to constantly perform a search and monitoring function so as to recognize when and where keywords that are relevant to a business are posted online, and to track and collect the instances when and where they occur.

Then, as shown in FIG. 6C, this content and associated data may be subjected to the aforementioned knowledge extraction process whereby relevant signals can be identified and analyzed, so as to determine context and meaning. Particularly, as shown, the system collects a variety of search queries referencing a number of keywords, these keywords are collected and analyzed, such as by an LLM of the system, so as to extract particular knowledge therefrom, such as with regard to a business communicator. Such knowledge may include a characterization of the business, e.g., what it does, what it sells, how well it does it, what its operational hours are, and the like, and may further include other facts relevant to characterizing a business customer or its competitors. In order to perform these tasks, one or more prompts may be generated, e.g., autonomously generated by the communication system, whereby the prompt directs the LLM as to the type of knowledge to be extracted from the collected materials being analyzed. And in response to the prompt the extracted knowledge may produce a characterization of the business, its consumers, and/or its competitors, such as with respect to its name, hours of operations, holiday service hours, the products it sells, the services it proffers, to which categories the business applies, and the like. It is from this knowledge that the communication builder may then use the products and services and other insights to generate a listing that may then be optimized, or to generate an appropriate response to a search query being entered online, a question being asked, and/or a review being made.

Accordingly, an important feature of this process is in the design and configuring of a tailored prompt that is specifically fitted to generate the precise response and answers necessary, without generating a wide range of irrelevant and/or inaccurate responses thereto. To overcome these challenges, the generated prompts may be divided into a plurality of subtasks from which the ultimate answer may be prompted based on the results of the sub-prompts, so as to improve quality and reliability of the returned results, e.g., the identified signals or keyword descriptors. More specifically, instead of prompting the LLM to return all mentions of a business, its products, and services, the LLM prompt manager may be directed to spread out the reasoning behind the prompt strategy and reasoning into a plurality of separate tokens. In this manner prompts can be divided by types of mentions, and with respect to which modality those mentions are made, such as with regard to a search modality, such as a search engine modality, other engagement modality, review modality, a question-and-answer modality, and the like. Likewise, the prompts may be limited to a specific business or business products or services, as well as various business tasks it performs.

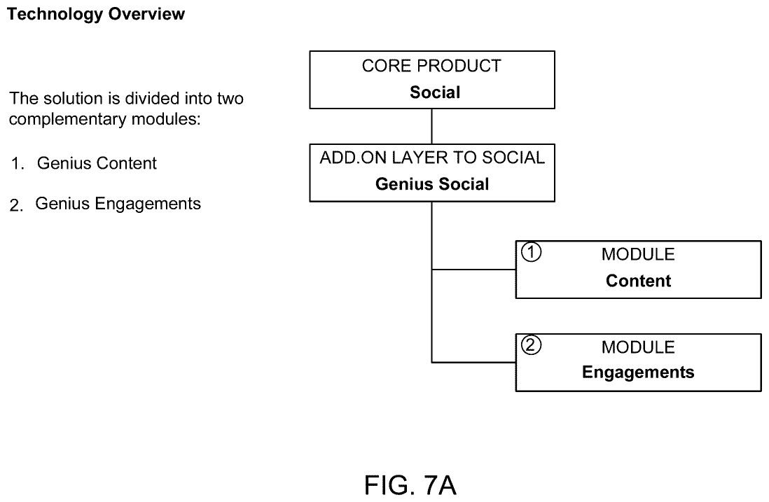

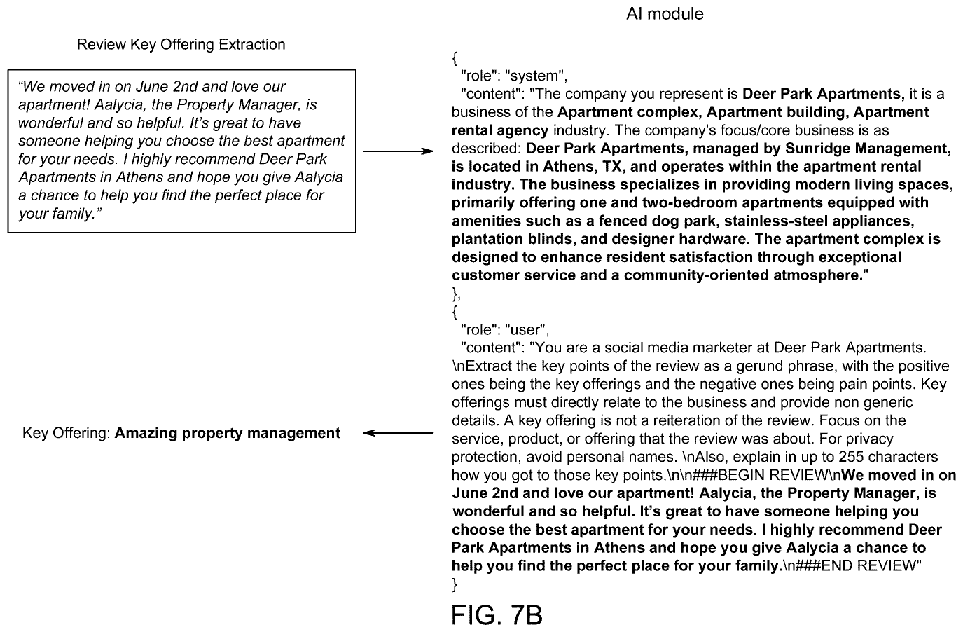

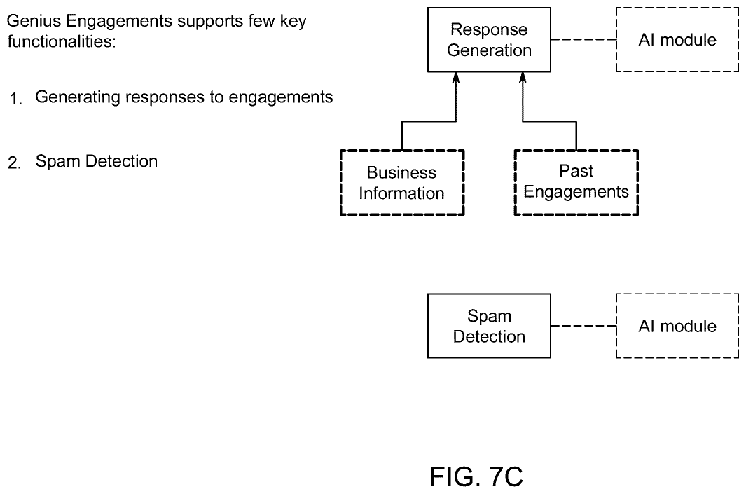

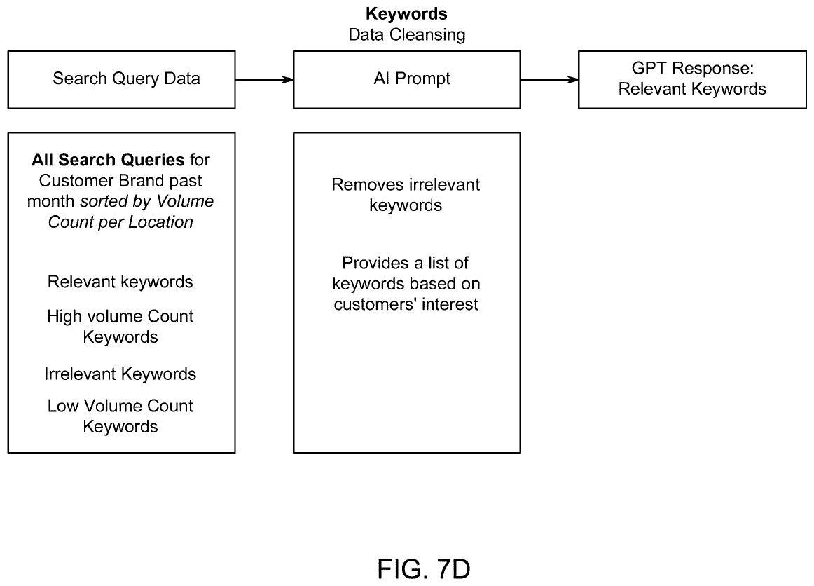

Further, as can be seen with reference to FIG. 7D, a specialized series of prompts can be designed to make future prompt responses more accurate and relevant. For instance, as indicated above the content collection module may be employed to collect a wide variety of content that can be analyzed to determine when a responsive communication should be generated and with regard to what subject matter the communication should be about. In one set of iterations, as indicated above, the system may be configured for collecting and/or otherwise determining content that can be identified as a keyword, and likewise, a number of keywords can be collected and analyzed so as to derive one or more categories therefrom. These analyses are useful because identifying keywords that are trending can help improve engagement in communications that can utilize those keywords, and identifying categories, such as business categories, that are trending, e.g., by search engine ranking algorithms, can further help the business communicators appear higher in those rankings.

Hence, for these purposes, as shown in FIG. 7D, the content collection module may be configured for collecting search query data, such as via suitably configured communication connection, e.g., API, between the communication system and the search engine platform. Such data may include all references to a particular business over a given period of time, e.g., a past week or month, etc. The collected information. May organized and sorted by volume and may be sub-divided based on brand locations. These search queries can be parsed and analyzed to determine the keywords being employed, which may be ranked based on determined relevancy and impact, and a volume count, high or low, of the keywords may be made. Then, low volume count and irrelevant keywords can be identified and discarded. Hence, to perform these functions, prior to the generation of a communication employing high impact, precisely relevant keywords, the model may be directed, e.g., prompted, to remove irrelevant, low impactful keywords from the search query data so that only those keywords and/or descriptors that are above a certain threshold of impact and relevancy can then be evaluated, ranked, stored, and considered. These keywords can then be returned when the communication builder then returns to build a communication having a determined objective in mind, such as based on a determined interest of a consumer entering a query into the search engine, or a particular business that wants to be found in response to such a query.

As indicated, both the collected and analyzed data may be stored in a database of the system, but the databases may be constructed or otherwise structured manner. For instance, once the signals have been generated and the words or phrases (or other data) pertaining thereto, have been defined and meaning attributed thereto, so as to define relevant keywords, the characterized keywords can be stored in a structured database so as to be stored in a keyword database in a clustered manner such that words or phrases that have a same or similar meaning, and/or expressing a same or similar sentiment, for example, in a same or similar context, may be stored in proximity to one another. This is useful because upon retrieval one given keyword can easily be swapped for another by comparing their meaning, sentiment, and contextual elements to each other, where those with the greatest similarity may be swapped one for another, such as without changing the meaning of the communication within which high impactful keywords are to be swapped with less performing keywords.

Hence, the content collection agent may be configured for collecting content or data pertaining to one or more of an online search being performed, a review being posted, a comment being made, or some other engagement occurring where a business or consumer or competitor referent is being made, and the collection agent can then identify and/or collect the content including the keyword and demarcate its context and the sentiment being expressed therein. Additionally, data pertaining to the posting, its contents and subjects, the business, the business consumers, and competitors as well as the poster can all be collected, stored, and can be analyzed, and the key referents can be identified and defined, and the meaning thereof may be stored within one or more memories of one or more databases of the system, such as for use in generating insights and/or evaluating which words or phrases to use in a given communication to achieve a determined objective. More particularly, in particular instances, the content collection module may be configured for collecting content and other data related to characterizing a business or consumer, such as business communicator characterization content, business communicator online communication content, business communicator online marketing content, target communication recipient characterization content, target communication recipient environment content, and competitor characterization content all of which can be used to determine context, meaning, relevancy, impact, and the like.

In this regard, as can be seen with reference to FIG. 7A, in determining what subject matter should be collected, along with how a communication should be constructed, the communication platform may collect content that is important for determining the presence of a signal, but also engagement data, which is important for determining significance and impact. This content and data, therefore, will be useful in determining the meaning and context of a posted communication, and can further be important in drafting a responsive communication that includes relevant content, but does so in a way that maximizes consumer engagement with the content, and is therefore impactful. Thus, in both collecting and generating communication content, the communication system may perform special analysis of content so as to evaluate the extent of engagement that can be expected to result for the publication of that content.

For instance, as can be seen with respect to FIG. 7B, in determining what content will be impactful for provoking and increasing engagement with a communication, posted and/or collected content and data can be subjected to a knowledge extraction process whereby one or more published statements can be analyzed, such as by an analytics module of the system, so as to determine the contexts in which the statements were made, as well as to determine the meaning behind those statements. This determined contexts and meaning can then be used to determine the meaning and significance of the descriptors and referents in the posted communication, which can then be used to further extract various characteristics about the referents, such as with regard to what products or services a given business proffers for sale, or to extract other such information about a business that a consumer may be interested in, without having to look up such information within a lookup table of a database, e.g., the answer may be inferred from the contextual content and data evaluated.

Accordingly, as can be seen with respect to FIG. 7C, the content collection module may be configured for not only collecting posted content, e.g., listing and/or review content, but may also be configured for collecting engagement content related to the posted content. In particular instances, the engagement content is useful for evidencing or otherwise determining how online users are reacting to or otherwise engaging with the posted review content. In such instances, the collected content and engagement data can be analyzed to extract particularized information therefrom, such as business information. Likewise, the engagement data can be aggregated and assessed over time, so that a number of engagements with the posted content can be evaluated, such as when determining the impactfulness of the content.

This information and data are useful because in future instances where a new, bespoke communication needs to be generated, e.g., to generate a company listing or to respond to a review, the system can use this information and data to generate new communications that are engineered in a manner to maximize impact and optimize engagement. In such an instance, the project builder may be instantiated by a workflow manager, e.g., an AI agent, that is configured to not only build but optimize the communication to achieve a company defined objective, e.g., to increase reach or lift. In more particularized instances, the workflow manage may be instantiated by an artificial intelligence module implementing a model such a CHATGP“n,” or OPENAI®, or the like.

Specifically, in various embodiments, one or more of the project builder and analytics module may be instantiated by an AI module that executes one or more of an Artificial General Intelligence protocol and a Generative Pre-trained Transformer model so as to generate the various insights referenced herein and to produce the bespoke communications and/or the updates thereto, e.g., updated listings. In such instances, the project builder may be communicably coupled to a database of the system, such as where the database embodies a neural network architecture that allows the communication platform, e.g., listings optimization and/or review response platform to process and understand contexts by determining the relationships between descriptive words and keywords.

The collection, interpretation, and evaluating being performed in these instances is useful not only for determining context, meaning, and engagement generally, but are also useful for determining particularized context, meaning, and engagement that is relevant on one level to a global business entity, e.g., business communicator, but is also on another level relevant to a local representative of the larger commercial entity. Categorizing the extracted content and data based on contextual and/or organizational relevance is useful for crafting communications that have to achieve a multiplicity of purposes, such as to be relevant to a national brand, but also of particularized interest to a local community. In this manner, the communication builder is able to craft a communication, such as review response, based on collected content and engagement data that includes communication elements that are both of interest to a nationwide consumer base, but also relevant to a localized community within which a smaller business representative resides.

In such instances, the communication may be generated and configured so as to be distributed both locally and globally. In particular instances, the communication, e.g., review response, can be crafted so as to have a globalized brand look but a locally relevant context and feel. For instance, in various embodiments, the locally relevant feel may be generated by including a localized context in the bespoke communication, whereby the localized context is derived from insights produced by a knowledge extraction process that analyzes one or more of collected content or data that pertains to the communication type, e.g., the listing, the online review or other engagement, the business referent, the keyword, the context, the sentiment, the business communicator, the target communication recipient, the business communicator characterization content, the business communicator online communication content, the business communicator online marketing content, the target communication recipient characterization content, the target communication recipient environment content, the competitor characterization content, and the like, so as to derive the extracted knowledge and insights.

Further, in various embodiments, in evaluating the collected content and/or data to extract knowledge therefrom and generate a number of insights pertaining thereto, such as for determining meaning and evaluating for communication generation, the evaluation module may employ a number of different models. For example, a first model may be employed so as to determine one or more meanings and contexts of the collected content, such as online search, listing, review, or other online engagement content, whereby the evaluation module may then apply the first model to one or more of the online collected content, e.g., listing and review content, the descriptors and/or referents therein, the keyword, the contexts, the sentiments expressed, characteristics about the business, or characteristics of the person posting the online content, and the like, so as to evaluate and determine the meaning of the evaluated content, for instance, to more fully give meaning to the collected content, e.g., business related descriptors and referents.

For these purposes, in various implementations, the evaluation module may include or otherwise be associated with an artificial intelligence (AI) module, such as an AI module that executes one or more models, such as a Large Language Model (LLM). In such instances, the LLM may be trained on the generated insights, and may be configured for determining the semantic meaning of the collected and evaluated descriptors, referents, keywords, characteristics, and the like. In particular instances, the LLM may be trained on the determined insights, and based on those insights, may then generate the determined meaning, which determined meaning may include semantic meaning that is generated from the insights. Further, as indicated, where useful, the evaluation module may additionally implement a Retrieval-Augmented Generation (RAG) model that is configured for accessing and retrieving, from one or more memories of the databases associated with the system, content and data related to one or more of the listing and/or review descriptors, referents, keywords, sentiments, and the various business, consumer, and competitor characterizations being evaluated by the LLM, which content and data may then be employed by the LLM in determining one or more of meaning, context, sentiment, writing style, vibe of the listing, review, and associated descriptors, referents and/or the like.

As can be seen with respect to FIG. 8A, once a number of descriptors, referents, and/or keywords, have been identified, collected, and analyzed, and meaning has been attributed thereto, such as where the collected content may have been retrieved from a review webpage or from search results obtained from a search engine website, such as via a RAG model, the defined content elements can be grouped together, and can then be analyzed in comparison to one another. As set forth with respect to FIG. 6C, in this manner, the various collected and defined communication content can be characterized as a member of the group, whereby the group is then characterized by the individual aspects of its members, and in this manner one or more categories can be defined. These categories are important for clustering the semantically defined communication elements, e.g., descriptors, referents, and keywords, but are also useful for determining trends with respect to the categories being applied by the search engines to rank business listings and/or posted reviews and review responses.

Accordingly, FIG. 8A sets forth a process whereby a number of the categories being employed by one or more search engines may be determined with a determined level of predicted accuracy. In this process, a list of search references to a given online business, e.g., business listing, can be collected, the search rankings that resulted from the search query can also be analyzed, and from these analyses one or more categories being applied by the search engine to categorize the business listing can be determined along with a predicted level of accuracy. In this manner, the brand, its products, services, and other offerings can be categorized based on the attributes by which the search engine ranks the brand relative to known search queries. Overtime, the list of categories can be narrowed down to a select set of primary categories.

This process can be repeated for a number of brands, so an overall more objectified list of categories can be defined and monitored so as to determine when category trends change, and the list of primary categories needs to be updated. When this happens the list of current primary categories can be updated, and likewise once this update takes place, all brand listings that fit within the old outdated set of categories can be redefined, their communications recrafted, and their listings updates so that they now fit squarely within the new categories, based on the system generated descriptions of their attributes applying the current set of favored keywords predicted to be trending, impactful, and relevant. As can further be seen with reference to FIG. 8A, when this happens this updated change to listings and brand communications can be performed autonomously and automatically or can be saved as recommendation for execution upon approval. In either instance, when the trends or the business offerings change, then the system can autonomously change the descriptions and characterizations of the business communications, such as by updating the long and short descriptions and categories applied to the business listings, which recommended changes can be saved to the system or may be made live automatically.

Further, as seen in FIG. 8A, this process can be expedited, as described in detail above, the communication platform, in this instance a listing generation platform, can employ an AI module that implements a number of different sub-modules, each of which may implement a different model. For instance, a first AI sub-module may execute a zero-shot classification module so as to collect, analyze, semantically define, and categorize collected communication content, which content can include business communication content, including descriptions, characterizations, referents, and the like. From this generated contextually defined meaning, the analyzed content can be further assessed in a manner to derive insights therefrom. This content and the generated insights therefrom may then be fed into a second AI sub-module, e.g., implementing an LLM, whereby the content can be characterized and categorized such as with respect to potentially using the content in the production of new communications, such as for use in the generation of new or updates business listings and review responses. In certain instances, one or more filters may be applied, e.g., keyword filters, whereby the number and type of categories that may be applied to the semantically defined content can be narrowed down, prior to categorizing the defined content.

Once categorized and stored, the content can be made available by a third AI sub-module, this time implemented by a communication builder portion of the communication platform, whereby the semantically defined content can then be evaluated for use in the building of a new communication, which new communication can be crafted in accordance with newly defined or updated categories. This process is useful for ensuring that the generated communication employs wording, phraseology, contexts, and sentiments that have been determined to be the highest performing and most impactful, given determined business objects, while also fitting within the predicted limitations of the most up to date search engine categories. In this manner, the system can ensure that the visibility, searchability, and consumer engagements with the crafted communications will be optimized and maintained in that manner.

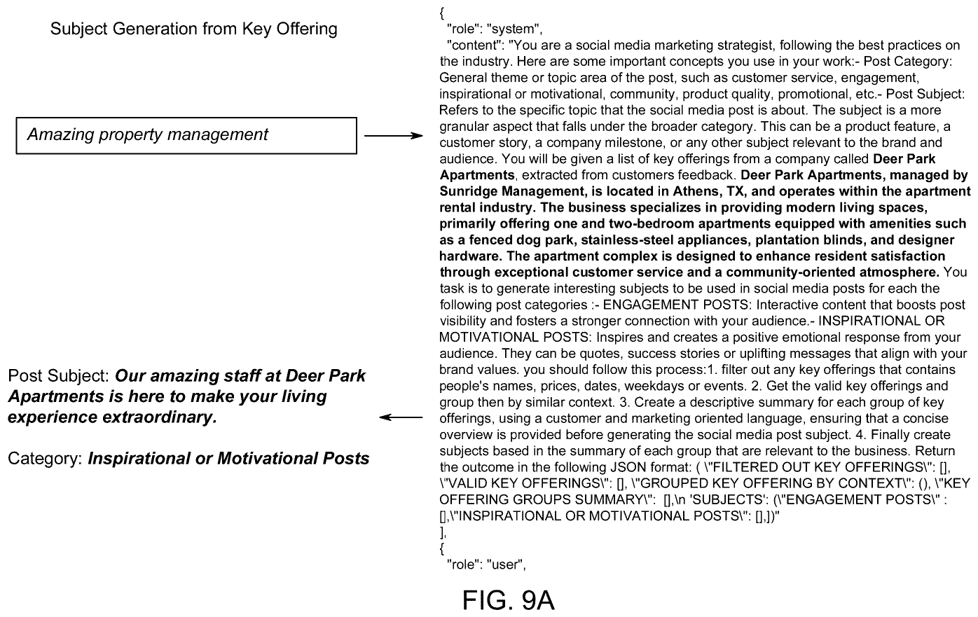

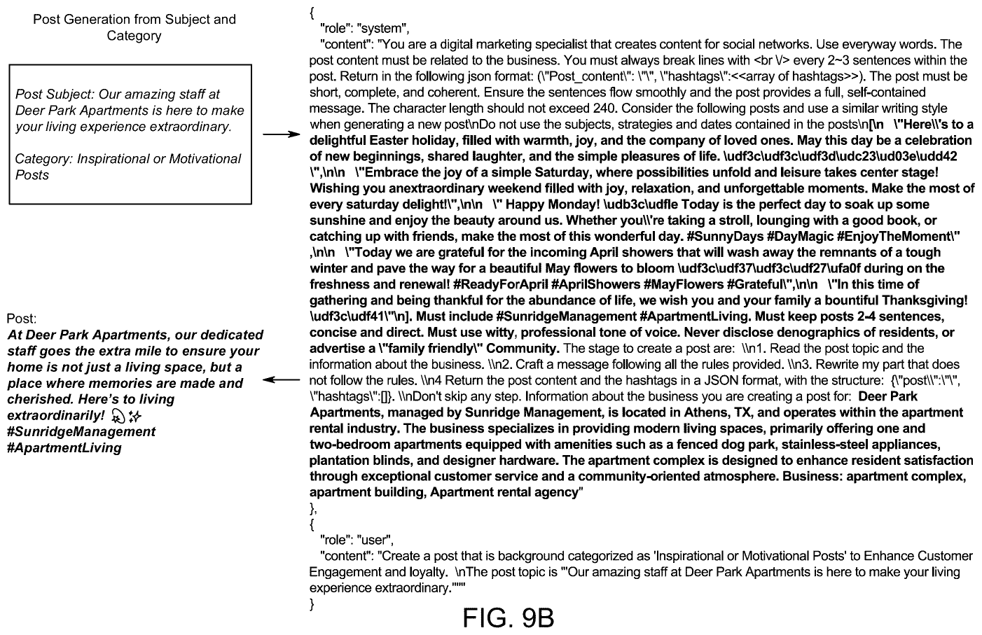

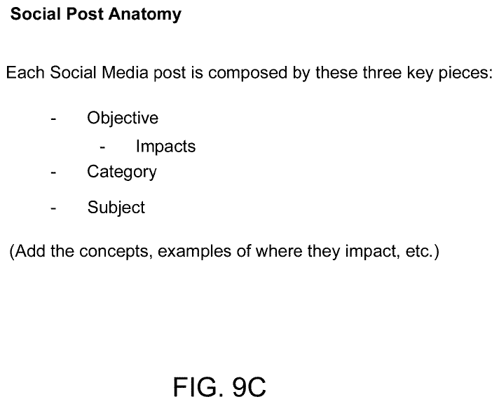

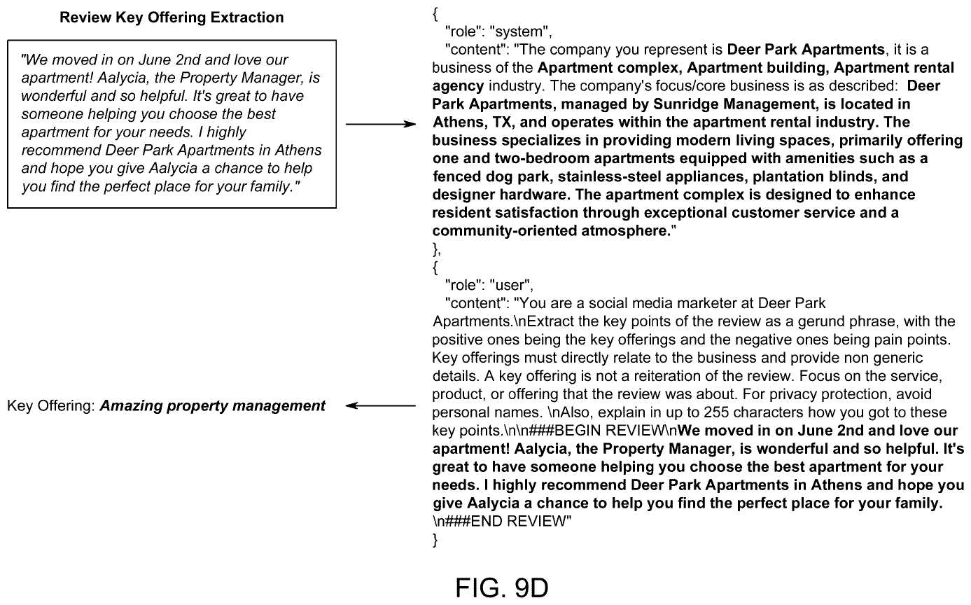

As can be seen with reference to FIG. 9C, in interpreting a communication, such as a review response, a listing description, or a social media post, the communication may include three different elements, such as an objective, configured to provoke a predicted level of impact, a subject, defining the meaning of the communication, and a category, setting the parameters as to what the subject is about. As can be seen with reference to FIG. 9A, in various instances, the subject of a communication, e.g., including a written description, may be derived through the knowledge extraction process. As described above, the content to be evaluated can be collected fed into, or simply be accessed by, the knowledge extraction module, whereby the written description will be analyzed and its context and meaning will be determined, in accordance with the methods disclosed herein. From this meaning the subject of the communication can be determined contextually, in this instance the subject is “property management.” The sentiment can also be determined, which is “amazing.” And one or more relevant categories relevant to the subject and sentiments expressed in the written description can also be determined, e.g., contextually inferred by this system. In this instance the category is inspirational. From this information, the objective if the communication can be understood. The impact of the communication can also be assessed by the system.

This is the process by which meaning can be given to collected or otherwise accessed content. The reverse may be practiced when generating a response to an interpreted communication. As can be seen with reference to FIG. 9B, in building a communication, such as a review response, a listing description, or a social media post, the objective for the communication may first be determined, the category to be communicated about may be devised, and the subject and subject matter may be defined. However, any order of communication interpreting and building can be employed. In either of these instances, the knowledge extracted and the insights generated therefrom may be the same or similar so as to be sure that the communication to be crafted is responsive to the original communication that triggered the need to generate and distribute the reply. This is also the methodology that may be employed when extracting or otherwise determining various characteristics about a business or its offerings, e.g., key knowledge extraction, when reviewing business communications during the listings generation process. See FIG. 9D.

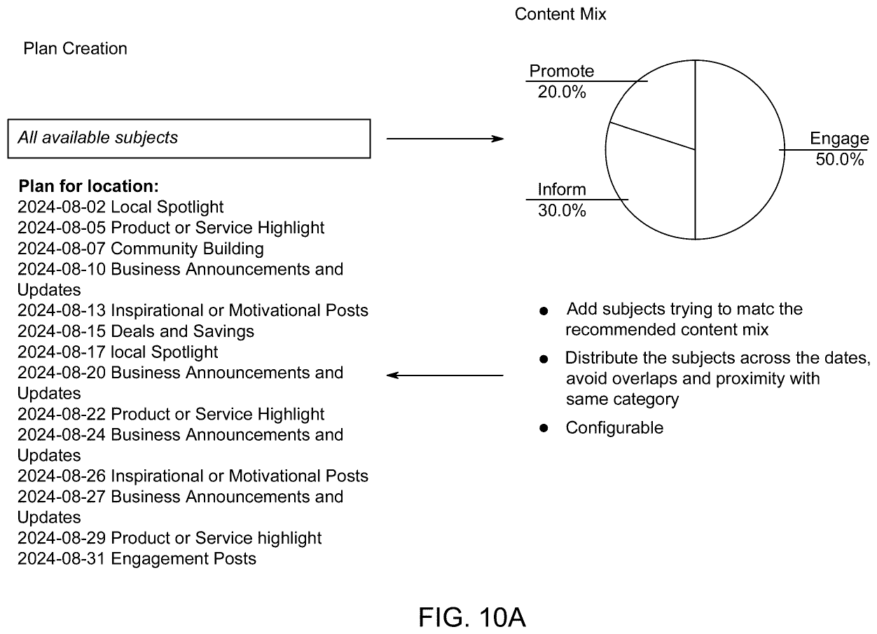

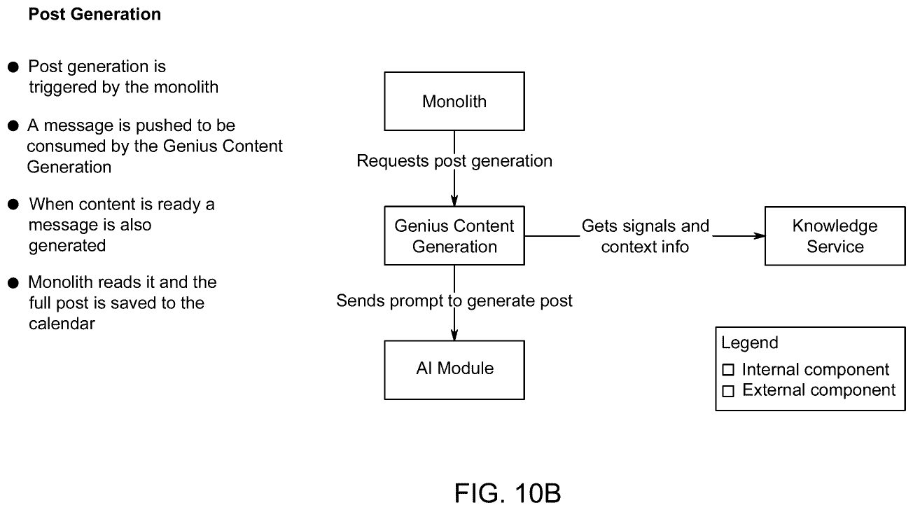

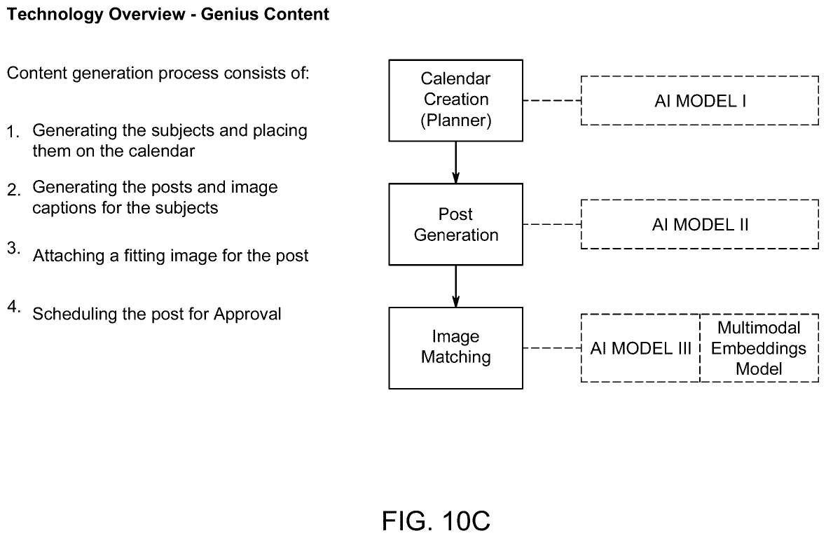

Further with respect to crafting bespoke communications, as can be seen with respect to FIG. 10A, the communications generation platform may schedule and calendar a series of communications to be generated over a course of several hours, days, months, and the like. What this means is that after the collected or otherwise assessed content has been evaluated, knowledge extracted therefrom, insights generated, and stored, such as in a clustered manner in a structured database of the system, this content will then be accessible via the communication builder for the crafting of a number of different communications having one or more of different objectives, different subjects and subject matters, different contexts and sentiments, as well as belonging to different categories. Hence, using the collected material, a whole variety of communications can be generated, such as in accordance with best practices, so that throughout any given period a wide array of communications can be posted where none of the communications are too similar as to provoke communication fatigue and a loss of interest. The communication mix may be of any determined proportion, such as where 50% of the communications to be distributed are for the purpose of increasing engagement, 30% of the communications are distributed so as to be informative, and 20% of the communications are crafted to be promotional, all of which can be placed on a calendar to be generated and distributed at a predetermined day and time.

For instance, as can be seen with respect to FIG. 10C, in one embodiment, the content generation process may first include the creating of a calendar of communications to be generated. In creating such a calendar, the subjects and/or subject matter may first be determined, e.g., by a first AI sub-module executing a first model, such as an LLM, and placed on the calendar, such as where each subject is varied so as to make each respective communication different from those scheduled to be delivered within the same time frame. Once the subject matters have been determined, then the post texts and images corresponding to those subject matters can be determined, such as by a second AI sub-module executing a second model, such as a second LLM, where a caption of the text is matched to the subject matter of the text. Next, the image can be collected and attached to the post. Then the communication can be scheduled and upon approval the communication can be generated and transmitted, e.g., by third AI module, such as a generative AI module, at the calendared time. In a manner such as this, a regular schedule of varied postings may be implemented.

As indicated above, each bespoke communication may include a category identifier, a subject identifier, and an objective identifier, such as where each communication may be based on a knowledge set that was extracted from one or more key offering descriptions of the business communicator, which may be determined in accordance with a RAG model. In this manner, a communication can be varied in a number of ways, such as by varying the category of the communication, its subject, and/or its object. In various embodiments, both the objective and subject of the communication may autonomously be determined by the system, such as based on one or more of the system generated insights, and in particular embodiments the determined objective may be to maximize consumer reach. Once the communication has been determined to be useful for being distributed, the scheduling module will then determine when the bespoke communication is to be calendared and when it will be delivered.

In this manner a whole series of bespoke communications may be calendared to be generated and distributed on a pre-set schedule in such a manner that the category, subject, and objective of the bespoke communication differs. In particular implementations, the scheduling module may be a trained scheduling module that is configured for scheduling the distribution of the bespoke communication at a time when its targeted recipients are known to frequent the one or more selected social media modalities at which the communications has been scheduled to be posted. Hence, the scheduling module may determine the subject of the bespoke communication, but also the day and time and mode of the distribution.

In view of the forgoing, in generating a communication for posting, such communications can be calendared for posting in accordance with a set schedule, as described immediately above. However, in particular instances, as can be seen with respect to FIG. 10B, in some embodiments, the generating of a communication for posting may be in response to a triggering event. In such instances, the workflow manager may generate a signal that a triggering event has occurred. The generated signal may then be pushed to the communication builder with a request that a communication be built. Insights may be generated and sent into the knowledge service module where those insights can be turned into signals, and in response thereto, a communication responsive to the triggering event and contexts can then be generated, such as by initiating of the selection of content in accordance with a determined subject and context.

Once the appropriate content and context have been determined, e.g., via the content generation module, then the communication builder can build the communication. At this point the communication can either by automatically distributed or be set for approval and/or calendared for distribution at a preset schedule, e.g., day and time, and with regard t one or more selected social media or other transmission modalities. Where approvals are required, at the completion of anyone of these steps, a message may be generated and sent to a system user to indicate thereto that the next stage of the process has been accomplished, and likewise when the post is ready for review and approval another message may be sent, as well as when the post has been published.

As described above, in one instance, a communication to be crafted is generated and distributed in response to a triggering event. In other instances, the communication can be generated in accordance with a preset schedule of distribution. However, as further explained above, in various instances, the communication may be a listing for a business that is set to be published in response to a search query being entered into an interface at a search engine website. For these purposes, the communications system may include a listings optimization platform for generating an optimized business listings in response to one or more system generated insights, e.g., a signal determined to be a triggering event.

Particularly, the business listing may be optimized by having one or more of its words, descriptors, or referents replaced with other words, e.g., keywords, which have been predetermined to be more impactful and/or relevant for obtaining a determined business objective. In such instances, the optimized business listing may have one or more keywords determined to be of high-ranking value. In some instances, the optimized business listing may be published in a format that has been optimized for display on a social media website to which the optimized business listing is to be published.

As indicated above, in various instances, the business listings optimization platform may be associated with a database that may be dedicated to storing content and data pertaining to the business and its communications, especially with respect to its listings. For instance, the database may have a memory that is configured for storing a plurality of content elements, such as including one or more business listings, business listing content, a business characterization, a communication recipient characterization, a competitor characterization, a market characterization, categories of keyword concepts, concept indicators, conceptual referents, key concepts, keywords, high performing keywords, updated keywords, descriptive words, word phrases, a characterization of categories, a characterization of keywords, contextual elements, engagement elements, a business objective, as well as data pertaining the same. In such instances, the database may be configured to be queried, such as by a listings project builder, in a manner to effectuate rapid access to the plurality of these content elements.

Accordingly, for building the optimized business listing, the business listings optimization platform may include a plurality of servers having one or more processing units, where each processing unit includes a set of processing engines. In certain instances, at least one of the processing engines of one of the processing units may be a trained processing engine and one or more may further be configured for executing a set of autonomous operations. In these regards the set of processing engines may include an online listing monitoring module, a data collection module, a trained conceptual referent evaluation module, and an autonomous update listing generation module.

More specifically, the autonomous update listing generation module may include an online listing monitoring module that is configured for monitoring business listings posted to a social media website. The listing monitoring module may have a conceptual referent filter, such as a keyword recognition filter. In particular instances, the conceptual referent filter may be configured as an AI agent that has been trained to recognize concepts including keywords, their context, and their meaning. In either instance, the online listing monitoring module may be configured for recognizing the posting of a conceptual referent within a business listing. In this regard, the conceptual referent may include a key concept that includes at least one descriptive word that has been determined to be a variant of a high performing keyword for achieving a determined business objective.

A data collection module may also be included, such as for identifying and/or collecting the content of the listing and its associated data. For example, the data collection module may be coupled to one or more memories of the database, and may be configured for executing a number of sets of operations for recognizing, collecting, and/or storing within a memory of the database, one or more listing associated conceptual referents, such as keywords or phrases used in the business listing, including the business name, descriptions about the business or its offerings, operational parameters about the business, and the like. What makes these conceptual referents important is that the system can identify them as fundamental to the business listing, but also as poor performing, low impact words and phrases to which a modification should be made (or at least evaluated), so as to replace these referents with more high performing words that will have greater impact with regard to achieving a determined business objective. Consequently, data collection module may be configured for identifying and/or collecting conceptual referents as well as associated descriptive words used in the business listing that may be in need of change. Where a modification is evaluated to be made, the modification may be made based on an evaluative comparison between at least one descriptive words of the conceptual referent and a category of keywords to which the high performing keywords are associated.

For the purposes of performing the aforementioned evaluations, the autonomous update listing generation module may include a trained conceptual referent evaluation module. In this instance, the evaluation module may be configured for executing a set of operations for both determining a meaning of and evaluating the collected listing associated conceptual referents, such as for evaluating listing, the listing content elements, as well as any keywords therein and any contextual words or phrases. In various instances, the evaluating may be based on a number of characteristics of the category of keywords so as to produce an evaluated referent having a determined meaning and a ranking. In particular instances, the evaluating may include comparing one or more of the descriptive words to the category of keywords.

Accordingly, once a business listing in need of updating has been identified, the words and descriptors, e.g., business referents, it uses to describe the business and its offerings have been evaluated, and the system has determined that those referents can be swapped our with more higher performing, greater impact keywords, then the business listings optimization platform may autonomously generate an updated listing. For these purposes an autonomous update listing generation module may be included so as to generate the updated listing.

Particularly, the update listing generation module may be configured for executing a set of operations for generating the updated listing, such as in response to a triggering event. For these purposes, the updated listing generation module may include a project builder that is configured to access the memory and to execute a set of operations for generating the updated business listing. More specifically, the project builder may include a number of sets of processing engines that are configured for accessing the memory and selecting and replacing one or more descriptive words of the listing associated conceptual referent with at least one high performing keywords to thereby produce the updated business listing. The updated business listing, therefore, will include one or more updated keywords. In various instances, the selecting may be based on a higher ranking of the updated keywords over a determined ranking of the descriptive words of the listing associated conceptual referent.

In various instances, the conceptual referent filter may include an artificial intelligence agent that has been trained to recognize one or more concepts including a business listing, content within the business listing, a characterization of the business, a characterization of a communication recipient, a characterization of a business competitor, a market characterization, a category, an indicator of a concept, a conceptual referent, a key concept, a keyword, a category of keyword concepts, a descriptive word, a word phrase, a characterization of a category, a characterization of a keyword, a contextual element, an engagement element, a business objective, and the like, as well as data pertaining the same. In certain instances, the conceptual referent filter may be configured for employing a model for recognizing and characterizing the conceptual referent within the business listing. In a particular instance, referent filter may be composed of a referent recognizing AI agent that is configured for working with the data collection module to identify and/or collect the business listing, and then the referent agent may apply the model, e.g., a large language model (LLM) to the business listing so as to generate a contextual understanding of the business listing and the various descriptive words, e.g., descriptors, employed therein.

Accordingly, in various embodiments, the conceptual referent filter, e.g., AI agent, may further be configured to identify and characterize the one or more descriptive words within the listing associated conceptual referent. And then based on these characterizations, the referent agent can identify one or more categories of keywords that may apply to the characterized descriptive words. Specifically, the agent can compare, evaluate, and/or rank the characterized descriptive words in relation to a number of other keywords within the identified categories. In such an instance, the identified keywords that rank higher than the characterized descriptive words can then be given a greater weighting, such as for deciding whether to replace the descriptive words with higher ranking keywords.

More specifically, once the descriptive words have been characterized, they may be stored within a memory of one or more of the databases associated with the system. In such an instance, the storage of the characterized descriptive words may be based, at least partially, on a correspondence between one or more characteristics of the characterized descriptive words and one or more features of other keywords within the category. In this instance, the features of the keywords define the respective category, and the characterized descriptive words are stored in a relational manner thereto so that the more the characterized descriptive words correspond to the category, the closer to a node defining the category the characterized descriptive words can be ranked and placed for storage.

Therefore, based on a degree of correspondence between the characteristics of the characterized descriptive words and the features defining the category, the characterized descriptive words may be stored within a cluster being defined by the same or similar features so as to thereby facilitate the efficient identification and evaluation of keywords that can be used to replace the characterized descriptive words. In such instances, the characteristics of the characterized descriptive words and the features of the keywords may each include a category identifier, a subject identifier, and an objective identifier, wherein a degree of correspondence between their respective objective identifiers may determine the weighting of the system generated ranking, whereby the greater the weight of the generated ranking the closer to the category node the characterized descriptive words and the keywords will be positioned for storage.

As can be seen with respect to FIG. 5A, in various embodiments, the data collection module may be configured for executing a second set of operations for recognizing, collecting, and storing within a memory of one or more databases associated with the system, one or more of: a business listing, content within the business listing, a characterization of one or more businesses, a characterization of a communication recipient, a characterization of a business competitor, one or more market characterizations, an indicator of a category, an indicator of a concept, a conceptual referent, a key concept, a keyword, a category of keyword concepts, a descriptive word, a word phrase, a characterization of a category, a characterization of a keyword, a contextual element, an engagement element, a business objective, and data pertaining to the same. Any one of these elements can be analyzed by the system and as a result thereof a signal may be determined requiring that a response thereto be generated. Other signals can be identified and/or collected for response thereto may include both content and related data such as search volume data, searched keywords, reviews, engagements, surveys, weather alerts, holidays, competitor postings and content, marketing materials and knowledge, brand voice and directives indicators, global and local brand content, as well as previous communications pertaining to the same, other business listings, can all be identified and evaluated as signals.

Additionally, the platform may have access, e.g., via a suitably configured RAG, to the inventory and/or CRM of the business, whereby data pertaining thereto may also be evaluated for one or more signal indictors. In these and other such instances where a signal is identified, the conceptual referent filter may implement a Retrieval-Augmented Generation (RAG) model that is configured for accessing and retrieving, from one or more memories of the databases associated with the system, content and data that is related to the listing associated conceptual referents being evaluated by the LLM. This content and data may then employed by the LLM in determining one or more of meaning and context of the listing associated conceptual referents. As can be seen with respect to FIG. 6B, there are a variety of signals, including content, contextual data, category indicators, environmental conditions, holidays, special hours being posted, and the like, all of which can prompt the need for a response, such as primary and additional categories, relevant characteristics and attributes, services and goods descriptors, competitors characterizations and communications, consumer characterizations, communications, and interests, as well as the traditional signal generators, such as reviews, other engagements, posts, listings, including short and long descriptions, and the like.

As can be seen with respect to FIG. 7D, once the business conceptual referents have been broken down into their descriptive words, and these descriptive words have been contextually defined, categorized, and compared with a set of other more impactful and relevant keywords within the category, the system may determine to replace various of the descriptive wors within the business referent with other higher impact keywords having the same or similar meaning as the descriptors they replace. In such an instance, the listing update communication builder, e.g., project builder, may then accesses one or more of the memories of the system, select one or more identified keywords for replacing the characterized descriptive words within the business listing and thereby produces the updated business listing, whereby the selecting of the one or more identified keywords for replacement of the characterized descriptive words may be based on them having a higher ranking than that of the characterized descriptive words but also having a same or similar meaning to the one or more characterized descriptive words being replaced thereby.

Once the communication has been determined as being useful for generation and distribution, then the communication can be sent to a user of the system for review and approval thereby. Accordingly, the business listing update platform may include an approvals module whereby once the updated listing has been autonomously generated, it may be presented at a display of a client computer device associated with the system for approval by the user of the system, whereupon receipt of the approval of the updated listing can be posted. In such an instance, the generated and updated business listing may be configured for being selected for display in response to a search query activated at an online search engine interface, whereby a ranking of search results is determined by a correspondence between one or more words employed in the business listing and a set of keywords defining one or more categories used by the online search engine for the purpose of determining how returned search results should be ordered. Hence, in various embodiments, the listings optimization platform may include a distributor, e.g., a distribution module, for executing a set of instructions for distributing the updated listing to a plurality of search engine modalities, and once the updated listing has been approved, all relevant listings across respective organizational entities may be substantially simultaneously updated and posted, both globally and locally, where each listing may be tailored to be specifically relevant to each local business environment.

In various embodiments, the updated listing has been generated in a manner to be optimized. What this means is that the words employed in the business listing have been tailored and selected because they have been determined to be present in search results returned when consumers are looking for services proffered by the business. In certain instances, this optimization has been performed so as to increase the correspondence between the keywords used in the updated business listing and the search categories being employed by various search engines when selecting and ranking returned results.

Therefore, when building the communication, the project builder may be associated with an analytics module that is configured for performing an analytics process for analyzing the collected content and associated data so as to produce a number insights that can be used when determining how and with what words and/or phrases to update the business listing. In various implementations, these insights can be employed in conjunction with the system generated objectives so as to determine to which categories the characterized descriptive words apply, e.g., a relevancy determination. In one particular implementations, the categories themselves may be determined based on the insights derived by the analytics module evaluating both previously performed search quarries and returned results so as to identify the relevant search engine categories being employed by the search engine when ranking returned results. This analytics process can be repeated a number of times so as to determine one or more trends and based on the determined trends, the business listing can continually be updated with respect to the categories being applied thereto.

As can be seen with reference to FIG. 8C, in various embodiments, the updating of the business listing may include incorporating a local feel into the listing, which contextually grounds the listing within each local community, while maintaining a globally brand identifying look. In such instances, the insights generated by the system may be used to understand the descriptors and referents commonly used for defining and organizing the categories that apply to the business, e.g., the brand, as well as to the goods and services it proffers, all of which can be used to update the brands various different listings. However, in certain instances, these insights can be stored within the system, along with the updated descripts and referents, e.g., now containing the high impacting keywords, and all of these can then be used to determine both global brand context as well as contexts for each local community serviced by the business entity so as to generate a globally consistent brand voice that is locally relevant. In such an instance, the communication builder may employ the insights generated by the system to build a memory that is directed to storing and understanding brand knowledge. This brand knowledge may then be accessed and used by the communication builder to generate communications that leverage the brand voice in a manner that reflects tone, personality, and style of the brand and implements that brand voice across all localities. Ultimately, this updating results in an advancement of the business listing up the rankings in relevant search return results.

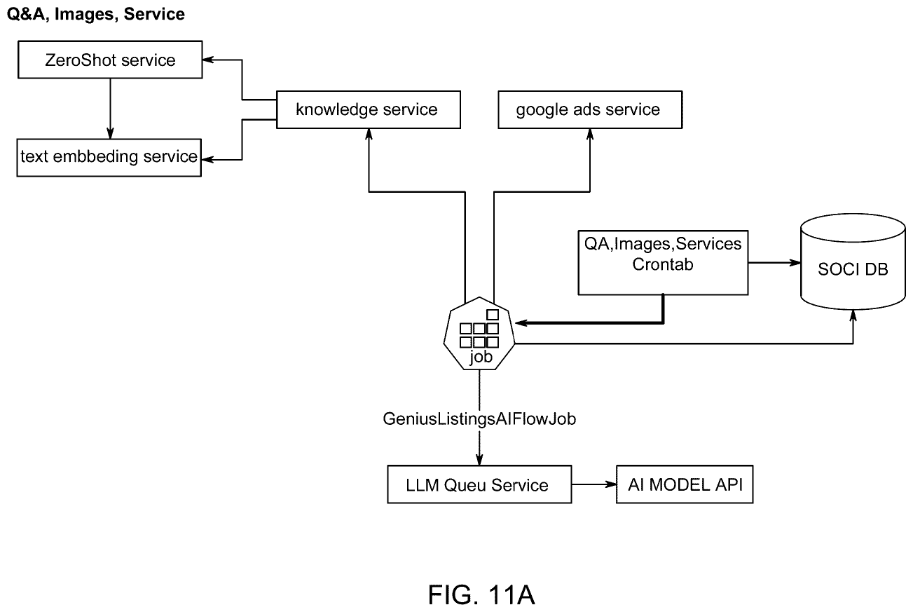

In various other embodiments, as can be seen with reference to FIG. 11, the content to be collected may be derived from data and content pertaining to a questions and answer section of a website designed to answer questions one or more communication recipients may have about the business. In such instances, the insights may be derived from such data and content may be then employed in generating the updated listing. Likewise, these insights can be used to collect or otherwise generate texts and/or images that can be semantically defined and/or characterized, such as by application of a zero-or one-shot classification model to the identified and/or collected texts and/or images so as to extract knowledge therefrom that can be used to semantically define their content, the textual and image content can then be symbolized, vectorized, and stored, and when a subject and/or context for a new communication is to be generated, such as in response to a search query or posted question, these texts and/or images corresponding to an answer thereto can be searched and retrieved form the system and used in the generation of a new communication that can then be distributed in reply to the triggering event. In particular instances, these question-and-answer configurations can be configured to occur real time, whereby the communication builder, e.g., AI agent, are configured for engaging consumers directly, answering their questions, and optimizing follow up communications therewith. This is useful for increasing leads, boosting growth, and generating tailored conversations that enhance engagement on all levels of the business. In various embodiments, the communication builder may be configured for generating mass communications can then be distributed out from all levels of the organization both globally and locally, but in a personalized manner that has been determined to increase impressions, conversions, engagements, lift and overall sales, such as at scale. The present systems, therefore, provide devices and their methods of use for overcoming the aforementioned problems in the manners described herein and above.

As indicated, one or more aspects or features of the subject matter described herein may be realized in digital electronic circuitry, integrated circuitry, specially designed ASICs (application specific integrated circuits), FPGAs (field programmable gated array), computer hardware, firmware, software, and/or combinations thereof. These various implementations may include implementation in one or more computer programs or operations that are executable and/or interpretable on a programmable system including at least one programmable processor, which may be special or general purpose, coupled to receive data and instructions from, and to transmit data and instructions to, a storage system, at least one input device (e.g., mouse, touch screen, etc.), and at least one output device.

These computer programs, which can also be referred to as programs, software, software applications, hardware, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” (sometimes referred to as a computer program product) refers to physically embodied apparatus and/or device, such as for example magnetic discs, optical disks, memory, and Programmable Logic Devices (PLDs), used to provide machine instructions and/or data to a programmable data processor, including a machine-readable medium that receives machine instructions as a machine-readable signal. The term “machine-readable signal” refers to any signal used to provide machine instructions and/or data to a programmable data processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

Accordingly, to facilitate one or more of the implementations disclosed herein, a software and/or hardware application may be present and executed by one or more of the system controlling and/or analyses devices and may provide a user interface that can display information from or about a communication to generated and/or an audience to be targeted and/or an objective to be achieved.

The interface may further provide input portions that permit the user to enter information and/or commands. For example, to provide for interaction with a user, the subject matter described herein can be implemented on a computer having a display device, such as for example a cathode ray tube (CRT), or a liquid crystal display (LCD), or light emitting diode (LED) or (OLED) monitor for displaying information to the user and a keyboard and a pointing device, such as for example a mouse or a trackball, by which the user may provide input to the computer. In various instances, the display screen may be a capacitive sensing interactive touch-screen display. Other kinds of devices can be used to provide for interaction with a user as well.

For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein may be implemented in a computing system that includes one or more back-end components (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), WiFi, and the Internet.

The computing system may include clients and servers. A client and server are generally remote from each other and typically interact through a communication network. The relationship of client and server arises by virtue of computer programs running on the respective computers and having a client-server relationship to each other. In various instances, the methods herein disclosed may be performed in software and/or hardware implementations. For instance, a software application may be provided in the form of a “mobile app” for use on or execution by a mobile smartphone or dedicated device or processor thereof, or may be in the form of a software application for execution in a conventional personal computer (e.g., desktop or laptop or tablet) or enterprise computer system.

An exemplary software application may present a user with a one or more menus or screens configured at least for permitting viewing and/or selection of user preferences or settings, for viewing data received from or related to one or more treatment modalities and/or system component configurations and for controlling said functions and/or determining the positioning of the various components of the system. In addition to such control and presentation of wireless (or wired) communications, communication features may include transmission of commands and settings, receipt of sensor data, feedback data, and/or historical use data, alarm/warning notifications (e.g., at loss or attainment of proximity), etc., all of which may be collected by the system, be stored within a database, and be retrieved and analyzed by the system to suggest future use protocols.

Hence, in various instances, implementations of various aspects of the disclosure may include, but are not limited to: apparatuses, systems, and methods including one or more features as described in detail herein, as well as articles that comprise a tangibly embodied machine-readable medium operable to cause one or more machines (e.g., computers, etc.) to result in operations described herein. Similarly, computer systems are also described that may include one or more processors, e.g., a collection of processors forming a processing engine, and/or one or more memories coupled to the one or more processors. Accordingly, computer implemented methods consistent with one or more implementations of the current subject matter can be implemented by one or more data processors residing in a single computing system or multiple computing systems containing multiple computers, such as in a computing or supercomputing bank.

Such multiple computing systems can be connected and can exchange data and/or commands or other instructions or the like via one or more connections, including but not limited to a connection over a network (e.g., the Internet, a wireless wide area network, a local area network, a wide area network, a wired network, a physical electrical interconnect, or the like), via a direct connection between one or more of the multiple computing systems, etc. A memory, which can include a computer-readable storage medium, may include, encode, store, or the like one or more programs that cause one or more processors to perform one or more of the operations associated with one or more of the algorithms described herein.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. Other implementations may be within the scope of the following claims.

The methods illustratively described herein may suitably be practiced in the absence of any element or elements, limitation or limitations, not specifically disclosed herein. Thus, for example, the terms “comprising”, “including,” containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof. It is recognized that various modifications are possible within the scope of the invention claimed. Thus, it should be understood that although the present disclosed embodiments have been specifically disclosed by representative configurations and optional features, modification and variation of the embodiments herein disclosed may be resorted to by those skilled in the art, and that such modifications and variations are considered to be within the scope of this disclosure.

Any of the features or attributes of the above-described embodiments and variations can be used in combination with any of the other features and attributes of the above described embodiments and variations as desired. From the foregoing disclosure and detailed description of certain disclosed embodiments, it is also apparent that various modifications, additions and other alternative embodiments are possible without departing from the true scope and spirit.

The embodiments discussed were chosen and described to provide the best illustration of the principles of the present invention and its practical application to thereby enable one of ordinary skill in the art to utilize the invention in various embodiments and with various modifications as are suited to the particular use contemplated.

All such modifications and variations are within the scope of the present invention as determined by the appended claims when interpreted in accordance with the benefit to which they are fairly, legally, and equitably entitled.

Specific embodiments have been described broadly and generically herein. Each of the narrower species and subgeneric groupings falling within the generic disclosure also form part of the methods. This includes the generic description of the methods with a proviso or negative limitation removing any subject matter from the genus, regardless of whether or not the excised material is specifically recited herein.

Although a few embodiments have been described in detail above, other modifications are possible. Other embodiments may be within the scope of the following claims.

1. A system including a listings optimization platform for generating an optimized business listing in response to one or more system generated insights, the optimized business listing having one or more keywords determined to be of high-ranking value, the system comprising:
a database having a memory configured for storing a plurality of content elements, the plurality of content elements including one or more business listings, business listing content, a business characterization, a communication recipient characterization, a competitor characterization, a market characterization, categories of keywords, conceptual referents, keywords, high performing keywords, descriptive words, evaluated descriptive words, word phrases, a characterization of keyword categories, a characterization of keywords, a business objective, and data pertaining the same, the database being configured to be queried in a manner to effectuate rapid access to the plurality of content elements;
a listings optimization platform including a plurality of servers having one or more processing units, each processing unit including a set of processing engines, at least one of the processing engines of one of the processing units being a trained processing engine, and at least some of the processing engines being configured for executing a set of autonomous operations, the set of processing engines comprising:
an online listing monitoring module configured for monitoring business listings that are posted in response to a search query, the listing monitoring module having a conceptual referent filter configured for recognizing and identifying a conceptual referent within a posted business listing, the conceptual referent including at least one descriptive word that has been determined to be a variant of a high performing keyword for achieving a determined business objective;
a data collection module, coupled to one or more memories of the database, and configured for executing a first set of operations for collecting and storing within a memory of the database, the identified business listing associated conceptual referent to which making a modification thereto is to be evaluated, the modification being based on an evaluative comparison between the at least one descriptive words of the collected business listing associated conceptual referent and a category of keywords with which the high performing keyword is associated;
a trained conceptual referent evaluation module configured for executing a set of operations for both determining a meaning of and evaluating the at least one descriptive words of the collected business listing associated conceptual referent based on a number of characteristics of the category of keywords so as to produce an evaluated descriptive word having a determined meaning and a ranking within the category of keywords, wherein the evaluating includes comparing the meaning of the at least one descriptive word to the characteristics of the category of keywords;
an autonomous updated business listing generation module being configured for executing a set of operations for generating an optimized business listing in response to a triggering event, the updated business listing generation module comprising:
a project builder for accessing the memory and for executing a set of operations for generating the optimized business listing, the project builder having a set of processing engines being configured for accessing the memory and selecting and replacing the evaluated descriptive word with at least one high performing keywords within the category of keywords to produce an optimized business listing having one or more high performing keywords within the business associated conceptual referent, the selecting being based on a higher ranking of the at least one high performing keywords over the determined ranking of the evaluated descriptive word.

2. The system in accordance with claim 1, wherein the conceptual referent filter comprises an artificial intelligence agent that has been trained to recognize one or more concepts including a business listing, content within the business listing, a characterization of the business, a characterization of a communication recipient, a characterization of a business competitor, a market characterization, a category, a conceptual referent, a keyword, a category of keywords a descriptive word, a word phrase, a characterization of a category, a characterization of a keyword, a business objective, as well as data pertaining the same.

3. The system in accordance with claim 2, wherein the conceptual referent filter is configured for employing a model for recognizing and characterizing the descriptive words of the conceptual referent within the business listing, wherein the model is a large language model (LLM) that is applied to the business listing.

4. The system in accordance with claim 3, wherein the data collection module is further configured for executing a second set of operations for recognizing, collecting, and storing within a memory of one or more databases associated with the system, one or more of: a business listing, content within the business listing, a characterization of one or more businesses, a characterization of a communication recipient, a characterization of a business competitor, one or more market characterizations, an indicator of a category, a conceptual referent, a keyword, a category of keywords, a descriptive word, a word phrase, a characterization of a category, a characterization of a keyword, a business objective, and data pertaining to the same.

5. The system in accordance with claim 4, wherein the conceptual referent filter further implements a Retrieval-Augmented Generation (RAG) model that is configured for accessing and retrieving, from one or more memories of the databases associated with the system, content and data related to the listing associated conceptual referent being evaluated by the LLM, which content and data are employed by the LLM in determining one or more of meaning and context of the listing associated conceptual referent.

6. The system in accordance with claim 5, wherein the conceptual referent filter further identifies and characterizes the one or more descriptive words within the business listing associated conceptual referent, and based on this characterization identifies one or more categories of keywords that may apply to the characterized descriptive words, and then compares, evaluates, and ranks the characterized descriptive words in relation to a number of other keywords in the identified categories, whereby the identified keywords that rank higher than the characterized descriptive words are given a greater weighting.

7. The system in accordance with claim 6, wherein once the descriptive words have been characterized they may be stored within a memory of one or more of the databases associated with the system, whereby the storage of the characterized descriptive words is at least partially based on a correspondence between one or more characteristics of the characterized descriptive words and one or more features of other keywords within the category of keywords, whereby the features of the keywords define the respective category, and the characterized descriptive words are stored in a relational manner so that the more the characterized descriptive words correspond to the category the closer to a node defining the category the characterized descriptive words will be ranked and placed for storage.

8. The system in accordance with claim 7, wherein based on a degree of correspondence between the characteristics of the characterized descriptive words and the features defining the category, the characterized descriptive words may be stored within a cluster being defined by the same or similar features so as to thereby facilitate the efficient identification and evaluation of keywords that can be used to replace the characterized descriptive words.

9. The system in accordance with claim 8, wherein the characteristics of the characterized descriptive words and the features of the keywords each include a category identifier, a subject identifier, and an objective identifier, wherein a degree of correspondence between their respective objective identifiers determines the weighting of the system generated ranking, whereby the greater the weight of the generated ranking the closer to the category node the characterized descriptive words and the keywords will be positioned for storage.

10. The system in accordance with claim 9, wherein the project builder accesses one or more of the memories of the system, selects one or more identified keywords for replacing the characterized descriptive words within the business listing and thereby produces the updated business listing, whereby the selecting of the one or more identified keywords for replacement of the characterized descriptive words is based on them having a higher ranking than that of the characterized descriptive words but also having a same or similar meaning to the one or more characterized descriptive words.

11. The system in accordance with claim 10, wherein both the objective and subject is autonomously determined by the system based on one or more of the system generated insights, and further wherein the determined objective is to maximize consumer reach.

12. The system in accordance with claim 11, further comprising an approvals module whereby once the updated listing has been autonomously generated, it may be presented at a display of a client computer device associated with the system for approval by a user of the system, whereupon receipt of said approval the updated listing can be posted.

13. The system in accordance with claim 12, wherein the generated and updated business listing is configured for being selected for display in response to a search query activated at an online search engine interface, whereby a ranking of search results is determined by a correspondence between one or more words employed in the business listing and a set of keywords defining one or more categories used by the online search engine for the purpose of determining how returned search results should be ordered.

14. The system in accordance with claim 13, wherein the project builder is associated with an analytics module that is configured for performing an analytics process for analyzing the collected content and associated data so as to produce the insights, and the produced insights are used in conjunction with the system generated objective to determine to which categories the characterized descriptive words apply, whereby the categories themselves are determined based on insights derived by the analytics module evaluating performed search quarries and returned results so as to identify relevant search engine categories being employed by the search engine when ranking returned results.

15. The system in accordance with claim 14, wherein the analytics process is repeated a number of times so as to determine one or more trends and based on the determined trends to continually update the categories being deployed by the system.

16. The system in accordance with claim 15, whereby the project builder and analytics module is instantiated by an AI module that executes one or more of an Artificial General Intelligence protocol and a Generative Pre-trained Transformer model so as to generate the insights and produce the updated listing.

17. The system in accordance with claim 16, wherein the project builder is communicably coupled to the database, and the database embodies a neural network architecture that allows the listings optimization platform to process and understand context by determining the relationships between descriptive words and keywords.

18. The system in accordance with claim 16, wherein the listings optimization platform includes a distributor, for executing a set of instructions for distributing the updated listing to a plurality of search engine modalities, and once the updated listing has been approved, all relevant listings across respective organizational entities may be substantially simultaneously updated and posted, both globally and locally, where each listing is tailored to be specifically relevant to each local business environment.

19. The system in accordance with claim 18, wherein the updating includes incorporating a local feel into the listing, which contextually grounds the listing within each local community, while maintaining a globally brand identifying look.

20. The system in accordance with claim 19, wherein the insights are used to understand the global brand context as well as contexts for each local community serviced by the business entity so as to generate a globally consistent brand voice that is locally relevant.
